(19) United States
(12) Patent Application Publication
(10) Pub. No.: US 2014/0003074 A1
(43) Pub. Date: Jan. 2, 2014

(54) WAVELENGTH CONVERSION MEMBER AND METHOD FOR MANUFACTURING THE SAME, AND LIGHT-EMITTING DEVICE, ILLUMINATING DEVICE, AND HEADLIGHT

(71) Applicant: Katsuhiko Kishimoto, Osaka-shi (JP)

(72) Inventor: Katsuhiko Kishimoto, Osaka-shi (JP)

(21) Appl. No.: 14/004,790

(22) PCT Filed: Mar. 8, 2012
(86) PCT No.: PCT/JP2012/055928

§ 371 Date: Sep. 12, 2013

(30) Foreign Application Priority Data
Mar. 16, 2011 (JP) 2011-058471
Mar. 24, 2011 (JP) 2011-066132
Jun. 21, 2011 (JP) 2011-062461
Jun. 21, 2011 (JP) 2011-137844

(51) Int. Cl. F21V 9/16; F21V 29/00; F21S 8/10

(52) U.S. Cl. CPC F21V 9/16; F21S 48/1225; F21V 29/22
USPC 362/510; 362/84; 252/301.4 R; 252/301.36; 252/519.31; 252/518.1

(57) ABSTRACT

A headlamp (1) includes a laser diode (2) for emitting a laser beam and a light-emitting section (5), which contains a fluorescent substance for emitting fluorescence upon receiving the laser beam emitted from the laser diode (2) and diffusing particles (15) for diffusing the laser beam.

### REFERENCE TO RELATED APPLICATIONS

This application is a national stage application under 35 USC 371 of International Application No. PCT/JP2012/055928, filed Mar. 8, 2012, which claims the priority of Japanese Patent Application Nos. 2011-058471, filed Mar. 16, 2011, 2011-062461, filed Mar. 22, 2011, 2011-066132, filed Mar. 24, 2011, and 2011-137844, filed Jun. 21, 2011, the entire contents of which are incorporated herein by reference.

### FIELD OF THE INVENTION

The present invention relates to a wavelength conversion member (a light-emitting section or a light-emitting member) and a method for manufacturing the wavelength conversion member, as well as a light-emitting device including the wavelength conversion member, and an illuminating device and a headlight (for example, vehicle headlight) each including the light-emitting device.

### BACKGROUND OF THE INVENTION

Studies are being actively carried out on light-emitting devices that use, as illumination light, fluorescence generated by irradiating a light-emitting section containing a fluorescent material with excitation light emitted from an excitation light source, which is a solid-state light-emitting element (semiconductor light-emitting element), such as a light-emitting diode (LED) or a laser diode (LD).

Such a light source that excites a fluorescent material with a solid-state light-emitting element must satisfy a prescribed eye safety level specified in the international safety standard IEC 60825-1 or Japanese JIS C6082. In particular, applications in consumer equipment, such as lighting fixtures, require class 1 level eye safety, at which illumination light from a light source directly incident on the eye through an optical system is unlikely to cause blindness.

In particular, improvement in eye safety requires at least a certain apparent light source size.

Patent Literature 1 discloses an optical communication module that includes a light source apparatus that emits stimulated emission light from a laser diode through a multiple scattering optical system into a free space. This optical communication module contains a high concentration of scatterer in a region close to the laser diode. The scatterer reduces the spatial coherence of a laser beam emitted from the laser diode.

As an example of technology with respect to such a light-emitting device, Patent Literature 2 discloses a luminaire. This luminaire includes a laser diode as an excitation light source in order to realize a high-intensity light source. Since a laser beam from a laser diode is coherent and directional, the laser beam can be efficiently collected and utilized as excitation light. Such a light-emitting device that includes a laser diode as an excitation light source (referred to as a LD light-emitting device) can be suitably applied to a vehicle headlamp. Use of a laser diode as an excitation light source can realize a high-intensity light source, which cannot be realized with LED.

When such a laser beam is used as excitation light, in a very small light-emitting section or a light-emitting section having a very low volume, a component of excitation light absorbed by the light-emitting section and converted into heat rather than converted into fluorescence by a fluorescent material easily increases the temperature of the light-emitting section and consequently impairs the characteristics of the light-emitting section or causes thermal damage to the light-emitting section.

In order to solve this problem, the invention described in Patent Literature 3 provides a light-transmitting thin-film heat-conductive member thermally connected to a wavelength conversion member (corresponding to a light-emitting section). This heat-conductive member reduces heat generation of the wavelength conversion member.

In accordance with the invention described in Patent Literature 4, a wavelength conversion member is held by a cylindrical ferrule, which is thermally connected to a wire-shaped heat-conductive member to reduce the heat generation of the wavelength conversion member.

The invention described in Patent Literature 5 provides a heat-radiating member having a refrigerant flow path disposed on a surface of a light conversion member (corresponding to a light-emitting section) facing a semiconductor light-emitting element to cool the light conversion member.

Patent Literature 6 discloses a light-transmitting heat sink thermally connected to a surface of a high-power LED chip, which serves as a light source, to cool the high-power LED chip.

Patent Literature 7 discloses a semiconductor light-emitting device as an example of a light-emitting device as described above. This semiconductor light-emitting device contains, as fluorescent materials, a green-light-emitting fluorescent material (rare-earth-activated inorganic fluorescent material) for emitting green light and a red-light-emitting fluorescent material (semiconductor particulate fluorescent material) for emitting red light, which has a longer wavelength than green light. In the semiconductor light-emitting device, a smallest difference between a wavelength at which the red-light-emitting fluorescent material has the lowest absorption spectrum and a peak wavelength of the emission spectrum of the green-light-emitting fluorescent material is 25 nanometers (nm) or less.

Patent Literature 8 discloses a semiconductor nanoparticle fluorescent material as an example of a blue-light-emitting fluorescent material. The semiconductor nanoparticle fluorescent material has an emission peak at a wavelength in the range of 400 to 500 nm. The semiconductor nanoparticle fluorescent material dispersed in water has a luminous efficiency of 35% or more.

Patent Literature 9 discloses a light-emitting device that contains a plurality of fluorescent materials such that the fluorescence wavelength of light from a LED chip decreases along an optical path through which the light is emitted outward.

Patent Literature 10 discloses a nitride or oxynitride fluorescent material as an example of a fluorescent material.

Patent Literatures 1 and 2 are disclosed as additional examples of technology with respect to a light-emitting device as described above.

Patent Literature 11 discloses a blue-light-emitting glass. More specifically, a sol-gel reaction is performed using a starting solution that contains a raw material for forming a glass base material, a light-emitting base material europium (Eu), and a reducing agent. In the sol-gel reaction, the reducing agent provides an europium ion with its electron or an electron of oxygen to convert a trivalent europium ion (Eu³⁺) into a divalent ion (Eu²⁺). The divalent europium ion (Eu²⁺) emits blue light due to ultraviolet excitation. This method realizes a blue-light-emitting glass, in which the glass base material emits blue light upon ultraviolet irradiation.

Patent Literature 12 realizes a fluorescent glass containing a fluorescent material dispersed in a glass material and having L* of 65 or more on the chromaticity coordinates of the L*a*b* color system.

### PATENT LITERATURE

PTL 1: International Publication WO 2003/077389 (published on Sep. 18, 2003)
PTL 2: Japanese Unexamined Patent Application Publication No. 2005-150041 (published on Jun. 9, 2005)
PTL 3: Japanese Unexamined Patent Application Publication No. 2007-27688 (published on Feb. 1, 2007)
PTL 4: Japanese Unexamined Patent Application Publication No. 2007-335514 (published on Dec. 27, 2007)
PTL 5: Japanese Unexamined Patent Application Publication No. 2005-294185 (published on Oct. 20, 2005)
PTL 6: Japanese Unexamined Patent Application Publication (Translation of PCT Application) No. 2009-513003 (published on Mar. 26, 2009)
PTL 7: Japanese Unexamined Patent Application Publication No. 2010-141033 (published on Jun. 24, 2010)
PTL 8: Japanese Unexamined Patent Application Publication No. 2006-291175 (published on Oct. 26, 2006)
PTL 9: Japanese Unexamined Patent Application Publication No. 2005-277127 (published on Oct. 6, 2005)
PTL 10: Japanese Unexamined Patent Application Publication No. 2007-231245 (published on Sep. 13, 2007)
PTL 11: Japanese Unexamined Patent Application Publication No. 2001-270733 (published on Oct. 2, 2001)
PTL 12: Japanese Unexamined Patent Application Publication No. 2009-270091 (published on Nov. 19, 2009)

### SUMMARY OF INVENTION

The existing techniques described above, however, have the following problems.

For example, the invention described in Patent Literature 1 relates to the light source apparatus in the optical communication module and does not relate to a light-emitting device that functions as a high-intensity light source. Thus, there is a problem that the constitution described in Patent Literature 1 cannot be directly applied to the light-emitting device described above.

As a result of extensive studies, the present inventor found that the existing techniques have a problem that a light-emitting section having low thermal conductivity even in contact with a heat-conductive member having high thermal conductivity has insignificant heat sink effects.

The fluorescence efficiency (external quantum efficiency) of such a rare-earth-activated fluorescent material as used in the semiconductor light-emitting device described in Patent Literature 7 tends to be lower in a fluorescent material having a fluorescence peak wavelength in a blue wavelength range that emits light at a shorter wavelength than in a fluorescent material having a fluorescence peak wavelength in a green to red wavelength range. Thus, considering external quantum efficiency alone, in order to maintain a required amount of fluorescence, the amount of fluorescent material having a peak wavelength in a blue wavelength range is greater than the amount of fluorescent material having a peak wavelength in a green to red wavelength range.

In order to produce illumination light having an ordinary neutral white color up to a higher color temperature, the amount of fluorescent material having a peak wavelength in a green wavelength range generally tends to be greater than the amount of fluorescent material having a peak wavelength in a red wavelength range. In other words, in order to maintain a required amount of fluorescence, the amount of fluorescent material having a shorter peak wavelength tends to be greater than the amount of fluorescent material having a longer peak wavelength.

In order to achieve good color rendering properties of illumination light, the spectrum of light in a visible light region preferably has a smaller number of troughs. Thus, considering color rendering properties, it is preferable to use, as part of illumination light, fluorescence of a blue-light-emitting fluorescent material that emits a blue light having a wider emission spectrum than a blue light of a blue LED rather than using the blue light of the blue LED as part of illumination light, as in the case of the semiconductor light-emitting device as described in Patent Literature 7. Inclusion of a blue-light-emitting fluorescent material in a light-emitting member is not disclosed in the semiconductor light-emitting device described in Patent Literature 1.

If the light-emitting member contains a blue-light-emitting fluorescent material, however, the amount of blue-light-emitting fluorescent material that emits light in a blue wavelength range must particularly be increased to improve the luminous efficiency of the light-emitting member, also because of low visibility of light emission in the blue wavelength range (on the short wavelength side). Thus, the fluorescent material having a peak wavelength in the blue wavelength range (on the short wavelength side) is particularly greater in amount than a fluorescent material having a peak wavelength on the long wavelength side of the blue wavelength range.

Consequently, a light-emitting member composed of a plurality of fluorescent materials including the blue-light-emitting fluorescent material has a problem that a particularly large amount of blue-light-emitting fluorescent material having a peak wavelength in the blue wavelength range (on the short wavelength side) prevents fluorescence emission from a fluorescent material having a peak wavelength on the long wavelength side to the outside of the light-emitting member.

For example, in the semiconductor light-emitting device described in Patent Literature 7, if a blue-light-emitting fluorescent material is added as a fluorescent material contained in the light-emitting member, a particularly great amount of blue-light-emitting fluorescent material having a peak wavelength on the short wavelength side prevents fluorescence emission from a green- or red-light-emitting fluorescent material having a peak wavelength on the long wavelength side to the outside of the light-emitting member.

The light-emitting member composed of a plurality of fluorescent materials including the blue-light-emitting fluorescent material also has a problem that a particularly large amount of blue-light-emitting fluorescent material having a peak wavelength in the blue wavelength range (on the short wavelength side) prevents a fluorescent material having a peak wavelength on the long wavelength side from being irradiated with excitation light.

For example, in the semiconductor light-emitting device described in Patent Literature 7, if a blue-light-emitting fluorescent material is added as a fluorescent material contained in the light-emitting member, a particularly great amount of blue-light-emitting fluorescent material having a peak wavelength on the short wavelength side prevents a green- or red-light-emitting fluorescent material having a peak wavelength on the long wavelength side from being irradiated with excitation light.

These two problems of the semiconductor light-emitting device described in Patent Literature 7 are not limited to the blue-light-emitting fluorescent material. A fluorescent material that emits light of another color, for example, a green-light-emitting fluorescent material also has the problems. More specifically, a light-emitting member composed of a plurality of fluorescent materials including a green-light-emitting fluorescent material also has a problem that the green-light-emitting fluorescent material having a peak wavelength in a green wavelength range (on the short wavelength side) prevents fluorescence emission from a small amount of fluorescent material having a peak wavelength on the long wavelength side to the outside of the light-emitting member or prevents excitation light irradiation of the fluorescent material.

The circumstances under which lamp color illumination light having a low color temperature is obtained with a light-emitting member composed of a plurality of fluorescent materials including a blue-light-emitting fluorescent material are different from the circumstances described above under which only the luminous efficiency is taken into consideration. For example, for a light-emitting member composed of blue-, green-, and red-light-emitting fluorescent materials, the blue-light-emitting fluorescent material content is particularly greater than the green- and red-light-emitting fluorescent materials content as in the case that only the luminous efficiency is taken into consideration. In order to obtain lamp color illumination light having a low color temperature, however, the circumstances are different in that the red-light-emitting fluorescent material content may sometimes be greater than the green-light-emitting fluorescent material content. In this case, a greater amount of red-light-emitting fluorescent material having a longer wavelength may prevent fluorescence from a smaller amount of green-light-emitting fluorescent material having a shorter wavelength or prevent excitation light irradiation of the green-light-emitting fluorescent material. In this case, however, a particularly large amount of blue-light-emitting fluorescent material having a shorter wavelength still prevents fluorescence from a small amount of green- or red-light-emitting fluorescent material having a longer wavelength or prevents excitation light irradiation of the green- or red-light-emitting fluorescent material.

Even in such a case, a small amount of green-light-emitting fluorescent material having a shorter wavelength may prevent fluorescence from a large amount of red-light-emitting fluorescent material having a longer wavelength or prevent excitation light irradiation of the red-light-emitting fluorescent material.

None of Patent Literatures 8 to 10 describes the problem that a large amount of fluorescent material prevents fluorescence emission from a small amount of fluorescent material to the outside of the light-emitting member. Also, none of Patent Literatures 8 to 10 describes the problem that a large amount of fluorescent material prevents excitation light irradiation of a small amount of fluorescent material.

The semiconductor light-emitting device described in Patent Literature 7 contains the red-light-emitting fluorescent material having the longest peak wavelength as the semiconductor particulate fluorescent material. Furthermore, in order to improve the color rendering properties and luminous efficiency of the light-emitting member, a smallest difference between a wavelength at which the red-light-emitting fluorescent material has the lowest absorption spectrum and a peak wavelength of the emission spectrum of the green-light-emitting fluorescent material is set at 25 nm or less. These make it difficult to manufacture the semiconductor light-emitting device.

The invention described in Patent Literature 11 aims to manufacture a blue-light-emitting glass that emits blue light but does not relate to a technique using a fluorescent material that emits fluorescence of another color in addition to blue. Thus, the invention described in Patent Literature 11 cannot provide illumination light having good color rendering properties.

The invention described in Patent Literature 12 relates to dispersion of a fluorescent material in a glass base material but does not relate to a technique of dispersing a fluorescent material in a fluorescent glass. Furthermore, blue-light-emitting fluorescent materials generally have low luminous efficiency and transparency. Thus, the invention described in Patent Literature 12 must use a large amount of blue-light-emitting fluorescent material in order to improve luminous efficiency, which causes a problem of low transparency of a light-emitting section. There is no literature that describes problems of low luminous efficiency of a blue-light-emitting fluorescent material and low luminous efficiency of a light-emitting device because of the use of a large amount of blue-light-emitting fluorescent material.

In view of these existing problems, it is a first object of the present invention to provide a wavelength conversion member that functions as a high-intensity light source and ensures eye safety and a method for manufacturing the wavelength conversion member, as well as a light-emitting device, an illuminating device, and a headlight.

It is a second object of the present invention to provide a wavelength conversion member that has a low thermal resistance and can efficiently dissipate heat and a method for manufacturing the wavelength conversion member, as well as a light-emitting device, an illuminating device, and a headlight.

It is a third object of the present invention to provide a wavelength conversion member that can improve luminous efficiency and can be easy to manufacture and a method for manufacturing the wavelength conversion member, as well as a light-emitting device, an illuminating device, and a headlight.

It is a fourth object of the present invention to provide a wavelength conversion member that can efficiently emit illumination light having good color rendering properties and a method for manufacturing the wavelength conversion member, as well as a light-emitting device, an illuminating device, and a headlight.

In order to solve the problems described above, a light-emitting device according to the present invention includes a laser diode for emitting a laser beam and a wavelength conversion member (for example, a light-emitting section), which contains a fluorescent substance for emitting fluorescence upon receiving the laser beam emitted from the laser diode and diffusing particles for diffusing the laser beam.

In accordance with this constitution, the fluorescent substance contained in the wavelength conversion member emits light upon receiving the laser beam emitted from the laser diode. This light emission can be utilized as illumination light. Since a laser beam has high coherence (spatial coherence), even when the size of the wavelength conversion member is reduced, the excitation light irradiation efficiency of the wavelength conversion member can be increased. Thus, a high-intensity illuminating device can be realized.

In contrast to such advantages, because of its high coherence, a laser beam can adversely affect the human body. Thus, diffusing particles for diffusing a laser beam in a wavelength conversion member can diffuse the laser beam (reduce spatial coherence) and convert the laser beam into light having a large luminous point size that has little effect on the human body, thereby allowing the laser beam to be emitted as illumination light.

Thus, a light-emitting device that functions as a high-intensity light source and ensures eye safety can be realized.

In order to solve the problems described above, a light-emitting device according to the present invention includes an excitation light source for emitting excitation light and a wavelength conversion member containing a fluorescent material that emits light in response to excitation light emitted from the excitation light source. The wavelength conversion member contains heat-conductive particles.

In accordance with this constitution, the wavelength conversion member emits light upon receiving excitation light. Part of the excitation light not converted into fluorescence is converted into heat and heats the wavelength conversion member. The wavelength conversion member has a low thermal resistance because of the heat-conductive particles. Thus, the heat-conductive particles can efficiently dissipate the heat of the wavelength conversion member.

In order to solve the problems described above, a manufacturing method according to the present invention is a method for manufacturing a wavelength conversion member that emits light upon receiving excitation light, which includes a mixing step of mixing heat-conductive particles, a fluorescent material, and a sealant and a baking step of baking the mixture prepared in the mixing step.

The wavelength conversion member emits light upon receiving excitation light. Part of the excitation light not converted into fluorescence is converted into heat and heats the wavelength conversion member.

In accordance with this constitution, the heat-conductive particles, the fluorescent material, and the sealant are mixed and baked to form a wavelength conversion member. The wavelength conversion member has a low thermal resistance because of the heat-conductive particles. Thus, the heat-conductive particles can efficiently dissipate the heat of the wavelength conversion member.

In order to solve the problems described above, a wavelength conversion member according to the present invention is a wavelength conversion member that contains a first fluorescent material for emitting fluorescence having a peak wavelength in a first color wavelength range, and a second fluorescent material for emitting fluorescence having a peak wavelength in a second color wavelength range, the second color wavelength range being on the long wavelength side of the first color wavelength range. At least the first fluorescent material is a nanoparticle fluorescent material.

In this constitution, at least the first fluorescent material is a nanoparticle fluorescent material [the average particle size (hereinafter referred to simply as “particle size”) is approximately two orders of magnitude smaller than the light wavelength in the visible light wavelength range]. Thus, the first fluorescent material transmits (or is transparent to) light in the visible light wavelength range and the vicinity thereof. This results in higher fluorescence efficiency (external quantum efficiency) of the second fluorescent material in emitting fluorescence to the outside of the wavelength conversion member than the case that the first fluorescent material is not a nanoparticle fluorescent material.

This also results in higher excitation light irradiation efficiency of the second fluorescent material than the case that the first fluorescent material is not a nanoparticle fluorescent material.

In accordance with the technique described in Patent Literature 7, a smallest difference between a wavelength at which the red-light-emitting fluorescent material has the lowest absorption spectrum and a peak wavelength of the emission spectrum of the green-light-emitting fluorescent material is set at 25 nm or less. These make it difficult to manufacture the semiconductor light-emitting device. In contrast, a wavelength conversion member according to the present invention only requires the nanoparticle fluorescent material as the first fluorescent material and is therefore easy to manufacture.

Thus, the wavelength conversion member has improved luminous efficiency and is easy to manufacture.

The term “luminous efficiency” refers to a characteristic of a light-emitting material and corresponds to internal quantum efficiency in the present application. More specifically, it is the ratio of the number of photons of fluorescence to the number of photons of excitation light absorbed by a fluorescent material.

In order to solve the problems described above, a wavelength conversion member according to the present invention contains a sealant made of a fluorescent glass for emitting blue fluorescence in response to excitation light and a dispersed fluorescent material for emitting fluorescence having a longer wavelength than the blue fluorescence in response to the excitation light.

In general, blue-light-emitting fluorescent materials have low luminous efficiency. Thus, a wavelength conversion member that contains a blue-light-emitting fluorescent material dispersed in a glass base material as in the related art must contain a large amount of blue-light-emitting fluorescent material so as to increase luminous efficiency. This reduces the luminous efficiency of the wavelength conversion member. Use of a large amount of blue-light-emitting fluorescent material in the related art also causes a problem of high manufacturing costs of a wavelength conversion member.

In this respect, a wavelength conversion member according to the present invention contains a fluorescent glass for emitting blue fluorescence in response to excitation light as a sealant. This obviates the necessity of using a blue-light-emitting fluorescent material having low luminous efficiency dispersed in large quantity in a glass base material in a wavelength conversion member according to the present invention. Thus, a wavelength conversion member according to the present invention can have higher luminous efficiency than before and can be manufactured at reduced costs.

A wavelength conversion member according to the present invention contains a dispersed fluorescent material for emitting fluorescence having a longer wavelength than the blue fluorescence in response to the excitation light. Thus, a wavelength conversion member according to the present invention can emit illumination light having good color rendering properties as a result of the color mixing of blue light emitted from a fluorescent glass and fluorescence emitted from the fluorescent material and having a longer wavelength than the blue fluorescence. For example, a light-emitting device including a wavelength conversion member according to the present invention described below has a wider spectrum in a blue light region and better color rendering properties in the blue region than generally used light-emitting devices that include a blue LED as an excitation light source. Thus, the light-emitting device can have both improved color rendering properties due to the addition of fluorescence having a longer wavelength than blue and improved color rendering properties in the blue region itself.

Since no blue-light-emitting fluorescent material is used, unlike existing wavelength conversion members that contain a blue-light-emitting fluorescent material, excitation of the fluorescent material or light extraction efficiency from the fluorescent material is not reduced. Thus, a wavelength conversion member according to the present invention achieves high luminous efficiency.

Thus, a wavelength conversion member according to the present invention can efficiently emit illumination light having good color rendering properties in response to excitation light irradiation.

As described above, a light-emitting device according to the present invention includes a laser diode for emitting a laser beam and a wavelength conversion member, which contains a fluorescent substance for emitting fluorescence upon receiving the laser beam emitted from the laser diode and diffusing particles for diffusing the laser beam.

This produces an advantageous effect of realizing a light-emitting device that functions as a high-intensity light source and ensures eye safety.

As described above, a light-emitting device according to the present invention includes an excitation light source for emitting excitation light and a wavelength conversion member containing a fluorescent material that emits light in response to excitation light emitted from the excitation light source. The wavelength conversion member contains heat-conductive particles.

As described above, a manufacturing method according to the present invention includes a mixing step of mixing heat-conductive particles, a fluorescent material, and a sealant and a baking step of baking the mixture prepared in the mixing step.

This produces an advantageous effect of reducing the thermal resistance of the wavelength conversion member and efficiently dissipating heat of the wavelength conversion member.

As described above, a wavelength conversion member according to the present invention is a wavelength conversion member that contains a first fluorescent material for emitting fluorescence having a peak wavelength in a first color wavelength range, and a second fluorescent material for emitting fluorescence having a peak wavelength in a second color wavelength range, the second color wavelength range being on the long wavelength side of the first color wavelength range. At least the first fluorescent material is a nanoparticle fluorescent material.

This produces an advantageous effect of improving the luminous efficiency of the wavelength conversion member and making it easy to manufacture the wavelength conversion member.

As described above, a wavelength conversion member according to the present invention contains a sealant made of a fluorescent glass for emitting blue fluorescence in response to excitation light and a dispersed fluorescent material for emitting fluorescence having a longer wavelength than the blue fluorescence in response to the excitation light.

This produces an advantageous effect of realizing a wavelength conversion member that can efficiently emit illumination light having good color rendering properties.

Other objects, features, and merits of the present invention will become apparent from the following description. The advantages of the present invention will become apparent from the following description with reference to the accompanying drawings.

### BRIEF DESCRIPTION OF THE DRAWINGS

FIG. 1 is a detail view of a wavelength conversion member (for example, a light-emitting section or a light-emitting member) and a heat-conductive member of a headlamp according to an embodiment of the present invention.

FIG. 2 is a cross-sectional view of the structure of the headlamp.

FIG. 3 is a schematic view of a heat-conductive filler and fluorescent material particles dispersed in a glass material in a wavelength conversion member.

FIG. 4 is a view of a plurality of fluorescent material particles disposed on a surface of a heat-conductive filler or a plurality of heat-conductive fillers disposed on a surface of a fluorescent material particle. (a) illustrates a plurality of fluorescent material particles disposed on a surface of a heat-conductive filler. (b) illustrates a plurality of heat-conductive fillers disposed on a surface of a fluorescent material particle.

FIG. 5 is a cross-sectional view of a modified example of the wavelength conversion member.

FIG. 6 is a view of a specific example of an excitation light source. (a) illustrates a circuit of an example of an excitation light source (LED) with respect to the headlamp. (b) is a front view of the appearance of the LED. (c) illustrates a circuit of another example of the excitation light source (LD). (d) illustrates the appearance of the LD viewed from the lower right.

FIG. 7 is a view of a specific example of a wavelength conversion member and a heat-conductive member of the headlamp.

FIG. 8 is a schematic view of the structure of a headlamp according to another embodiment of the present invention.

FIG. 9 is a view of a modified example of a holding portion or the connection of a wavelength conversion member with a heat-conductive member via an adhesive layer. (a) to (c) illustrate modified examples of a holding portion. (d) illustrates the connection of a wavelength conversion member with a heat-conductive member via an adhesive layer.

FIG. 10 is a schematic view of the structure of a headlamp according to still another embodiment of the present invention.

FIG. 11 is a schematic view of an example of the composition of a wavelength conversion member according to still another embodiment of the present invention. (a) illustrates an example of the composition of a wavelength conversion member. (b) illustrates another example of the composition of the wavelength conversion member.

FIG. 12 is a graph of the chromaticity range of illumination light.

FIG. 13 is a graph showing the relationship between the particle size of a nanoparticle fluorescent material and fluorescence energy level (eV; electron volt).

FIG. 14 is a schematic cross-sectional view of the structure of a headlamp according to still another embodiment of the present invention.

FIG. 15 is a view of the positional relationship between ends of optical fibers and a wavelength conversion member of the headlamp according to still another embodiment.

FIG. 16 is a schematic view of the appearance of a light-emitting unit of a laser downlight according to an embodiment of the present invention and a known LED downlight.

FIG. 17 is a cross-sectional view of a ceiling on which the laser downlight is installed.

FIG. 18 is a cross-sectional view of the laser downlight.

FIG. 19 is a cross-sectional view illustrating a modified example of a method for installing the laser downlight.

FIG. 20 is a cross-sectional view of a ceiling on which the LED downlight is installed.

FIG. 21 is a cross-sectional view of a laser downlight according to another embodiment of the present invention.

FIG. 22 is a cross-sectional view illustrating a modified example of a method for installing the laser downlight.

FIG. 23 is a table for comparing the specifications of the laser downlight and the LED downlight.

### DESCRIPTION OF EMBODIMENTS

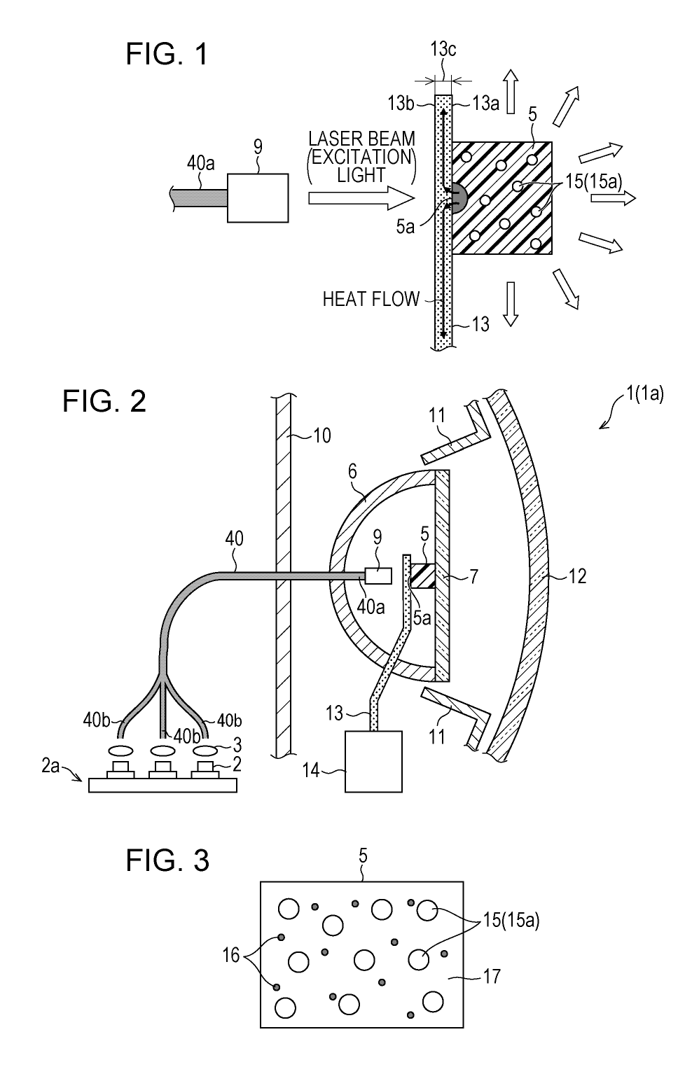

Embodiments of the present invention will be described below with reference to FIGS. 1 to 23. Although description of a component other than the components described in the following particular embodiments may be omitted where appropriate, if the component is described in one embodiment, the component is the same in the other embodiments. For convenience of explanation, members having the same function are designated by the same reference numerals throughout the embodiments and will not be described again.

### First Embodiment

An automobile headlamp (light-emitting device, illuminating device, headlight) 1 will be described below as an embodiment of an illuminating device according to the present invention. An illuminating device according to the present invention may be a headlamp for vehicles and moving objects other than automobiles (for example, humans, ships, aircrafts, submarines, and rockets) or another illuminating device. Examples of other illuminating devices include searchlights, projectors, household lighting fixtures, interior lighting fixtures, and exterior lighting fixtures.

The headlamp 1 may satisfy the light distribution characteristic standard of a main-beam headlight (high beam) or the light distribution characteristic standard of a dipped-beam headlight (low beam).

The headlamp 1 is a headlamp that functions as a high-intensity light source and ensures eye safety.

### (Structure of Headlamp 1)

The structure of the headlamp 1 will be described below with reference to FIG. 2. FIG. 2 is a cross-sectional view of the structure of the headlamp 1. As illustrated in the figure, the headlamp 1 includes a laser diode array 2a, aspheric lenses 3, an optical fiber 40, a ferrule 9, a light-emitting section (wavelength conversion member) 5, a reflector 6, a transparent sheet 7, a housing 10, an extension 11, a lens 12, a heat-conductive member 13, and a cooling section 14.

(Laser Diode Array 2a/Laser Diodes 2)

The laser diode array 2a functions as an excitation light source for emitting excitation light and includes a plurality of laser diodes (excitation light sources, solid-state device light sources) 2 on a substrate. Each of the laser diodes 2 emits a laser beam as excitation light. It is not necessary to use a plurality of laser diodes 2 as excitation light sources, and a single laser diode 2 may be used alone. However, it is easy to produce a high-power laser beam with a plurality of laser diodes 2.

Each of the laser diodes 2 may have one luminous point per chip or a plurality of luminous points per chip. More specifically, for example, each of the laser diodes 2 emits a laser beam of 405 nm (blue-violet), has an output of 1.0 W, an operating voltage of 5 V, and an electric current of 0.6 A, and is sealed in a package having a diameter of 5.6 mm.

The peak wavelength of a laser beam emitted by the laser diodes 2 is not limited to 405 nm and may be 380 nm or more and 470 nm or less. For example, the laser diodes 2 may emit a laser beam of 450 nm (blue) (or a laser beam having a peak wavelength of 440 nm or more and 490 nm or less, that is, in the vicinity of “blue”).

In the case that a short-wavelength laser diode of good quality that can emit a laser beam having a wavelength of less than 380 nm can be manufactured, a laser diode configured to emit a laser beam having a wavelength of less than 380 nm may be used as the laser diodes 2 of the present embodiment.

The diameter of the package is not limited to 5.6 mm and may be 3.8 or 9 mm, for example. The package preferably has low thermal resistance.

Although a laser diode is used as an excitation light source in the present embodiment, a light-emitting diode may be used instead of the laser diode.

### (Aspheric Lenses 3)

The aspheric lenses 3 allow a laser beam (excitation light) emitted from the laser diodes 2 to enter inlet ends 40b of the optical fiber 40. For example, the aspheric lenses 3 may be FLKN 1405 manufactured by Alps Electric Co., Ltd. The shape and material of the aspheric lenses 3 are not particularly limited, provided that the aspheric lenses 3 have the function described above. Preferably, the material is transparent to light at 405 nm and its vicinity and has high heat resistance.

### (Optical Fiber 40)

### (Arrangement of Optical Fiber 40)

The optical fiber 40 is a light guide member for guiding a laser beam emitted from the laser diodes 2 to the light-emitting section 5 and is a bundle of a plurality of optical fibers. The optical fiber 40 includes the inlet ends 40b for receiving the laser beam and a plurality of outlet ends 40a for emitting the laser beam that has entered the inlet ends 40b. Different regions on a laser beam irradiation surface 5a (a excitation light irradiation surface) of the light-emitting section 5 are irradiated with the laser beam emitted through the outlet ends 40a.

For example, the outlet ends 40a of the optical fiber 40 are parallel to the laser beam irradiation surface 5a. This arrangement allows different portions on the laser beam irradiation surface 5a of the light-emitting section 5 to be irradiated with the highest intensity portion (the midsection (maximum intensity section) of an irradiated region on the laser beam irradiation surface 5a) in the intensity distribution of the laser beam emitted through the outlet ends 40a. Thus, the laser beam irradiation surface 5a of the light-emitting section 5 can be two-dimensionally irradiated with the laser beam. This can prevent the light-emitting section 5 from deteriorating significantly in part because of local laser beam irradiation of the light-emitting section 5.

When a high-power laser beam is used as excitation light, in a very small light-emitting section 5, a component of excitation light absorbed by the light-emitting section 5 and converted into heat rather than converted into fluorescence by a fluorescent material easily increases the temperature of the light-emitting section 5. This may impair the characteristics of the light-emitting section 5 or cause thermal damage to the light-emitting section 5.

As described above, two-dimensionally dispersed laser beam irradiation of the light-emitting section 5 can prevent any portion of the light-emitting section 5 from thermally deteriorating significantly.

The optical fiber 40 is not necessarily a bundle of optical fibers (a structure having a plurality of outlet ends 40a) and may be a single optical fiber.

### (Material and Structure of Optical Fiber 40)

The optical fiber 40 has a two-layer structure composed of a core and a clad, which covers the core and has a lower refractive index than the core. The core is mainly composed of quartz glass (silicon oxide), which has little absorption loss of a laser beam. The clad is mainly composed of quartz glass or synthetic resin material that has a lower refractive index than the core. For example, the optical fiber 40 has a core diameter of 200 μm, a clad diameter of 240 μm, and a numerical aperture NA of 0.22 and is made of quartz. The structure, thickness, and material of the optical fiber 40 are not limited to those described above. The cross section of the optical fiber 40 perpendicular to the longitudinal axis may be rectangular.

Because of visibility of the optical fiber 40, the relative positional relationship between the laser diodes 2 and the light-emitting section 5 can be easily altered. The length of the optical fiber 40 can be controlled to separate the laser diodes 2 from the light-emitting section 5.

This allows the laser diodes 2 to be disposed in a position in which the laser diodes 2 are easy to cool or replace, thereby improving the design flexibility of the headlamp 1.

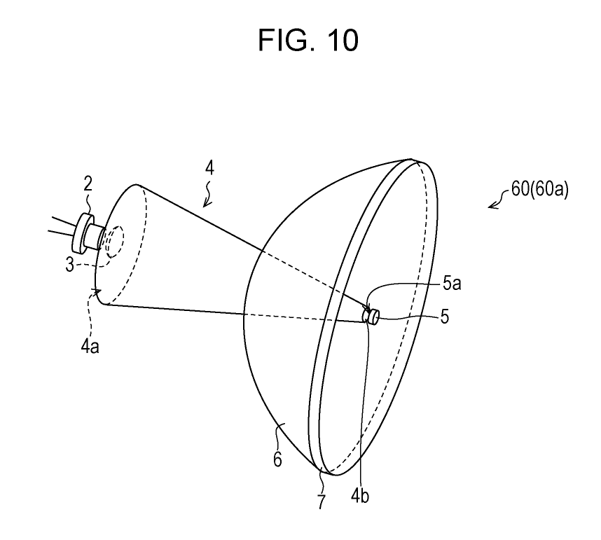

The light guide member is not limited to an optical fiber and may be any member that can guide a laser beam from the laser diodes 2 to the light-emitting section 5. For example, at least one truncated-cone-(or truncated-pyramid-)shaped light guide member having an inlet end and an outlet end for a laser beam may be used (see, for example, FIG. 10). A laser beam from the laser diodes 2 may be projected directly or via an optical system, such as a reflecting mirror, onto the light-emitting section 5.

### (Ferrule 9)

The ferrule 9 holds the outlet ends 40a of the optical fiber 40 arranged in a predetermined pattern relative to the laser beam irradiation surface 5a of the light-emitting section 5. The ferrule 9 may have openings for inserting the outlet ends 40a arranged in a predetermined pattern. The ferrule 9 may include separable upper and lower portions and hold the outlet ends 40a between grooves in the joint surfaces of the upper and lower portions.

The ferrule 9 may be fixed to the reflector 6 with a rod-like or tubular member extending from the reflector 6 or may be fixed to the heat-conductive member 13. The material of the ferrule 9 is not particularly limited and is stainless steel, for example. A plurality of ferrules 9 may be arranged for one light-emitting section 5.

In the case that the optical fiber 40 has only one outlet end 40a, the ferrule 9 may be omitted.

### (Light-Emitting Section 5)

### (Composition of Light-Emitting Section 5)

FIG. 1 is a detail view of the light-emitting section 5 and the heat-conductive member 13 of the headlamp 1 according to the present embodiment. The light-emitting section 5 emits light upon receiving a laser beam emitted through the outlet ends 40a and contains a fluorescent material for emitting light upon receiving the laser beam (a fluorescent substance; fluorescent material particles 16 illustrated in FIG. 3) and diffusing particles (a diffusing member) 15. The fluorescent material and the diffusing particles 15 are dispersed in a glass material sealant. The light-emitting section 5 is disposed at approximately the focal position of the reflector 6.

The light-emitting section 5 contains at least one of blue, green, and red fluorescent materials.

Upon irradiation of the light-emitting section 5 with a laser beam from the laser diodes 2, a plurality of colors are mixed to form white light. Thus, the light-emitting section 5 is a wavelength conversion material (or a wavelength conversion member). White light or pseudo-white light can be made up by the color mixing of three colors that satisfy the isochromatic principle or the color mixing of two colors that satisfy the relationship of complementary colors. On the basis of these principle and relationship, the color of a laser beam from the laser diodes and the color of light from the fluorescent material can be combined as described above to produce white light or pseudo-white light.

For example, when the laser diodes 2 emit a laser beam of 405 nm (blue-violet), the fluorescent material of the light-emitting section 5 is a mixture of a green fluorescent material and a red fluorescent material. When the laser diodes 2 emit a laser beam of 450 nm (blue), the fluorescent material of the light-emitting section 5 is a yellow fluorescent material or a mixture of a green fluorescent material and a red fluorescent material. The laser diodes 2 may emit a laser beam of 450 nm (blue) (or a laser beam having a peak wavelength of 440 nm or more and 490 nm or less, that is, in the vicinity of “blue”). In this case, the fluorescent material is a yellow fluorescent material or a mixture of a green fluorescent material and a red fluorescent material.

The yellow fluorescent material is a fluorescent material that emits light having a peak wavelength of 560 nm or more and 590 nm or less. The green fluorescent material is a fluorescent material that emits light having a peak wavelength of 510 nm or more and 560 nm or less. The red fluorescent material is a fluorescent material that emits light having a peak wavelength of 600 nm or more and 680 nm or less.

### (Type of Fluorescent Material)

The fluorescent material of the light-emitting section 5 is preferably an oxynitride-based fluorescent material, a nitride-based fluorescent material, or a group III-V compound semiconductor nanoparticle fluorescent material. These materials are resistant to a very strong laser beam (output and optical density) emitted from the laser diodes 2 and are best suited for laser illumination sources.

Some typical oxynitride-based fluorescent materials are commonly known as sialon fluorescent materials. Sialon fluorescent materials are substances in which the silicon atoms of silicon nitride are partly substituted by aluminum atoms and the nitrogen atoms of the silicon nitride are partly substituted by oxygen atoms. Sialon fluorescent materials can be produced from solid solution of alumina (Al₂O₃), silica (SiO₂), and a rare-earth element in silicon nitride (Si₃N₄).

One of the characteristics of semiconductor nanoparticle fluorescent materials is that the particle size of a single compound semiconductor (for example, indium phosphide: InP) can be altered in a certain range on the order of nanometers to change luminescent color by the quantum size effect. For example, InP having a particle size in the range of approximately 3 to 4 nm emits red light (the particle size is measured with a transmission electron microscope (TEM)).

Semiconductor nanoparticle fluorescent materials, which are based on semiconductors, have a short fluorescence lifetime and can rapidly convert the excitation light power into fluorescence. Thus, semiconductor nanoparticle fluorescent materials are resistant to high-power excitation light. This is because the emission lifetime of semiconductor nanoparticle fluorescent materials is approximately 10 nanoseconds, which is five orders of magnitude shorter than the emission lifetime of general fluorescent materials containing a rare earth as a luminescent center.

Because of its short emission lifetime as described above, semiconductor nanoparticle fluorescent materials can rapidly and repeatedly absorb a laser beam and emit light. Consequently, semiconductor nanoparticle fluorescent materials can maintain high efficiency for a strong laser beam and reduce heat generation.

### (Sealant)

The sealant may be an inorganic glass having a thermal conductivity of approximately 1 W/mK (a heat-resistant sealant). Among inorganic glasses, low-melting glasses are particularly preferred.

Because of high heat resistance of glass, a sealant made of a glass material can prevent the degradation of the light-emitting section 5 even when the fluorescent material is irradiated with a laser beam and generates heat. Furthermore, unlike silicone resin sealants, discoloration of the sealant resulting from the degradation of the resin due to long-term exposure to light rarely occurs.

Use of a low-melting glass as the sealant allows the fluorescent material to be dispersed in the glass material at a low temperature, thereby preventing the thermal degradation of the fluorescent substance and facilitating the manufacture of the light-emitting section.

The low-melting glass preferably has a glass transition point of 600° C. or less and preferably contains at least one of SiO₂, B₂O₃, and ZnO. The addition of SiO₂, B₂O₃, or ZnO can reduce the glass transition point and the baking temperature and maintain the transparency of the low-melting glass while stabilizing the low-melting glass.

The glass material has a composition of SiO₂-α₂O₃—CaO—BaO—Li₂O—Na₂O, for example. This low-melting glass has a melting point of 550° C.

The ratio of the sealant to the fluorescent material in the light-emitting section 5 is approximately 10:1.

The sealant is not limited to the inorganic glass and may be an organic inorganic hybrid glass or a resin material, such as a silicone resin. The sealant made of an inorganic glass as described above can improve the heat resistance of the light-emitting section 5 and reduce the thermal resistance (increase the thermal conductivity) of the light-emitting section 5. Thus, inorganic glasses are preferred.

### (Diffusing Particles 15)

The diffusing particles 15 are filler (a scattering member) that diffuses (scatters) a laser beam emitted from the laser diodes 2 and reaching the light-emitting section 5, thereby converting the laser beam having high coherence (spatial coherence) and a very small luminous point size into light having a large luminous point size that has little effect on the human body. In other words, the diffusing particles 15 are particles for increasing the luminous point size (apparent light source size) of the headlamp 1.

### <Significance of Diffusing Particles 15>

The significance of the diffusing particles 15 in the light-emitting section 5 will be described below.

When high-energy light emitted from a light source having a small spot size enters the human eye, the light source image is narrowed to the spot size on the retina. This may markedly increase the energy density at the image formation point. For example, a laser beam from a laser diode device may have a spot size of less than 10 μm per side. Light from such a light source entering the eye directly or through an optical member, such as a lens or a mirror, such that its small luminous point can be directly seen may cause damage to the image formation point on the retina.

In order to avoid this, the luminous point size must be larger than a finite size (more specifically, for example, at least 1 mm×1 mm).

Typical high-power laser diodes have a luminous point size of 1 μm×10 μm, for example. The area is 10 μm²=1.0×10⁻⁵ mm². Even for light having the same energy, the energy density of the image formation region on the retina is 10⁵ times that of a light source having a luminous point of 1 mm².

An increase in luminous point size can result in an increase in image formation size on the retina and a decrease in energy density on the retina even for incident light having the same energy.

In order to increase the luminous point size, the luminous point of the light source should be visually unrecognizable. To this end, in the present embodiment, the light-emitting section 5 contains the diffusing particles 15, and the diffusing particles 15 diffuse a laser beam.

Even without the diffusing particles 15, the light-emitting section 5 has a function of diffusing a laser beam to some extent. This diffusion function can be achieved by utilizing a difference in refractive index between the sealant and the fluorescent material in the light-emitting section 5. To this end, the light emitting section 5 is designed to have a volume (particularly a thickness) that allows sufficient diffusion of a laser beam. This can ensure eye safety to some extent. In addition to this, the light-emitting section 5 can contain the diffusing particles 15 to further enhance the diffusing function of the light emitting section 5 and further ensure eye safety.

An increase in luminous point size can be taken into account not only in laser sources but also LED light sources. Since a laser beam is more monochromatic or more uniform in wavelength than light emitted from LED light sources, the laser beam causes less blurring of an image on the retina due to a difference in wavelength (chromatic aberration) and is therefore more harmful than light emitted from LED light sources. Thus, it is particularly preferable to consider an increase in luminous point size in an illuminating device that utilizes light from a laser source as illumination light.

### <Specific Example of Diffusing Particles 15>

The diffusing particles 15 may be any particles that have an effect of diffusing light and that are resistant to heat during the manufacture of the light-emitting section 5 and may be made of fumed silica, Al₂O₃, zirconium oxide, or diamond. Among these, zirconium oxide or diamond is particularly preferred.

A larger difference in refractive index between adjacent two substances results in wider diffusion of light passing between the substances. Thus, a larger difference in refractive index between the diffusing particles 15 and the sealant can result in more effective diffusion of a laser beam. More specifically, the difference in refractive index between the diffusing particles 15 and the sealant is preferably 0.2 or more. When the difference in refractive index is 0.2 or more, the diffusing particles 15 can be practically used.

For the sealant made of an inorganic glass, since the inorganic glass has a refractive index in the range of approximately 1.5 to 1.8, the diffusing particles 15 preferably has a refractive index in the range of approximately 1.7 to 2.0 or more, more preferably 2.0 or more to further ensure the diffusion effect.

Zirconium oxide has a refractive index of 2.4, and diamond has a refractive index of 2.42. Use of such a substance having a high refractive index as the diffusing particles 15 can enhance the effect of diffusing a laser beam.

Since zirconium oxide has a melting point of 2715° C., and diamond has a melting point of 3550° C., they do not melt or deteriorate at melting temperatures of common sealants. Also in this respect, zirconium oxide and diamond are suitable for materials that are dispersed in the sealant as the diffusing particles 15.

The diffusing particles 15 are preferably highly transparent or translucent. The diffusing particles 15 of low transparency or translucency may intercept or absorb a laser beam emitted from the laser diodes 2 and fluorescence emitted from the fluorescent material. Thus, the diffusing particles 15 are preferably highly transparent or translucent in terms of the use efficiency of a laser beam.

Because of their high transparency or translucency, zirconium oxide and diamond are suitable for the diffusing particles 15 also in terms of light transmission.

Silica, which is frequently used as diffusing fine particles, has a refractive index of 1.46 and has a small scattering effect in inorganic glasses (refractive index: 1.5 to 1.8). Y₂O₃ (yttria) (refractive index: 1.91), which is used for the same purpose, has a refractive index of less than 2, which is similar to the refractive index of a low-melting glass, and has a small diffusion effect.

### (Shape and Size of Light-Emitting Section 5)

The light-emitting section 5 in the present embodiment may be cylindrical and have a diameter of 3.2 mm and a thickness of 1 mm. A laser beam from the outlet ends 40a reaches the laser beam irradiation surface 5a, which corresponds to the bottom of the cylinder.

The light-emitting section 5 may be rectangular cuboid rather than cylindrical. For example, the light-emitting section 5 is a 3 mm×1 mm×1 mm rectangular parallelepiped. The light distribution pattern (light intensity distribution) of vehicle headlamps legally defined in Japan is narrow in the vertical direction and wide in the horizontal direction. Thus, the shape of the light-emitting section 5 is elongated in the horizontal direction (a generally rectangular cross section) to easily realize the light distribution pattern.

The required thickness of the light-emitting section 5 depends on the ratio of the sealant to the fluorescent material in the light-emitting section 5. A high fluorescent material content of the light-emitting section 5 results in high conversion efficiency from a laser beam into white light and a decrease in the thickness of the light-emitting section 5. Although a decrease in the thickness of the light-emitting section 5 is effective in decreasing thermal resistance, an excessively small thickness may result in the emission of a laser beam to the outside without conversion to fluorescence.

In order to reduce this possibility, it is effective to increase the amount of diffusing particles 15 (mixing ratio) in the light-emitting section 5 or use the diffusing particles 15 having a large diffusion effect. This can reduce the possibility that a coherent laser beam leaks out even when the light-emitting section 5 has a small thickness. A decrease in the thickness of the light-emitting section 5 results in a decrease in the thermal resistance of the light-emitting section 5 and an improvement in the heat dissipation characteristics of the light-emitting section 5.

With respect to the absorption efficiency of excitation light in the fluorescent material, the thickness of the light-emitting section is preferably at least 10 times the particle size of the fluorescent material.

Thus, the light-emitting section 5 made of an oxynitride-based fluorescent material and a nitride-based fluorescent material preferably has a thickness of 0.2 mm or more and 2 mm or less. For an excessively high fluorescent material content (typically the fluorescent material accounts for 100%), the minimum thickness is not limited to this.

From this viewpoint, the light-emitting section containing a nanoparticle fluorescent material may have a thickness of 0.01 μm or more, preferably 10 μm or more or 0.01 mm or more in terms of dispersion in the sealant and the ease of manufacture. On the other hand, an excessive increase in the thickness results in a large deviation from the focal point of the reflector 6 and blurring of a light distribution pattern.

The laser beam irradiation surface 5a of the light-emitting section 5 is not necessarily flat and may be curved. In order to control a reflected laser beam, however, the laser beam irradiation surface 5a is preferably flat. In the case that the laser beam irradiation surface 5a is curved, at least the incident angle on the curved surface varies greatly, and the direction of reflected light varies greatly with the irradiation position. Thus, it is sometimes difficult to control the reflection direction of a laser beam. In contrast, for the flat laser beam irradiation surface 5a, the direction of reflected light remains almost unchanged even with slight variations in the laser beam irradiation position. Thus, the reflection direction of the laser beam is easy to control. If necessary, it is easy to place a laser-beam-absorbing material on a portion to be irradiated with reflected light.

The laser beam irradiation surface 5a is not necessarily perpendicular to the optical axis of the laser beam. The laser beam irradiation surface 5a perpendicular to the optical axis of the laser beam reflects the laser beam toward the laser source and may cause damage to the laser source.

### (Modified Example of Light-Emitting Section 5)

The particles in the light-emitting section 5 illustrated in FIG. 1 may be a heat-conductive filler 15a described below instead of the diffusing particles 15 described in the present embodiment or may be particles having the functions of a heat-conductive filler and diffusing particles. For example, particles formed of Al₂O₃ (sapphire) beads or diamond (beads) have the functions of a heat-conductive filler and diffusing particles.

### (Reflector 6)

The reflector 6 reflects light emitted from the light-emitting section 5 to form a bundle of rays that travels within a predetermined solid angle. In other words, the reflector 6 reflects light emitted from the light-emitting section 5 to form a bundle of rays that travels toward the headlamp 1. For example, the reflector 6 is a curved (cup-shaped) member on which a thin metal film is formed.

The reflector 6 is not limited to a hemispherical mirror and may be an ellipsoidal mirror, a parabolic mirror, or a mirror having part of these curved surfaces. The reflective surface of the reflector 6 includes at least part of a curved surface formed by rotating a figure (an ellipse, a circle, or a parabola) on the rotation axis.

### (Transparent Sheet 7)

The transparent sheet 7 is a transparent resin sheet that covers the opening of the reflector 6. The transparent sheet 7 is preferably made of a material that intercepts a laser beam emitted from the laser diodes 2 and that transmits white light (incoherent light) formed by converting the laser beam in the light-emitting section 5. The light-emitting section 5 converts most of the coherent laser beam into incoherent white light. However, part of the laser beam may remain unconverted from any cause. Even in such a case, the transparent sheet 7 can intercept the laser beam to prevent the laser beam from leaking out.

The transparent sheet 7, together with the heat-conductive member 13, may be used to fix the light-emitting section 5. More specifically, the light-emitting section 5 may be disposed between the heat-conductive member 13 and the transparent sheet 7. In this case, the transparent sheet 7 functions as a holding portion for holding the relative positional relationship between the light-emitting section 5 and the heat-conductive member 13.

In the case that the transparent sheet 7 is one having higher thermal conductivity than resins (for example, an inorganic glass), the transparent sheet 7 can also function as a heat-conductive member and effectively dissipate the heat of the light-emitting section 5.

In the case that the light-emitting section 5 is fixed with the heat-conductive member 13 alone, the transparent sheet 7 may be omitted.

### (Housing 10)

The housing 10 constitutes the main body of the headlamp 1 and houses the reflector 6. The optical fiber 40 passes through the housing 10. The laser diode array 2a is disposed outside of the housing 10. Although the laser diode array 2a generates heat while emitting a laser beam, the laser diode array 2a disposed outside of the housing 10 can be efficiently cooled. This prevents the characteristic degradation of or thermal damage to the light-emitting section 5 due to heat generated from the laser diode array 2a.

In consideration of a failure, the laser diodes 2 are preferably installed in a position in which the laser diodes 2 can be easily replaced. Without such consideration, the laser diode array 2a may be housed in the housing 10.

### (Extension 11)

The extension 11 is disposed in front of the periphery of the reflector 6 and covers the inner structure of the headlamp 1 to enhance the appearance of the headlamp 1 and the integrity of the reflector 6 and an automobile body. The extension 11 has a thin metal film on its surface as in the reflector 6.

### (Lens 12)

The lens 12 covers the opening of the housing 10 and seals the headlamp 1. Light emitted from the light-emitting section 5 and reflected by the reflector 6 passes through the lens 12 and is emitted forward from the headlamp 1.

### (Heat-Conductive Member 13)

The heat-conductive member 13 is disposed on the laser beam irradiation surface (excitation light irradiation surface) 5a, which is to be irradiated with excitation light in the light-emitting section 5. The heat-conductive member 13 is a light-transmitting member for receiving heat from the light-emitting section 5 and is thermally (that is, such that thermal energy can be given and received) connected to the light-emitting section 5. The light-emitting section 5 may be connected to the heat-conductive member 13 with an adhesive, for example.

The heat-conductive member 13 is a sheet member. One end of the heat-conductive member 13 is thermally connected to the laser beam irradiation surface 5a of the light-emitting section 5. The other end is thermally connected to the cooling section 14.

The heat-conductive member 13 having such a shape and connection holds the very small light-emitting section 5 at a particular position and dissipates the heat of the light-emitting section 5 to the outside of the headlamp 1. In FIG. 1, the arrows in the heat-conductive member 13 indicate heat flow.

In order to efficiently dissipate the heat of the light-emitting section 5, the heat-conductive member 13 preferably has a thermal conductivity of 20 W/mK or more. A laser beam from the laser diodes 2 reaches the light-emitting section 5 via the heat-conductive member 13. Thus, the heat-conductive member 13 is preferably made of a light-transmitting material.

With these points taken into account, the material of the heat-conductive member 13 is preferably sapphire (Al₂O₃), magnesia (MgO), gallium nitride (GaN), or spinel (MgAl₂O₄). Use of these materials can achieve the thermal conductivity of 20 W/mK or more.

In FIG. 1, the thickness of the heat-conductive member 13 denoted by the reference numeral 13c is preferably 0.3 mm or more and 5.0 mm or less. A thickness of less than 0.3 mm may result in insufficient heat dissipation of the light-emitting section 5 and a degradation of the light-emitting section 5. A thickness of more than 5.0 mm results in an increase in absorption of an emitted laser beam in the heat-conductive member 13 and a decrease in use efficiency of excitation light.

The heat-conductive member 13 having an appropriate thickness in contact with the light-emitting section 5 can rapidly and efficiently dissipate heat in the light-emitting section 5 and prevent the light-emitting section 5 from being damaged (deteriorating) even under irradiation with a very strong laser beam of more than 1 W.

The heat-conductive member 13 may be a sheet having no bend or may have a bend or a flexure. A portion of the light-emitting section 5 to be bonded is preferably flat (plane) in terms of bonding stability.

### (Modified Example of Heat-Conductive Member 13)

The heat-conductive member 13 may include a portion for transmitting light (a light-transmitting portion) and a portion that does not transmit light (a light-shielding portion). In this structure, the light-transmitting portion is disposed so as to cover the laser beam irradiation surface 5a of the light-emitting section 5, and light-shielding portion is disposed outside of the light-transmitting portion.

The light-shielding portion may be a heat dissipation part made of a metal (for example, copper or aluminum) or a light-transmitting member having an illumination light reflection film, for example, made of aluminum or silver, on its surface.

### (Cooling Section 14)

The cooling section 14 is a member for cooling the heat-conductive member 13, for example, a heat sink block having high thermal conductivity made of a metal, such as aluminum or copper. In the case that the reflector 6 is made of a metal, the reflector 6 may serve as the cooling section 14. Alternatively, the cooling section 14 may be a cooling apparatus for cooling the heat-conductive member 13 by circulating a coolant in the interior thereof or a cooling apparatus (fan) for cooling the heat-conductive member 13 by wind cooling.

In the case that the cooling section 14 is a metal block, the metal block may have radiating fins on its top surface. This structure can increase the surface area of the metal block and make heat dissipation from the metal block more efficient.

The cooling section 14 is not essential for the headlamp 1. The heat-conductive member 13 may spontaneously dissipate the heat of the light-emitting section 5. The cooling section 14 can improve the efficiency of heat dissipation from the heat-conductive member 13 and is particularly effective when the light-emitting section 5 generates heat of 3 W or more.

The length of the heat-conductive member 13 can be controlled to separate the cooling section 14 from the light-emitting section 5. In this case, although the cooling section 14 is housed in the housing 10 in FIG. 2, the cooling section 14 may be disposed outside the housing 10 with the heat-conductive member 13 passing through the housing 10.

This allows the cooling section 14 to be installed in a position in which the cooling section 14 can be easily repaired or replaced in the event of a failure, thereby improving the design flexibility of the headlamp 1.

### (Specific Example of Light-Emitting Section 5 and Method for Manufacturing Light-Emitting Section 5)

A specific example of the light-emitting section 5 and a method for manufacturing the light-emitting section 5 will be described below. FIG. 3 is a schematic view of the diffusing particles 15 and the fluorescent material particles 16 dispersed in an inorganic glass 17 in the light-emitting section 5. FIG. 3 conceptually illustrates the position of each particle and does not precisely reflect the relative size of the diffusing particles 15 and the fluorescent material particles 16.

### First Example

In a first example described below, synthetic diamond particles are used as the diffusing particles 15, and a green-light-emitting fluorescent material (Caα-SiAlON:Ce³⁺) and a red-light-emitting fluorescent material (CASN:Eu²⁺) are used as fluorescent materials. An excitation light source used in combination with the light-emitting section 5 containing these fluorescent materials is a laser diode that emits light at 405 nm.

First, a glass powder and a fluorescent material powder are weighed at a predetermined ratio and are uniformly mixed (a mixing step). For example, a glass powder and the green-light-emitting fluorescent material (Caα-SiAlON:Ce³⁺) and the red-light-emitting fluorescent material (CASN:Eu²⁺) are mixed at a weight ratio of glass powder:green-light-emitting fluorescent material:red-light-emitting fluorescent material=100:6:2. Synthetic diamond particles (having a particle size of 1 μm) are then added to the mixture. The synthetic diamond particles constitute approximately 5% of the weight of the light-emitting section (the total weight of a sealant and the fluorescent materials). The particles are uniformly mixed.

The mixing may be performed by manually shaking a container containing the powders or by using a mixing apparatus.

At a high fluorescent material concentration of the light-emitting section 5, the fluorescent material particles 16 are preferably uniformly dispersed in the sealant, as illustrated in FIG. 3. This is because the concentration of the fluorescent material particles 16 in one place results in a large amount of heat generation in that place, possibly causing a decrease in luminous efficiency and a degradation of the light-emitting section 5. Thus, it is important to pay attention to uniform dispersion of the particles through mixing.

Since the effect of the diffusing particles 15 in diffusing a laser beam spreads over the light-emitting section 5, the diffusing particles 15 are preferably uniformly dispersed in the sealant.

After the mixing step, the mixed powder is heated in a metal mold (mold), for example, at 550° C. for one hour to form a light-emitting section (a baking step).

### Second Example

The fluorescent material to be dispersed in the light-emitting section 5 that contains an inorganic glass as a sealant may be a yellow-light-emitting fluorescent material exemplified by a YAG fluorescent material. The weight ratio of the inorganic glass to the fluorescent material is 10:1. Zirconium oxide is then added to the mixture of the inorganic glass powder and the fluorescent material powder. Zirconium oxide constitutes 3% by weight of the mixture. The mixture is then sintered to form a light-emitting section.

When a YAG fluorescent material is used, a sealant having a particularly low melting point of (500° or less) among low-melting glasses is preferably used. For example, low-melting glasses containing lead oxide or phosphate glasses have particularly low melting points among low-melting glasses and are suitable for the sealant for the YAG fluorescent material.

An excitation light source used for the YAG fluorescent material is preferably a blue laser diode that emits light in the range of 440 to 470 nm. In particular, when a laser diode that emits light in a blue region is used as an excitation light source, excitation light constitutes a main part of illumination light, and therefore eye safety is particularly important. More specifically, blue of the laser beam and yellow of the fluorescent material are combined to produce pseudo-white in this constitution, and part of the laser beam is emitted outward through the headlamp 1 as illumination light. In this case, a cutoff filter for intercepting the laser beam (the transparent sheet 7) cannot be installed. Thus, it is important to sufficiently diffuse the laser beam in the light-emitting section 5.

The diffusing particles 15 in the light-emitting section 5 sufficiently diffuse the blue laser beam emitted outward through the light-emitting section 5, thereby increasing the luminous point size. Thus, also in the generation of pseudo-white illumination light using the blue laser beam, a safe solid-state illumination source can be realized.

### (Specific Example of Excitation Light Source)

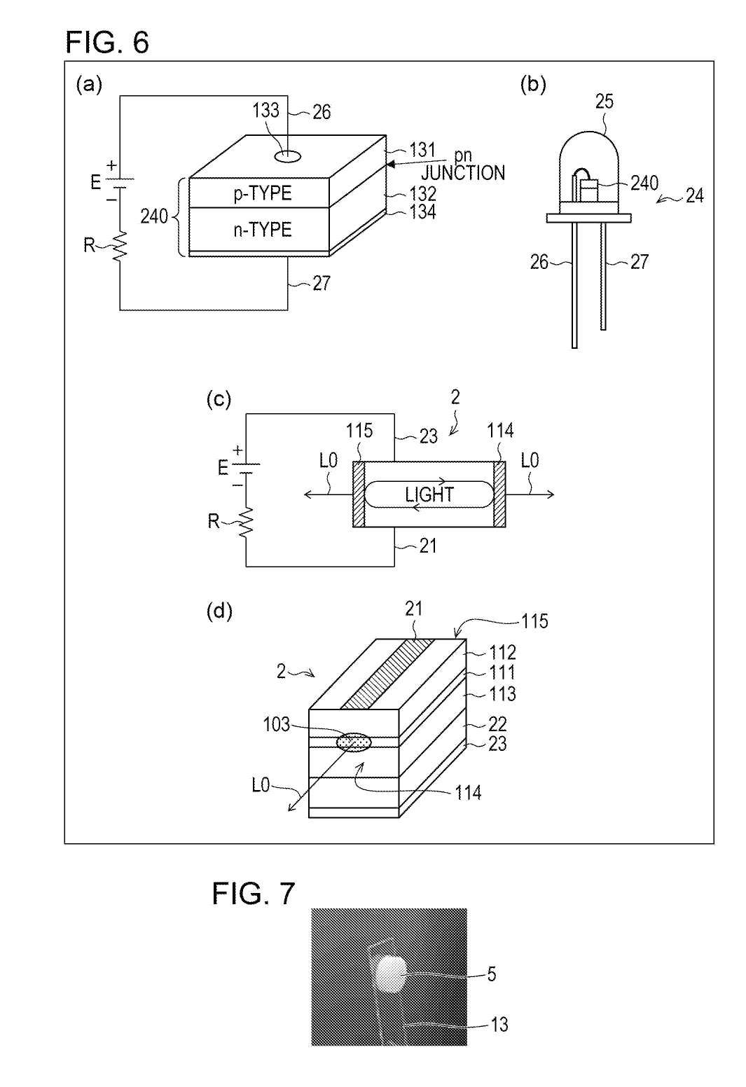

A specific example of the excitation light source will be described below with reference to FIGS. 6(a) to 6(d).

FIG. 6 is a view of a specific example of an excitation light source. FIG. 6(a) illustrates a circuit of a LED lamp (excitation light source) 24 as an example of an excitation light source. FIG. 6(b) is a front view of the appearance of the LED lamp 24.

As illustrated in FIG. 6(b), the LED lamp 24 includes a LED chip (excitation light source) 240 covered with an epoxy resin cap 25 and connected to an anode 26 and a cathode 27.

As illustrated in FIG. 6(a), in the LED chip 240, a p-type semiconductor 131 and an n-type semiconductor 132 form a pn junction. A p-type electrode 133 is connected to the anode 26, and an n-type electrode 134 is connected to the cathode 27. The LED chip 240 is connected to a power supply E through a resistance R.

The anode 26 and the cathode 27 are connected to the power supply E to constitute a circuit. Electric power is supplied from the power supply E to the LED chip 240, thereby producing incoherent excitation light from the vicinity of the pn junction.

Examples of the material of the LED chip 240 include GaP, AlGaAs, and GaAsP that produce a red luminescent color, GaAsP that produces an orange luminescent color, GaAsP and GaP that produce yellow luminescent color, GaP that produces a green luminescent color, and compound semiconductors, such as SiC and GaN, that produce a blue luminescent color.

The LED chip 240 operates at a low voltage in the range of approximately 2 to 4 V, is small and lightweight, has a high response speed, has a long life, and is inexpensive.

The basic structure of the laser diodes 2 will be described below. FIG. 6(c) is a schematic view of a circuit of a laser diode 2. FIG. 6(d) is the appearance (basic structure) of the laser diode 2 viewed from the lower right. As illustrated in the figure, the laser diode 2 includes an anode 23, a substrate 22, a clad layer 113, an active layer 111, a clad layer 112, and a cathode 21 stacked in this order.

The substrate 22 is a semiconductor substrate. In order to produce excitation light from a blue wavelength range to an ultraviolet wavelength range for exciting a fluorescent material as in the present application, the substrate 22 is preferably made of GaN, sapphire, or SiC. In general, other examples of the substrate for laser diodes include group IV semiconductors, such as Si, Ge, and SiC, group III-V compound semiconductors exemplified by GaAs, GaP, InP, AlAs, GaN, InN, InSb, GaSb, and AlN, group II-VI compound semiconductors, such as ZnTe, ZeSe, ZnS, and ZnO, oxide insulators, such as ZnO, Al₂O₃, SiO₂, TiO₂, CrO₂, and CeO₂, and nitride insulators, such as SiN.

The cathode 21 supplies an electric current to the active layer 111 through the clad layer 112.

The anode 23 supplies an electric current to the active layer 111 from the lower portion of the substrate 22 through the clad layer 113. The electric current is supplied under a forward bias applied to the anode 23 and the cathode 21.

The active layer 111 is disposed between the clad layer 113 and the clad layer 112.

The material of the active layer 111 and the clad layers 112 and 113 is a mixed crystal semiconductor AlInGaN in order to produce excitation light from the blue wavelength range to the ultraviolet wavelength range. In general, active layers and clad layers of laser diodes are made of a mixed crystal semiconductor mainly composed of Al, Ga, In, As, P, N, and/or Sb. Such a composition may also be used. II-VI compound semiconductors, such as Zn, Mg, S, Se, Te, and ZnO, may also be used.

The active layer 111 is a region for emitting light upon the application of an electric current. The emitted light is confined in the active layer 111 owing to a refractive index difference between the active layer 111 and the clad layers 112 and 113.

The active layer 111 has a front cleavage plane 114 and a back cleavage plane 115 facing each other for confining light amplified by stimulated emission. The front cleavage plane 114 and the back cleavage plane 115 serve as a mirror.

Unlike a mirror, which completely reflects light, part of light amplified by stimulated emission is emitted from the front cleavage plane 114 and the back cleavage plane 115 (for convenience, the front cleavage plane 114 in the present embodiment) of the active layer 111 and becomes excitation light L0. The active layer 111 may have a multilayer quantum well structure.

The back cleavage plane 115 opposite the front cleavage plane 114 has a reflective film (not shown) for laser oscillation. A difference in reflectivity between the front cleavage plane 114 and the back cleavage plane 115 allows most of the excitation light L0 to be emitted from a luminous point 103 on a low-reflectance end face, for example, the front cleavage plane 114.

The clad layer 113 and the clad layer 112 may be made of any semiconductor selected from III-V compound semiconductors exemplified by n-type and p-type GaAs, GaP, InP, AlAs, GaN, InN, InSb, GaSb, and AlN and II-VI compound semiconductors, such as ZnTe, ZeSe, ZnS, and ZnO, and apply a forward bias to the anode 23 and the cathode 21 to supply the active layer 111 with an electric current.

These semiconductor layers, including the clad layer 113, the clad layer 112, and the active layer 111, may be formed by a common film formation technique, such as metal-organic chemical vapor deposition (MOCVD), molecular beam epitaxy (MBE), chemical vapor deposition (CVD), laser ablation, or sputtering. Each metal layer may be formed by a common film formation technique, such as vacuum evaporation, plating, laser ablation, or sputtering.

### (Light Emission Principle of Light-Emitting Section 5)

The principle of light emission from a fluorescent material in response to a laser beam emitted from the laser diodes 2 will be described below.

When a fluorescent material in the light-emitting section 5 is irradiated with a laser beam emitted from the laser diodes 2, electrons in the fluorescent material are excited from a low energy state to a high energy state (excited state).

Since the excited state is unstable, the energy state of the electrons in the fluorescent material makes a transition to the low energy state (an energy state at a ground level or an energy state at a metastable level between the excitation level and the ground level) after a predetermined period of time.

Transition of electrons excited to the high energy state to the low energy state causes the fluorescent material to emit light.

### (Effects of Headlamp 1)

As described above, the headlamp 1 includes the light-emitting section 5 containing the diffusing particles 15. The diffusing particles 15 diffuse a laser beam in the light-emitting section 5, increase the luminous point size, and improve eye safety. This can realize a safe headlamp that ensures class 1 level eye safety.

### Second Embodiment

Another embodiment of the present invention will be described below with reference to FIGS. 1 to 6. An automobile headlamp (light-emitting device, illuminating device, headlight) 1a will be described below as an embodiment of an illuminating device according to the present invention. An illuminating device according to the present invention may be a headlamp for vehicles and moving objects other than automobiles (for example, humans, ships, aircrafts, submarines, and rockets) or another illuminating device. Examples of other illuminating devices include searchlights, projectors, and household lighting fixtures.

The headlamp 1a may satisfy the light distribution characteristic standard of a main-beam headlight (high beam) or the light distribution characteristic standard of a dipped-beam headlight (low beam).

A main point of difference between the headlamp 1a according to the present embodiment and the headlamp 1 is a difference in the composition of the light-emitting section 5. The other points are the same as the headlamp 1. Thus, only the difference from the headlamp 1 will be described below, and the other points are omitted.

### (Composition of Light-Emitting Section 5)

FIG. 1 is a detail view of the light-emitting section 5 and the heat-conductive member 13 of the headlamp 1a. The light-emitting section (wavelength conversion member) 5 emits light upon receiving a laser beam emitted through the outlet ends 40a and includes the fluorescent material particles 16 for emitting light upon receiving the laser beam and a heat-conductive filler (heat-conductive particles) 15a. The fluorescent material particles 16 and the heat-conductive filler 15a are dispersed in a glass material sealant.

(Heat-Conductive Filler 15a)

The heat-conductive filler 15a may be Al₂O₃ (sapphire) beads having a thermal conductivity in the range of approximately 20 to 40 W/mK or diamond beads having a thermal conductivity in the range of approximately 1000 to 2000 W/mK. Since the Al₂O₃ beads have a melting point of 2030° C., and diamond has a melting point of 3550° C., they do not melt or deteriorate at melting temperatures of common inorganic glasses.

In order to increase the thermal conductivity of the light-emitting section 5, the heat-conductive filler 15a preferably has higher thermal conductivity than the sealant. More preferably, the heat-conductive filler 15a has higher thermal conductivity than the fluorescent material.

The heat-conductive filler 15a is preferably highly transparent or translucent. The heat-conductive filler 15a of low transparency or translucency may intercept or absorb a laser beam emitted from the laser diodes 2 and fluorescence emitted from the fluorescent material particles 16. Thus, the heat-conductive filler 15a is preferably highly transparent or translucent in terms of the use efficiency of a laser beam.

### (Material Combination Example of Components)

A material combination example of the light-emitting section 5, the heat-conductive member 13, and an adhesive for bonding them together will be described below with reference to Tables 1 and 2.

TABLE 1
[Materials of light-emitting section]

| Components | Sealant | Heat-conductive filler | Fluorescent material |
|---|---|---|---|
| Materials | Inorganic glass | Diamond/sapphire | Oxynitride (based on |
| | | | SiN) |
| Thermal conductivity | 1.0 | 2000/25 | 20 |
| (W/mK) | | | |
| Refractive index | 1.627 | 2.42/1.785 | 2.0 |
| Particle size (μm) | — | approximately 1 to 50 | approximately 1 to 50 |
| Thickness | 0.2 to 2.0 mm | — | — |
| Heat resistance (° C.) | <500 | >1000 | <600 to 1000 |
| Transmittance (%) | 87.3 (wavelength 600 nm, | >90% | 15% to 30% |
| (including surface | thickness 1 mm) | | (reciprocal of |
| reflection) | | | absorptance) |

TABLE 2
[Materials of adhesive and heat-conductive member]

| | | Heat-conductive |
|---|---|---|
| Components | Adhesive | member |
| Materials | Epixacolle EP433 | Sapphire |
| Thermal conductivity (W/mK) | 0.2 | 25 (100° C.) |
| Refractive index | 1.50 | 1.785 |
| Thickness | 10 μm | 0.5 mm |
| Heat resistance (° C.) | <150 | >1000 |
| Transmittance (%) (including | 91 (550 nm) | approximately 92% |
| surface reflection) | | |

Table 1 shows that the light-emitting section 5 containing an inorganic glass as a sealant and diamond or sapphire particles as the heat-conductive filler 15a has high thermal conductivity. Consequently, the light-emitting section 5 has low thermal resistance.

Table 2 shows that the heat-conductive member 13 containing a heat-conductive material, such as sapphire, has low thermal resistance, high heat absorption efficiency, and high heat dissipation efficiency.

The thermal resistance of each member can be calculated using the following equation (1).

Thermal resistance=(1/thermal conductivity)×(length of heat dissipation path/heat dissipation cross-sectional area) (1)

The length of the heat dissipation path corresponds to the thickness of each member (the thickness in the transmission direction of a laser beam). The heat dissipation cross-sectional area corresponds to the bonding area between members. Table 3 shows specific calculation examples of thermal resistance.

TABLE 3
[Calculation example of thermal resistance]

| | Sealant in | | Heat- |
|---|---|---|---|
| | light-emitting | | conductive |
| Components | section | Adhesive | member |
| Thermal conductivity (W/mK) | 1.0 | 0.2 | 25 (100° C.) |
| Radiating surface area (m²) | 3 × 10⁻⁶ | 3 × 10⁻⁶ | 1 × 10⁻⁴ |
| Radiating distance (m) | 2.5 × 10⁻⁴ | 1 × 10⁻⁵ | 5 × 10⁻⁴ |
| Thermal resistance (K/W) | 83.3 | 16.7 | 0.2 |

Table 3 shows that the light-emitting section 5, for example, formed of a sealant alone has higher thermal resistance than the adhesive and the heat-conductive member 13. Since the light-emitting section 5 contains a fluorescent material having higher thermal conductivity than the sealant in practice, the light-emitting section 5 has lower thermal resistance than those shown in Table 3. Nevertheless, the thermal resistance of the light-emitting section 5 is at least one order of magnitude higher than the thermal resistance of the heat-conductive member 13.

Thus, the light-emitting section 5 can be mixed with the heat-conductive filler 15a to reduce the thermal resistance of the light-emitting section 5.

For example, a simulation shows that the light-emitting section 5 containing 8% sapphire fine particles (10 μm in diameter) having a thermal conductivity of 25 W/mK has an approximately 1.4 times higher heat sink effect, depending on the dispersion state in the light-emitting section 5. A thermographic observation of an increase in temperature of the light-emitting section shows substantially the same heat generation inhibiting effect (as compared with a 100° C. increase without heat-conductive filler, the addition of 8% sapphire fine particles resulted in a temperature increase of a little over 70° C.)

### (Method for Reducing Thermal Resistance)

A method for reducing the thermal resistance of each member and improving the heat sink effect will be described below for each member.

### <Light-Emitting Section 5>

The following modifications are effective in reducing the thermal resistance of the light-emitting section 5.
Increase the amount of heat-conductive filler 15a to be mixed with.
Increase the radiating surface area (the area in contact with another member). For example, a heat-conductive member is also brought into contact with a surface of the light-emitting section 5 opposite the laser beam irradiation surface 5a.
Decrease the thickness of the light-emitting section 5.

An increase in the number of members in contact with the light-emitting section 5 to increase the radiating surface area, however, may result in a decrease in luminance of the light-emitting section 5. A decrease in volume of the light-emitting section 5 to decrease the thickness of the light-emitting section 5 may result in a decrease in light flux or luminance uniformity. Furthermore, a complicated structure of the light-emitting section 5 to increase the radiating surface area may result in high manufacturing costs.

Thus, a suitable method for reducing the thermal resistance of the light-emitting section 5 is selected with these demerits taken into account.

The thermal conductivity of the light-emitting section 5 depends on not only the material of heat-conductive filler to be mixed with but also the concentration (mixing ratio) of the heat-conductive filler. For example, the addition of a relatively large number of sapphire beads can result in higher thermal conductivity than the addition of a very small amount of diamond paste. Thus, the thermal conductivity of the light-emitting section 5 may be controlled via the material and amount of heat-conductive filler to be mixed with the light-emitting section 5.

The light-emitting section 5 may be mixed with a plurality of heat-conductive fillers.

The light-emitting section 5 may be composed of a fluorescent material and the heat-conductive filler 15a without using a sealant.

### <Adhesive>

The following modifications are effective in reducing the thermal resistance of the adhesive.
Increase the radiating surface area (the area in contact with the light-emitting section 5 and other members).
Decrease the thickness of the adhesive.
Increase the thermal conductivity of the adhesive. For example, a heat-conductive material (for example, a low-melting-point inorganic glass paste to be sintered by heating) is used as the adhesive.

Although the adhesive may be mixed with a heat-conductive filler to reduce the thermal resistance of the adhesive, an inorganic glass paste mixed with a heat-conductive filler is often translucent or opaque and often has a high melting point.

As described below in a third embodiment, the light-emitting section 5 may be attached to the heat-conductive member 13 with a fixing member instead of the adhesive to remove the effects of the adhesive.

### <Heat-Conductive Member 13>

The following modifications are effective in enhancing the heat absorption effect and the heat sink effect of the heat-conductive member 13.
Increase the radiating surface area (the area in contact with the light-emitting section 5).
Increase the thickness of the heat-conductive member 13.
Increase the thermal conductivity of the heat-conductive member 13. For example, a heat-conductive material is used. Alternatively, a member (such as a thin film or a sheet member) having high thermal conductivity is placed on a surface of the heat-conductive member 13.

A thin metal film on a surface of the heat-conductive member 13 may reduce light flux. Surface coating of the heat-conductive member 13 or the formation of another member on a surface of the heat-conductive member 13 increases the manufacturing costs.

### (Method for Manufacturing Light-Emitting Section 5)

A method for manufacturing the light-emitting section 5 will be described below. FIG. 3 is a schematic view of the heat-conductive filler 15a and the fluorescent material particles 16 dispersed in the inorganic glass 17 in the light-emitting section 5.

First, a glass powder, a fluorescent material powder, and the heat-conductive filler 15a are weighed at a predetermined ratio and are uniformly mixed (a mixing step). The mixing may be performed by manually shaking a container containing the powders or by using a mixing apparatus.

At a high fluorescent material concentration of the light-emitting section 5, the fluorescent material particles 16 are preferably uniformly dispersed in the sealant, as illustrated in FIG. 3. This is because the concentration of the fluorescent material particles 16 in one place results in a large amount of heat generation in that place, possibly causing a decrease in luminous efficiency and a degradation of the light-emitting section 5.

Since the effect of the heat-conductive filler 15a in reducing thermal resistance spreads over the light-emitting section 5, the heat-conductive filler 15a is preferably uniformly dispersed in the sealant.

After the mixing step, the mixed powder is baked in a metal mold, for example, at 560° C. for 0.5 hours (a baking step).

When the heat-conductive filler 15a is separated from the fluorescent material particles 16 as illustrated in FIG. 3, the heat of the fluorescent material particles 16 is transferred to the heat-conductive filler 15a via the inorganic glass 17, possibly resulting in an insufficient effect of the heat-conductive filler 15a in reducing thermal resistance.

In order to solve this problem, preferably, the fluorescent material particles 16 and the heat-conductive filler 15a are combined in advance (a combining step), and the complex between the fluorescent material particles 16 and the heat-conductive filler 15a is mixed with the glass powder and is then sintered. In other words, the heat-conductive filler 15a in contact with the fluorescent material particles 16 is preferably dispersed in the light-emitting section 5.

The adhesion strength between the fluorescent material particles 16 and the heat-conductive filler 15a may be such that the fluorescent material particles 16 and the heat-conductive filler 15a are not separated while the complex and the sealant are mixed together and sintered.

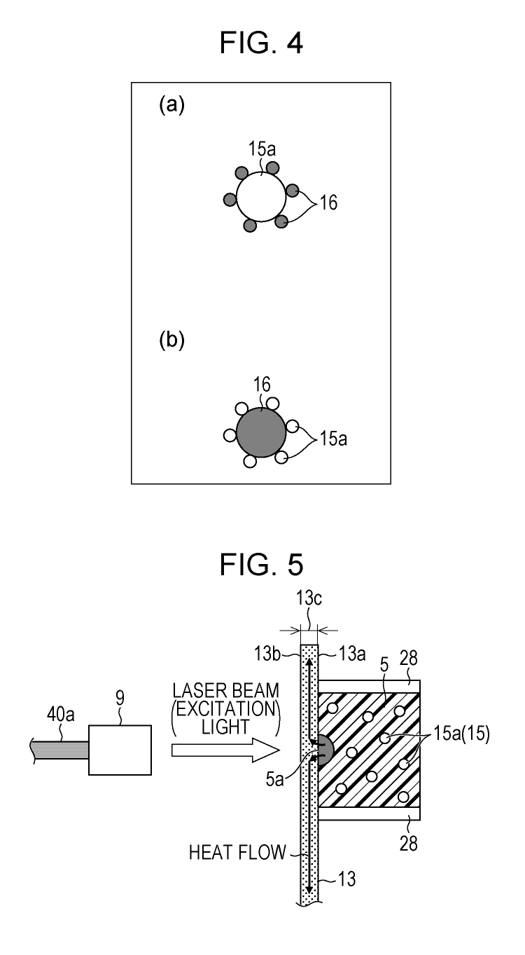

FIG. 4(a) illustrates the fluorescent material particles 16 disposed on the surface of the heat-conductive filler 15a. FIG. 4(b) illustrates the heat-conductive filler 15a disposed on the surface of one of the fluorescent material particles 16. In the case that the heat-conductive filler 15a has a larger particle size than the fluorescent material particles 16 as illustrated in FIG. 4(a), the fluorescent material particles 16 may be disposed on the surface of the heat-conductive filler 15a. On the other hand, in the case that the heat-conductive filler 15a has a smaller particle size than the fluorescent material particles 16 as illustrated in FIG. 4(b), the heat-conductive filler 15a is disposed on the surface of one of the fluorescent material particles 16.

A method for combining the fluorescent material particles 16 with the heat-conductive filler 15a may be a method for spraying adhesive particles (or a liquid containing adhesive particles) on particles to be adhered to, for example, through granulation by dry or wet coating or spray drying. The adhesive particles refer to smaller particles of the heat-conductive filler 15a and the fluorescent material particles 16. The particles to be adhered to refer to larger particles of the heat-conductive filler 15a and the fluorescent material particles 16.

The fluorescent material particles 16 and the heat-conductive filler 15a may be bonded together with an adhesive or by utilizing static electricity.

### Modified Example 1 of Light-Emitting Section 5

FIG. 5 is a cross-sectional view of a modified example of the light-emitting section 5. As illustrated in FIG. 5, a heat-conductive wall 28 may be in contact with a side surface of the light-emitting section 5. The heat-conductive wall 28 may be made of a metal (for example, aluminum) or a light-transmitting heat-conductive material, such as sapphire or an inorganic glass.

The formation of the heat-conductive wall 28 as a second heat-conductive member together with the heat-conductive member 13 can enhance the heat sink effect of the light-emitting section 5.

### Modified Example 2 of Light-Emitting Section 5

The particles in the light-emitting section 5 illustrated in FIG. 5 may be the diffusing particles 15 described above instead of the heat-conductive filler 15a described in the present embodiment or may be particles having the functions of a heat-conductive filler and diffusing particles. For example, particles formed of Al₂O₃ (sapphire) beads or diamond (beads) have the functions of a heat-conductive filler and diffusing particles.

(Effects of Headlamp 1a)

The present inventor found that excitation of the light-emitting section 5 with a high-power laser beam causes significant degradation of the light-emitting section 5. The degradation of the light-emitting section 5 results mainly from the degradation of the fluorescent material itself in the light-emitting section 5 and the degradation of the sealant surrounding the fluorescent material. For example, sialon fluorescent materials described above generate light at 60% to 80% efficiency in response to laser beam irradiation, and the remainder is dissipated as heat.

In the headlamp 1a, since the light-emitting section 5 contains the heat-conductive filler 15a, the light-emitting section 5 has lower thermal resistance than before. Thus, heat of the light-emitting section 5 is efficiently transferred to the heat-conductive member 13 and is effectively dissipated. This can prevent the degradation of the light-emitting section 5 and a decrease in luminous efficiency due to heat generation.

This can improve the life and reliability of a headlamp as an ultrahigh-intensity light source that utilizes a laser beam as an excitation light source.

### EXAMPLES

An example of the present invention will be described below with reference to FIG. 7. FIG. 7 illustrates a specific example of the light-emitting section 5 and the heat-conductive member 13.

The light-emitting section 5 was a wavelength conversion member that contained an oxynitride-based fluorescent material and a nitride-based fluorescent material (Caα-SiAlON:Ce and CASN:Eu) dispersed in a sealant. The light-emitting section 5 is discoidal and has a diameter of 3 mm and a thickness of 1.5 mm. The light-emitting section 5 contains dispersed sapphire beads as the heat-conductive filler 15a.

The lower limit of the preferred density range (mixing ratio range) of the heat-conductive filler 15a in the light-emitting section 5 satisfies the condition represented by the formula: (thermal conductivity of heat-conductive filler)×(mixing ratio)>(thermal conductivity of sealant). For example, when the heat-conductive filler 15a having a thermal conductivity of 25 W/mK constitutes 4% (% by volume) of the light-emitting section 5, 25×0.04=1 W/mK is obtained. This value is the same as the thermal conductivity of the glass material used as the sealant. Thus, an effect of improving the thermal conductivity (or thermal resistance) of the light-emitting section 5 is practically insignificant.

As described above, when sapphire beads constitute 8% of the light-emitting section 5, the heat sink effect is improved approximately 1.4 times.

The upper limit of the preferred density range (mixing ratio range) of the heat-conductive filler 15a in the light-emitting section 5 is a mixing ratio when the sealant is completely substituted by the heat-conductive filler 15a.

A sapphire sheet having a thickness of 0.5 mm (thermal conductivity: 42 W/mK) was used as the heat-conductive member 13. The light-emitting section 5 was bonded to the heat-conductive member 13 with a visible light polymerization type optical adhesive Epixacolle EP433 manufactured by Adell Corp. FIG. 7 shows this state.

For a light-emitting section containing a Caα-SiAlON:Ce fluorescent material and a CASN:Eu fluorescent material, the conversion efficiency from excitation light to illumination light (fluorescence) is approximately 70%. In irradiation with 10-W excitation light, at least 3 W is not converted into illumination light but into heat.

The thermal conductivity of the sealant for sealing the fluorescent material is in the range of approximately 0.1 to 0.2 W/mK for a silicone resin or an organic inorganic hybrid glass or approximately 1 to 2 W/mK for an inorganic glass. For example, a 3 mm×3 mm plane of a heating element 3 mm×3 mm×1 mm in thickness having a thermal conductivity of 0.2 W/mK generates heat of 1 W. A thermal simulation for the heating element thermally insulated from the outside shows that the temperature of the heating element is 500° C. or more (555.6° C.)

When the sealant has a thermal conductivity of 2 W/mK, the temperature rise of the heating element having the same size and the same heat generation is 55.6° C. Thus, the thermal conductivity of the sealant is very important. When the thermal conductivity of the sealant remains at 2 W/mK, the temperature rise of the heating element having a size of 3 mm×1 mm×1 mm in thickness is 166.7° C. Thus, a decrease in size of the light-emitting section 5 so as to increase luminance results in an increase in temperature even for the same amount of heat generation, thus imposing a higher load on the light-emitting section 5.

In contrast, the increase in temperature of the heating element (3 mm×3 mm×1 mm in thickness, thermal conductivity 0.2 W/mK) thermally bonded to a heat-conductive sheet (3 mm×10 mm×0.5 mm in thickness) having a thermal conductivity of 40 W/mK is reduced to approximately 170° C. An increase in thickness of the heat-conductive sheet from 0.5 mm to 1.0 mm results in a temperature rise of approximately 85° C., which is half of 170° C. A decrease in the thickness of the heating element from 1 mm to 0.5 mm improves heat dissipation to the heat-conductive sheet and can further reduce the temperature rise of the heating element.

When the temperature of the fluorescent material in the light-emitting section is approximately 200° C. or less, and the fluorescent material is an oxynitride-based fluorescent material, a nitride-based fluorescent material, or a group III-V compound semiconductor nanoparticle fluorescent material, even under irradiation with very strong excitation light that causes heat generation of more than 1 W particularly in the light-emitting section 5, heat can be rapidly and efficiently dissipated, thereby preventing the light-emitting section 5 from being damaged (deteriorating).

The sealant in the light-emitting section 5 is preferably an inorganic glass. When a silicone resin is used, it is preferable to strictly perform a thermal simulation to reduce the temperature rise to approximately 150° C. or less. For an organic inorganic hybrid glass, the acceptable temperature is up to the range of approximately 250° C. to 300° C. For an inorganic glass, the acceptable temperature may be 500° C. or more, provided that the acceptable temperature is lower than the melting point of the material.

### Third Embodiment

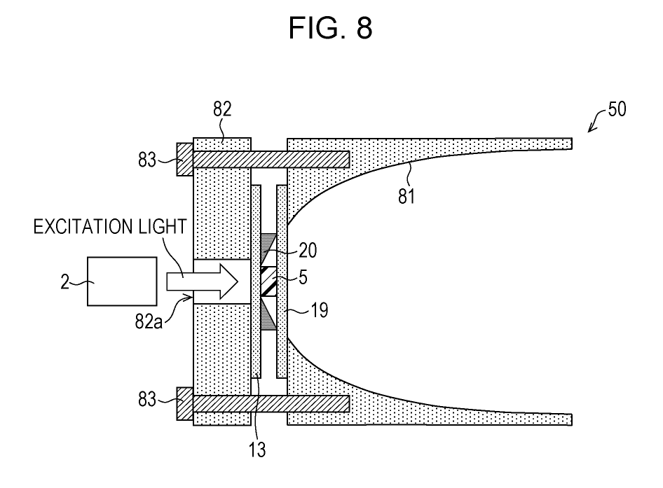

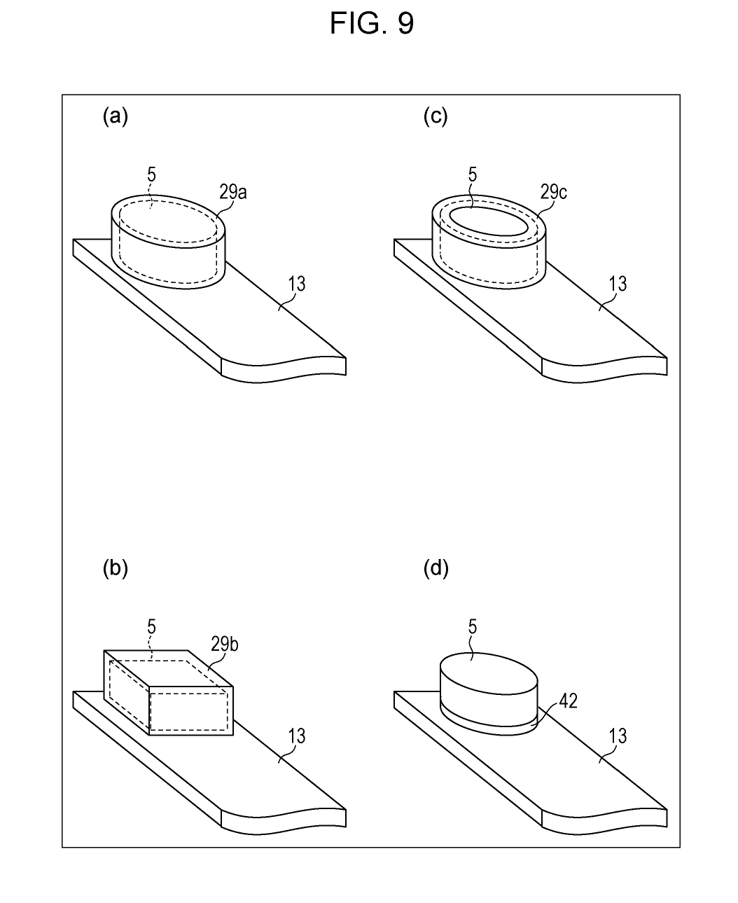

Another embodiment of the present invention will be described below with reference to FIGS. 8 and 9. Like members in the first and second embodiments and the present embodiment are designated by like reference numerals and will not be further described. In the present embodiment, another member that together with the heat-conductive member 13 holds the light-emitting section 5 will be described below.

### (Structure of Headlamp 50)

FIG. 8 is a schematic view of a headlamp (light-emitting device, illuminating device, headlight) 50 according to the present embodiment. As illustrated in the figure, the headlamp 50 includes a transparent sheet (holding portion) 19, a metallic ring 20, a reflector 81, a substrate 82, and screws 83. In the headlamp 50, the light-emitting section 5 is disposed between the heat-conductive member 13 and the transparent sheet 19.

### (Light-Emitting Section 5)

The light-emitting section 5 is bonded to the heat-conductive member 13 with an adhesive and is disposed in an opening at the bottom of the metallic ring 20. The light-emitting section 5 contains dispersed heat-conductive filler 15a (not shown in FIG. 8).

### (Reflector 81)

The reflector 81 has substantially the same function as the reflector 6 and is cut by a plane perpendicular to the optical axis in the vicinity of the focal position. The material of the reflector 81 is not particularly limited. In view of reflectivity, the reflector made of copper or stainless steel (SUS) is preferably subjected to silver plating and chromate conversion coating. Alternatively, the reflector 81 made of aluminum may be covered with an antioxidant film, or a resin reflector main body may be covered with a thin metal film.

### (Metallic Ring 20)

The metallic ring 20 is a conical ring that has a shape of the reflector 81 in the vicinity of the focal position on the assumption that the reflector 81 is a complete reflector, and has an opening at the bottom of the cone.

The surface of the conical portion of the metallic ring 20 functions as a reflector. A combination of the metallic ring 20 and the reflector 81 form a reflector having a complete shape. Thus, the metallic ring 20 is a partial reflector that functions as part of the reflector. If the reflector 81 is referred to as a first partial reflector, the metallic ring 20 is referred to as a second partial reflector having a portion in the vicinity of the focal position. Part of fluorescence emitted from the light-emitting section 5 is reflected by the surface of the metallic ring 20 and is emitted forward from the headlamp 50 as illumination light.

Although the material of the metallic ring 20 is not particularly limited, the material is preferably silver, copper, or aluminum in terms of heat dissipation. For the metallic ring 20 made of silver or aluminum, the conical portion is preferably mirror-finished and covered with a protective layer (such as a chromate conversion coating or a resin layer) for preventing darkening or oxidation. For the metallic ring 20 made of copper, the protective layer is preferably formed after silver plating or aluminum evaporation.

The metallic ring 20 in contact with the heat-conductive member 13 can dissipate heat of the heat-conductive member 13. Thus, the metallic ring 20 also functions as a cooling section for the heat-conductive member 13.

### (Transparent Sheet 19)

The transparent sheet 19 is disposed between the metallic ring 20 and the reflector 81. The transparent sheet 19 is in contact with a surface of the light-emitting section 5 opposite the laser beam irradiation surface 5a and presses the light-emitting section 5 so that the light-emitting section 5 does not separate from the heat-conductive member 13. The depth of the conical portion of the metallic ring 20 is substantially equal to the height of the light-emitting section 5. Thus, the transparent sheet 19 is in contact with the light-emitting section 5 while the distance between the transparent sheet 19 and the heat-conductive member 13 is held constant. Thus, the light-emitting section 5 is not flattened between the heat-conductive member 13 and the transparent sheet 19.

The transparent sheet 19 may be made of any light-transmitting material. As in the heat-conductive member 13, the material preferably has high thermal conductivity (20 W/mK or more). For example, the transparent sheet 19 preferably contains sapphire, gallium nitride, magnesia, or diamond. In this case, the transparent sheet 19 has high thermal conductivity and can efficiently absorb heat generated in the light-emitting section 5.

The heat-conductive member 13 and the transparent sheet 19 preferably have a thickness of approximately 0.3 mm or more and 5.0 mm or less. A thickness of 0.3 mm or less results in insufficient strength for fixing the light-emitting section 5 and the metallic ring 20. A thickness of 5.0 mm or more results in significant absorption of a laser beam and an increase in member costs.

### (Substrate 82)

The substrate 82 is a sheet member having an opening 82a through which a laser beam from the laser diodes 2 passes. The reflector 81 is fixed to the substrate 82 with the screws 83. The heat-conductive member 13, the metallic ring 20, and the transparent sheet 19 are disposed between the reflector 81 and the substrate 82. The center of the opening 82a is substantially coincident with the center of the opening at the bottom of the metallic ring 20. Thus, a laser beam from the laser diodes 2 passes through the opening 82a of the substrate 82, the heat-conductive member 13, and the opening of the metallic ring 20 to reach the light-emitting section 5.

The material of the substrate 82 is not particularly limited. Since the heat-conductive member 13 is entirely in contact with the substrate 82, the substrate 82 made of a metal, such as iron or copper, can enhance the heat sink effect of the heat-conductive member 13 and consequently the heat sink effect of the light-emitting section 5.

The metallic ring 20 is preferably securely fixed to the heat-conductive member 13. Because of a stress caused by fixing the substrate 82 and the reflector 81 with the screws 83, the metallic ring 20 can be fixed to the heat-conductive member 13 to some extent. Nevertheless, the risk of detachment of the light-emitting section 5 due to the movement of the metallic ring 20 can be avoided by securely fixing the metallic ring 20, for example, by bonding the metallic ring 20 to the heat-conductive member 13 with an adhesive or screwing the metallic ring 20 to the substrate 82 with the heat-conductive member 13 interposed therebetween.

The metallic ring 20 is not necessarily made of a metal, provided that the metallic ring 20 functions as a partial reflector as described above and can withstand the stress caused by fixing the reflector 81 and the substrate 82 with the screws 83. For example, an alternative member to the metallic ring 20 may be a resin ring that can withstand the stress and has a thin metal film on its surface.

### (Effects of Headlamp 50)

In the headlamp 50, the light-emitting section 5 is disposed between the heat-conductive member 13 and the transparent sheet 19. This fixes the relative positional relationship between the light-emitting section 5 and the heat-conductive member 13. This can prevent the light-emitting section 5 from detaching from the heat-conductive member 13 even in the case of low adhesion of an adhesive between the light-emitting section 5 and the heat-conductive member 13 or in the presence of a difference in thermal expansion coefficient between the light-emitting section 5 and the heat-conductive member 13.

### (Another Example of Holding Portion)

A holding portion for fixing the relative position of the light-emitting section 5 to the heat-conductive member 13 is not necessarily a sheet member and may be a member that has a press-contact surface to be pressed against at least part of a surface (referred to as a fluorescence-emitting surface) opposite the laser beam irradiation surface 5a of the light-emitting section 5 and a contact-surface-holding portion for fixing the relative positional relationship between the press-contact surface and the heat-conductive member 13.

The light-emitting section 5 can be fixed to the heat-conductive member 13 by fixing the relative position between the press-contact surface and the heat-conductive member 13 and pressing the press-contact surface against the fluorescence-emitting surface of the light-emitting section 5 (the press-contact surface being in contact with the fluorescence-emitting surface under slight pressure).

FIGS. 9(a) to 9(c) illustrate modified examples of the holding portion. In the case that the light-emitting section 5 is cylindrical as illustrated in FIG. 9(a), the holding portion may be a cylindrical hollow member 29a that has a surface in contact with the fluorescence-emitting surface of the light-emitting section 5 and is connected (bonded or welded) to the heat-conductive member 13. In the case that the light-emitting section 5 is rectangular cuboid or cubic as illustrated in FIG. 9(b), the holding portion may be a rectangular cuboid or cubic hollow member 29b. The hollow members 29a and 29b have an opening on the side of the heat-conductive member 13.

As illustrated in FIG. 9(c), part (particularly the central part) of a surface of a holding portion 29c in contact with the fluorescence-emitting surface may have an opening. This structure can reduce the loss of fluorescence emitted from the light-emitting section 5 due to the absorption of fluorescence by the holding portion. The holding portion is preferably a light-transmitting member or may be made of an opaque substance (for example, a metal), provided that the central portion has an opening.

The holding portion may be a plurality of wires. One end of each of the wires is connected to the light-emitting section 5, and the other end is connected to the heat-conductive member 13.

As illustrated in FIG. 9(d), the light-emitting section 5 may be connected to the heat-conductive member 13 with an adhesive layer 42 without using the holding portion 29c.

### Fourth Embodiment

### Headlamp 60

### (Technical Idea of Present Invention)

The fluorescence efficiency (external quantum efficiency) of a fluorescent material having an ordinary particle size (an average particle size in the range of approximately 1 μm to several tens of micrometers), which is not a nanoparticle fluorescent material, tends to be lower in a fluorescent material in a blue wavelength range that emits light on the short wavelength side than in a fluorescent material having a fluorescence peak wavelength in a green to red wavelength range. Thus, considering external quantum efficiency alone, in order to maintain a required amount of fluorescence, the amount of fluorescent material having a peak wavelength in a blue wavelength range is greater than the amount of fluorescent material having a peak wavelength in a green to red wavelength range.

In order to produce illumination light having an ordinary neutral white color up to a higher color temperature, the amount of fluorescent material having a peak wavelength in a green wavelength range generally tends to be greater than the amount of fluorescent material having a peak wavelength in a red wavelength range. In other words, in order to maintain a required amount of fluorescence, the amount of fluorescent material having a shorter peak wavelength tends to be greater than the amount of fluorescent material having a longer peak wavelength.

In order to achieve good color rendering properties of illumination light, the spectrum of light in a visible light region preferably has a smaller number of troughs. Thus, considering color rendering properties, it is preferable to use, as part of illumination light, fluorescence of a blue-light-emitting fluorescent material that emits a blue light having a wider emission spectrum than a blue light of a blue LED rather than using the blue light of the blue LED as part of illumination light, as in the case of the semiconductor light-emitting device as described in Patent Literature 7. Inclusion of a blue-light-emitting fluorescent material in a wavelength conversion member (a light-emitting member or a light-emitting section) is not disclosed in the semiconductor light-emitting device described in Patent Literature 7.

If the wavelength conversion member contains a blue-light-emitting fluorescent material, however, the amount of blue-light-emitting fluorescent material that emits light in a blue wavelength range must particularly be increased to improve the luminous efficiency of the wavelength conversion member, also because of low visibility of light emission in the blue wavelength range (on the short wavelength side). Thus, the fluorescent material having a peak wavelength in the blue wavelength range (on the short wavelength side) is particularly greater in amount than a fluorescent material having a peak wavelength on the long wavelength side of the blue wavelength range.

Consequently, a wavelength conversion member composed of a plurality of fluorescent materials including the blue-light-emitting fluorescent material has a problem that a particularly large amount of blue-light-emitting fluorescent material having a peak wavelength in the blue wavelength range (on the short wavelength side) prevents fluorescence emission from a fluorescent material having a peak wavelength on the long wavelength side to the outside of the wavelength conversion member.

For example, in the semiconductor light-emitting device described in Patent Literature 7, if a blue-light-emitting fluorescent material is added as a fluorescent material contained in the wavelength conversion member, a particularly great amount of blue-light-emitting fluorescent material having a peak wavelength on the short wavelength side prevents fluorescence emission from a green- or red-light-emitting fluorescent material having a peak wavelength on the long wavelength side to the outside of the light-emitting member.

The wavelength conversion member composed of a plurality of fluorescent materials including the blue-light-emitting fluorescent material also has a problem that a particularly large amount of blue-light-emitting fluorescent material having a peak wavelength in the blue wavelength range (on the short wavelength side) prevents a fluorescent material having a peak wavelength on the long wavelength side from being irradiated with excitation light.

For example, in the semiconductor light-emitting device described in Patent Literature 7, if a blue-light-emitting fluorescent material is added as a fluorescent material contained in the wavelength conversion member, a particularly great amount of blue-light-emitting fluorescent material having a peak wavelength on the short wavelength side prevents a green- or red-light-emitting fluorescent material having a peak wavelength on the long wavelength side from being irradiated with excitation light.

The circumstances under which lamp color illumination light having a low color temperature is obtained with a wavelength conversion member composed of a plurality of fluorescent materials including a blue-light-emitting fluorescent material are different from the circumstances described above under which only the luminous efficiency is taken into consideration. For example, for a wavelength conversion member composed of blue-, green-, and red-light-emitting fluorescent materials, the blue-light-emitting fluorescent material content is particularly greater than the green- and red-light-emitting fluorescent materials content as in the case that only the luminous efficiency is taken into consideration. In order to obtain lamp color illumination light having a low color temperature, however, the circumstances are different in that the red-light-emitting fluorescent material content may sometimes be greater than the green-light-emitting fluorescent material content. In this case, a greater amount of red-light-emitting fluorescent material having a longer wavelength may prevent fluorescence from a smaller amount of green-light-emitting fluorescent material having a shorter wavelength or prevent excitation light irradiation of the green-light-emitting fluorescent material. In this case, however, a particularly large amount of blue-light-emitting fluorescent material having a shorter wavelength still prevents fluorescence from a small amount of green- or red-light-emitting fluorescent material having a longer wavelength or prevents excitation light irradiation of the green- or red-light-emitting fluorescent material.

Even in such a case, a small amount of green-light-emitting fluorescent material having a shorter wavelength may prevent fluorescence from a large amount of red-light-emitting fluorescent material having a longer wavelength or prevent excitation light irradiation of the red-light-emitting fluorescent material.

The semiconductor light-emitting device described in Patent Literature 7 contains the red-light-emitting fluorescent material having the longest peak wavelength as the semiconductor particulate fluorescent material. Furthermore, in order to improve the color rendering properties and luminous efficiency of the light-emitting member, a smallest difference between a wavelength at which the red-light-emitting fluorescent material has the lowest absorption spectrum and a peak wavelength of the emission spectrum of the green-light-emitting fluorescent material is set at 25 nm or less. These make it difficult to manufacture the semiconductor light-emitting device.

In view of such situations, the present inventor has worked on the development of the following wavelength conversion member. The wavelength conversion member is a light-emitting member that includes a first fluorescent material for emitting fluorescence having a peak wavelength in a first color wavelength range and a second fluorescent material for emitting fluorescence having a peak wavelength in a second color wavelength range, the second color wavelength range being on the long wavelength side of the first color wavelength range. At least the first fluorescent material is a nanoparticle fluorescent material.

The present inventor thought that such a structure could improve the luminous efficiency of the wavelength conversion member and facilitate the manufacture of the wavelength conversion member.

A wavelength conversion member according to the present invention is based on such a technical idea. A headlamp (light-emitting device, illuminating device, headlight) 60 that satisfies the light distribution characteristic standard of an automotive main-beam headlight (high beam) will be described below as an example of a light-emitting device that includes the wavelength conversion member. An illuminating device according to the present invention may be a headlamp for vehicles and moving objects other than automobiles (for example, humans, ships, aircrafts, submarines, and rockets) or another illuminating device. Examples of other illuminating devices include searchlights, projectors, and household lighting fixtures (interior lighting fixtures and exterior lighting fixtures).

### (Structure of Headlamp 60)

The structure of the headlamp 60 according to the present embodiment will be described below with reference to FIG. 6 and FIGS. 10 to 13. FIG. 10 is a schematic view of the structure of the headlamp 60. As illustrated in the figure, the headlamp 60 includes a laser diode 2 (excitation light source), an aspheric lens 3, a light guide member 4, a light-emitting section 5, a reflector 6, and a transparent sheet 7 (transmission filter).

### (Laser Diode 2)

The laser diode 2 functions as an excitation light source for emitting excitation light. The laser diode 2 may be a single laser diode or a plurality of laser diodes. The laser diode 2 may have one luminous point per chip (one stripe per chip) or a plurality of luminous points (a plurality of stripes per chip). The present embodiment describes the laser diode 2 having one stripe per chip.

For example, the laser diode 2 in the present embodiment emits a laser beam of 405 nm (blue-violet), has a light output of 1.0 W, an operating voltage of 5 V, and an electric current of 0.7 A, and is sealed in a package (stem) having a diameter of 5.6 mm. In the present embodiment, ten laser diodes 2 are used, and the light output is 10 W in total. For convenience, FIG. 10 illustrates only one laser diode 2.

The wavelength of a laser beam emitted from the laser diode 2 is not limited to 405 nm. The peak wavelength (the wavelength of an emission peak) may be within a region from a near-ultraviolet region to a blue region (350 nm or more and 460 nm or less), more preferably from a near-ultraviolet region to a blue-violet region (350 nm or more and 420 nm or less).

When the light-emitting section 5 contains an oxynitride-based or nitride-based fluorescent material described below as a fluorescent material, preferably, the laser diode 2 has a light output of 1 W or more and 20 W or less, and the optical density of a laser beam with which the light-emitting section 5 is irradiated is 0.1 W/mm² or more and 50 W/mm² or less. The light output within this range can realize light flux and luminance required for vehicle headlamps and prevent the light-emitting section 5 from deteriorating because of a high-power laser beam. Thus, a high-light-flux, high-intensity, and long-life light source can be realized.

When the light-emitting section 5 contains a blue-light-emitting nanoparticle fluorescent material described below as a fluorescent material, the optical density of a laser beam with which the light-emitting section 5 is irradiated may be more than 50 W/mm².

### (Aspheric Lens 3)

The aspheric lens 3 allows a laser beam emitted from the laser diode 2 to enter a light incident surface 4a at one end of the light guide member 4. For example, the aspheric lens 3 may be FLKN 1405 manufactured by Alps Electric Co., Ltd. The shape and material of the aspheric lens 3 are not particularly limited, provided that the aspheric lens 3 has the function described above. Preferably, the material is transparent to light at 405 nm and its vicinity and has high heat resistance.

The aspheric lens 3 converges a laser beam emitted from laser diode 2 and guides the laser beam to a relatively small (for example, a diameter of 1 mm or less) light incident surface. Thus, when the light incident surface 4a of the light guide member 4 is large enough to obviate the need for converging the laser beam, the aspheric lens 3 may be omitted.

### (Light Guide Member 4)

The light guide member 4 is a truncated-cone-shaped light guide member that converges a laser beam emitted from the laser diode 2 and guides the laser beam to the light-emitting section 5 (the laser beam irradiation surface 5a of the light-emitting section 5). The light guide member 4 is optically connected to the laser diode 2 through the aspheric lens 3 (or directly). The light guide member 4 has a light incident surface 4a (inlet end) for receiving a laser beam emitted from the laser diode 2 and a light-emitting surface 4b (outlet end) for emitting the laser beam that has been received by the light incident surface 4a to the light-emitting section 5.

The area of light-emitting surface 4b is smaller than the area of the light incident surface 4a. Thus, a laser beam incident on the light incident surface 4a is converged while reflected forward by the side surface of the light guide member 4 and is emitted through the light-emitting surface 4b.

The light guide member 4 is made of BK7 (borosilicate crown glass), quartz glass, an acrylic resin, or another transparent material. The light incident surface 4a and the light-emitting surface 4b may be a planar or curved surface.

The light guide member 4 may be a truncated pyramid or an optical fiber, provided that a laser beam emitted from the laser diode 2 is guided to the light-emitting section 5. A laser beam emitted from the laser diode 2 may be transmitted to the light-emitting section 5 through the aspheric lens 3 or directly without the light guide member 4. Such a structure is possible when the distance between the laser diode 2 and the light-emitting section 5 is short.

### (Composition of Light-Emitting Section 5)

The composition of the light-emitting section 5 according to the present embodiment will be summarized below.

The composition of the light-emitting section 5 according to the present embodiment includes a first fluorescent material for emitting fluorescence having a peak wavelength in a first color wavelength range, and a second fluorescent material for emitting fluorescence having a peak wavelength in a second color wavelength range, the second color wavelength range being on the long wavelength side of the first color wavelength range. At least the first fluorescent material is a nanoparticle fluorescent material.

The composition may further include a third fluorescent material for emitting fluorescence having a peak wavelength in a third color wavelength range on the long wavelength side of the second color wavelength range.

In this constitution, at least the first fluorescent material in the light-emitting section 5 is a nanoparticle fluorescent material [the average particle size (hereinafter referred to simply as “particle size”) is approximately two orders of magnitude smaller than the light wavelength in the visible light wavelength range]. Thus, the first fluorescent material transmits (or is transparent to) light in the visible light wavelength range and the vicinity thereof. This increases the fluorescence efficiency (external quantum efficiency) of the second fluorescent material (or the third fluorescent material) to the outside of the light-emitting section 5 as compared with the case that the first fluorescent material is not a nanoparticle fluorescent material.

This also increases the excitation light irradiation efficiency of the second fluorescent material (or the third fluorescent material) as compared with the case that the first fluorescent material in the light-emitting section 5 is not a nanoparticle fluorescent material.

In accordance with the technique described in Patent Literature 7, a smallest difference between a wavelength at which the red-light-emitting fluorescent material has the lowest absorption spectrum and a peak wavelength of the emission spectrum of the green-light-emitting fluorescent material is set at 25 nm or less. These make it difficult to manufacture the semiconductor light-emitting device. In contrast, the composition of the light-emitting section 5 only requires the nanoparticle fluorescent material as the first fluorescent material, and therefore the light-emitting section 5 is easy to manufacture.

Thus, the light-emitting section 5 has improved luminous efficiency and is easy to manufacture.

A sealant for sealing each of the fluorescent materials is preferably a low-melting-point inorganic glass. Unless excitation light having an extremely high power and optical density is used, a resin, such as a silicone resin, or an organic hybrid glass may be used. Although the light-emitting section 5 may be a compact of the fluorescent materials alone, the fluorescent materials are preferably dispersed in the sealant. This is because use of the compact of the fluorescent materials alone may result in accelerated degradation of the light-emitting section 5 due to laser beam irradiation.

For the sake of simplicity, a fluorescent material for emitting fluorescence having a peak wavelength in a blue wavelength range is referred to as a blue-light-emitting fluorescent material. A fluorescent material for emitting fluorescence having a peak wavelength in a yellow wavelength range is referred to as a yellow-light-emitting fluorescent material. A fluorescent material for emitting fluorescence having a peak wavelength in a green wavelength range is referred to as a green-light-emitting fluorescent material. A fluorescent material for emitting fluorescence having a peak wavelength in a red wavelength range is referred to as a red-light-emitting fluorescent material.

“Blue light” is fluorescence having a peak wavelength in a wavelength range of 440 nm or more and 490 nm or less, for example. “Yellow light” is fluorescence having a peak wavelength in a wavelength range of 560 nm or more and 590 nm or less, for example. “Green light” is fluorescence having a peak wavelength in a wavelength range of 510 nm or more and 560 nm or less, for example. “Red light” is fluorescence having a peak wavelength in a wavelength range of 600 nm or more and 680 nm or less, for example.

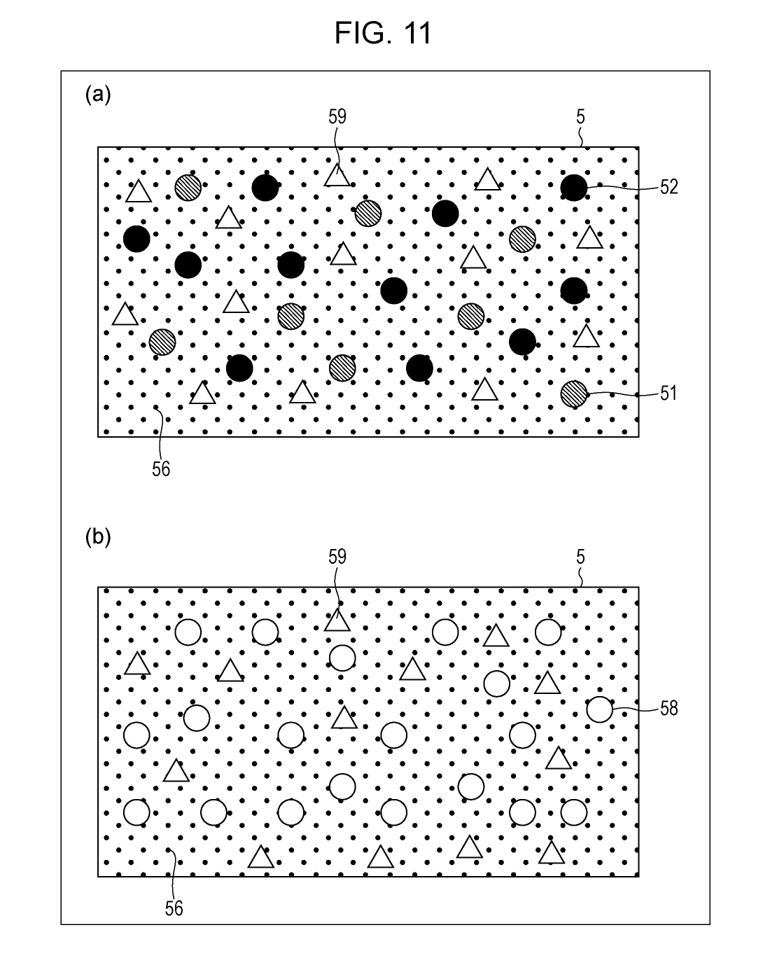

A specific example of the composition of the light-emitting section 5 will be described below with reference to FIGS. 11 to 13. FIG. 11(a) is a schematic view of an example of the composition of the light-emitting section 5 according to the present embodiment. FIG. 11(b) is a schematic view of another example of the composition of the light-emitting section 5 according to the present embodiment. These figures do not reflect the actual shape and size of the components of the light-emitting section 5 but are schematic views of the composition of the light-emitting section 5.

In general, white (or pseudo-white) light used as illumination light can be made up by the color mixing of three colors that satisfy the isochromatic principle or the color mixing of two colors that satisfy the relationship of complementary colors. On the basis of the isochromatic principle or the relationship of complementary colors, for example, white (or pseudo-white) light can be made up by the color mixing of fluorescent colors of a plurality of fluorescent materials contained in the light-emitting section 5.

For example, in the example illustrated in FIG. 11(a), the light-emitting section 5 contains a green-light-emitting fluorescent material (a second fluorescent material) 51, a red-light-emitting fluorescent material (a third fluorescent material) 52, a blue-light-emitting fluorescent material (a first fluorescent material, a nanoparticle fluorescent material) 56, and transparent fine particles 59 dispersed in the sealant. The sealant is present in spaces between the fluorescent materials and the transparent fine particles 59.

The light-emitting section 5 contains a blue-light-emitting fluorescent material 56, a green-light-emitting fluorescent material 51, and a red-light-emitting fluorescent material 52 in combination and can consequently produce white light.

More specifically, the light-emitting section 5 irradiated with excitation light from the near-ultraviolet region to the blue-violet region can emit white light having good color rendering properties with high luminous efficiency as illumination light. The color rendering properties are better than the following example illustrated in FIG. 11(b), and a decrease in luminous efficiency of the light-emitting section 5 can be reduced.

When the blue wavelength range is considered as the first color wavelength range, the green wavelength range or the red wavelength range is considered as the second color wavelength range. In other words, when the blue-light-emitting fluorescent material 56 is considered as the first fluorescent material, the green-light-emitting fluorescent material 51 or the red-light-emitting fluorescent material 52 may be considered as the second fluorescent material.

When the green wavelength range is considered as the first color wavelength range, the red wavelength range may be considered as the second color wavelength range. In other words, when the green-light-emitting fluorescent material 51 is considered as the first fluorescent material, the red-light-emitting fluorescent material 52 may be considered as the second fluorescent material. In this case, the green-light-emitting fluorescent material 51 is a nanoparticle fluorescent material.

When the blue wavelength range is considered as the first color wavelength range, and the green wavelength range is considered as the second color wavelength range, the red wavelength range may be considered as the third color wavelength range. In this case, the red-light-emitting fluorescent material 52 is considered as the third fluorescent material.

The second fluorescent material and the third fluorescent material may be a fluorescent material for emitting fluorescence having a peak wavelength in a green wavelength range and a fluorescent material for emitting fluorescence having a peak wavelength in a red wavelength range, respectively. Thus, the second fluorescent material and/or the third fluorescent material may be a nanoparticle fluorescent material.

In other words, in the composition of the light-emitting section 5, at least one fluorescent material for emitting fluorescence having a lower peak wavelength than the other fluorescent materials is a nanoparticle fluorescent material.

In the example illustrated in FIG. 11(b), the light-emitting section 5 contains the blue-light-emitting fluorescent material 56, a yellow-light-emitting fluorescent material (a second fluorescent material) 58, and the transparent fine particles 59 dispersed in a sealant. The sealant is as described above.

The light-emitting section 5 contains the blue-light-emitting fluorescent material 56 and the yellow-light-emitting fluorescent material 58 in combination and can consequently produce (pseudo-)white light.

More specifically, the light-emitting section 5 irradiated with near-ultraviolet to blue-violet excitation light (having an oscillation wavelength of 350 nm or more and less than 420 nm) can emit (pseudo-)white light with high luminous efficiency as illumination light.

Specific examples of the green-light-emitting fluorescent material 51, the red-light-emitting fluorescent material 52, and the yellow-light-emitting fluorescent material 58 will be described below.

### (Green-Light-Emitting Fluorescent Material)

Specific examples of the green-light-emitting fluorescent material 51 include various nitride-based or oxynitride-based fluorescent materials. In particular, oxynitride-based fluorescent materials, which have excellent heat resistance and high luminous efficiency and are stable, can provide the light-emitting section 5 that has excellent heat resistance and high luminous efficiency and is stable.

Examples of oxynitride-based fluorescent materials that emit green light include a Eu²⁺-doped β-SiAlON:Eu fluorescent material and a Ce³⁺-doped Caα-SiAlON:Ce fluorescent material. A β—SiAlON:Eu fluorescent material emits strong light having a peak wavelength of approximately 540 nm in response to near-ultraviolet to blue excitation light. The emission spectrum half-width of this fluorescent material is approximately 55 nm. The Caα-SiAlON:Ce fluorescent material emits strong light having a peak wavelength of approximately 510 nm in response to near-ultraviolet to blue excitation light.

The α-SiAlON and β—SiAlON (sialon) are sialon fluorescent materials (oxynitride-based fluorescent materials). Like silicon nitride, there are α-type and β-type depending on their crystal structures. In particular, α-sialon includes two empty spaces in a unit structure having a general formula S₁₂₋₍ₘ₊ₙ₎Al₍ₘ₊ₙ₎OₙN₁₆₋ₙ (m+n<12, 0<m, n<11; m and n are integers) composed of 28 atoms. Various metals can be dissolved in the empty spaces. Solid solution of a rare-earth element gives a fluorescent material. Solid solution of calcium (Ca) and europium (Eu) gives a fluorescent material having good characteristics that emits yellow to orange light having a longer wavelength than a YAG:Ce fluorescent material described below.

Sialon fluorescent materials can be excited by near-ultraviolet to blue (350 nm or more and 460 nm or less) light and are suitable for white LED fluorescent materials.

### (Red-Light-Emitting Fluorescent Material)

Specific examples of the red-light-emitting fluorescent material 52 include various nitride-based fluorescent materials.

For example, the nitride-based fluorescent materials include a Eu²⁺-doped CaAlSiN₃ fluorescent material (a CASN:Eu fluorescent material) and a Eu²⁺-doped SrCaAlSiN₃ fluorescent material (a SCASN:Eu fluorescent material). These nitride-based fluorescent materials in combination with the oxynitride fluorescent materials can further improve color rendering properties.

The CASN:Eu fluorescent material emits red fluorescence when the excitation wavelength is in the range of 350 to 450 nm and has a peak wavelength of 650 nm and a luminous efficiency of 73%. The SCASN:Eu fluorescent material emits red fluorescence when the excitation wavelength is in the range of 350 to 450 nm and has a peak wavelength of 630 nm and a luminous efficiency of 70%.

These red-light-emitting fluorescent materials can be used to produce white light having good color rendering properties. For the red-light-emitting fluorescent material, the noticeability of an objective irradiated with white light is improved when the objective is red. Since the background colors of traffic signs are red, yellow, and blue, use of the red-light-emitting fluorescent material in the light-emitting section 5 of the headlamp 1 is effective in visually recognizing traffic signs having a red background color.

Examples of nitride-based fluorescent materials that emit red light include Eu-activated nitride fluorescent materials, such as (Mg, Ca, Sr, Ba)AlSiN₃:Eu, and Ce-activated nitride fluorescent materials, such as (Mg, Ca, Sr, Ba)AlSiN₃:Ce.

### (Yellow-Light-Emitting Fluorescent Material)

Specific examples of the yellow-light-emitting fluorescent material 58 include a YAG:Ce fluorescent material, which is a cerium (Ce)-activated yttrium (Y)-aluminum (Al)-garnet fluorescent material, and a Eu²⁺-doped Caα-SiAlON:Eu fluorescent material.

The YAG:Ce fluorescent material has a broad emission spectrum having an emission peak in the vicinity of 550 nm (a slightly longer wavelength than 550 nm). The Caα-SiAlON:Eu fluorescent material emits strong light having a peak wavelength of approximately 580 nm in response to near-ultraviolet to blue excitation light.

### (Nanoparticle Fluorescent Material)

Nanoparticle fluorescent materials will be described below. Typical semiconductor substances that constitute nanoparticle fluorescent materials include group II-VI compounds, such as ZnSe, ZnTe, CdSe, and CdTe, group 4B elements, such as Si and Ge, and group III-V compounds, such as GaAs and InP. Semiconductor nanoparticles are made of semiconductor materials and have an average particle size of approximately 100 nm or less. The number of atoms in one nanoparticle is in the range of 10² to 10⁴. Because of the quantum size effect, semiconductor nanoparticles absorb and emit light having a wavelength different from those of bulk (a lump of a visible size) semiconductors. For example, because of indirect transition, nanoparticles of Si, which generally does not emit light, can emit light.

The quantum size effect is a phenomenon in which the electronic state in a material changes with decreasing particle size, so that light having a shorter wavelength is absorbed or emitted. In particular, the quantum size effect is often obviously observed in particles having an average particle size of 10 nm or less.

More specifically, one of the characteristics of nanoparticle fluorescent materials is that the particle size of a single compound semiconductor (for example, indium phosphide: InP) can be altered on the order of nanometers to change luminescent color because of the quantum size effect. For example, InP having a particle size in the range of approximately 3 to 4 nm emits red light [the particle size is measured with a transmission electron microscope (TEM)].

Nanoparticle fluorescent materials based on semiconductors have a short fluorescence lifetime and can rapidly convert the excitation light power into fluorescence. Thus, the nanoparticle fluorescent materials are resistant to high-power excitation light. This is because the emission lifetime of nanoparticle fluorescent materials is approximately 10 nanoseconds (ns), which is five orders of magnitude shorter than the emission lifetime of general rare-earth-activated fluorescent materials containing a rare earth as a luminescent center.

Because of its short emission lifetime as described above, nanoparticle fluorescent materials can rapidly and repeatedly absorb excitation light and emit light. Consequently, nanoparticle fluorescent materials can maintain high efficiency also for a strong laser beam and reduce heat generation.

Thus, a nanoparticle fluorescent material in the light-emitting section 5 can prevent thermal degradation (discoloration or deformation) of the light-emitting section 5. Thus, when a light-emitting element having high light output is used as a light source, a decrease in life of the headlamp 60 according to the present embodiment or a headlamp 70 or a headlamp 60a described below can be reduced.

It is supposed that the degradation of the light-emitting section 5 principally results from degradation of the sealant (for example, a silicone resin) for the fluorescent materials in the light-emitting section 5. More specifically, sialon fluorescent materials described above generate fluorescence at 60% to 80% efficiency in response to laser beam irradiation, and the remainder is dissipated as heat. This heat probably degrades the sealant.

Thus, the sealant preferably has high heat resistance. An example of the heat-resistant sealant is glass.

Preferred constituent materials of nanoparticle fluorescent materials will be described below. Nanoparticle fluorescent materials preferably contain at least one type of semiconductor nanoparticles made of any of Si, CdSe, InP, InN, InGaN, and InN—GaN mixed crystals.

Si semiconductor nanoparticles (hereinafter referred to as Si nanoparticles) having a particle size of approximately 1.9 nm emit blue-violet to blue (a peak wavelength in the vicinity of 420 nm) fluorescence. Si nanoparticles having a particle size of approximately 2.5 nm emit green (a peak wavelength in the vicinity of 500 nm) fluorescence. Si nanoparticles having a particle size of approximately 3.3 nm emit red (a peak wavelength in the vicinity of 720 nm) fluorescence.

CdSe nanoparticles presently have the highest luminous efficiency and an internal quantum efficiency of 50% or more.

InP nanoparticles have an internal quantum efficiency of approximately 20%. Blue light due to InP nanoparticles is produced at a very small particle size of 2 nm or less.

InN nanoparticles contains N instead of reactive P and are therefore expected to have high reliability. InN nanoparticles having a particle size of 2.5 nm or more and 3.0 nm or less emit blue light.

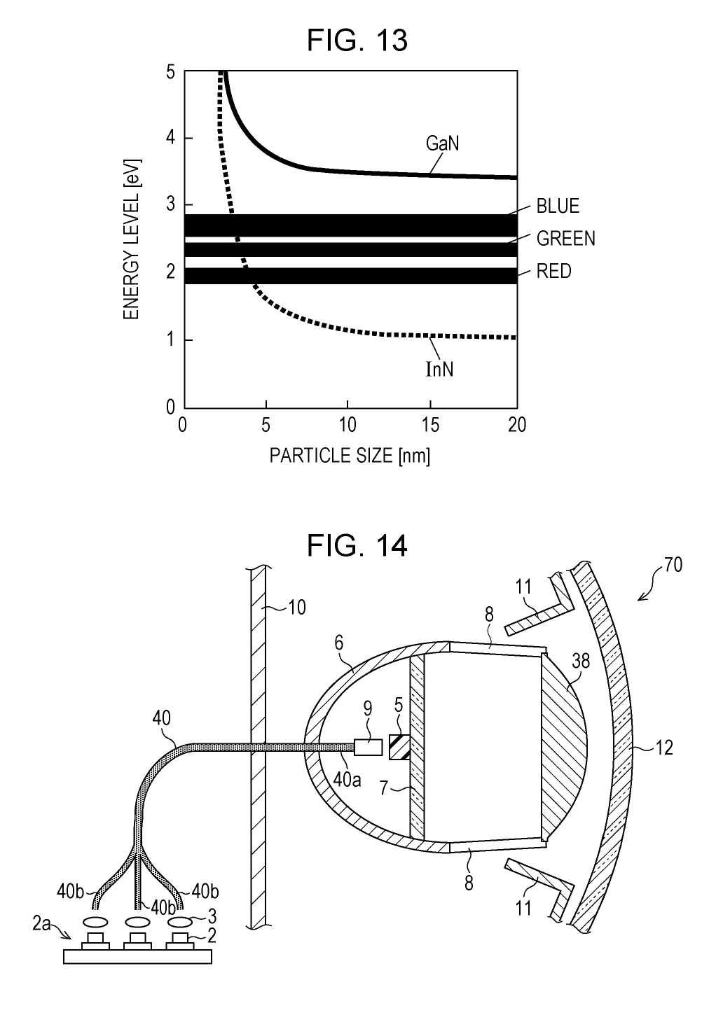

FIG. 13 shows the relationship between the particle size (nm) of InN nanoparticles and fluorescence energy level (eV) or luminescent color.

The mixed crystal ratio of Ga to N of InGaN nanoparticles can be changed to emit blue light at a particle size of approximately 3.0 nm. Thus, it is easiest to manufacture a nanoparticle fluorescent material from InGaN nanoparticles.

A mixed crystal of InN and GaN may also be used. Also in this case, blue light emission is possible at a particle size of several nanometers.

However, the constituent materials of nanoparticle fluorescent materials are not limited to these semiconductor materials. Another example may be ZnSe, which is a group II-VI semiconductor. ZnSe nanoparticles emit strong blue-violet to blue fluorescence when their surface conditions are appropriately controlled.

### (Nanoparticle Fluorescent Materials Other Than Si Nanoparticles)

Nanoparticle fluorescent materials other than Si nanoparticles, GaN, InN, and a mixed crystal thereof. InGaN, will be described in detail below. These nanoparticle fluorescent materials generally have an average particle size of 100 nm or less. Pure GaN has a density of 6.10 g/cm³, and InN has a density of 6.87 g/cm³. Depending on the mixed crystal ratio and the impurity content, InGaN may have a density in the range of 6.0 to 7.0 g/cm³, preferably 6.10 to 6.87 g/cm³.

Nanoparticle fluorescent materials preferably have an average particle size of 50 nm or less, more preferably 10 nm or less, still more preferably 5 nm or less. The reason for this will be described below with reference to FIG. 13.

FIG. 13 is a graph showing the relationship between the average particle size of a nanoparticle fluorescent material (GaN and InN) and the fluorescence wavelength. In FIG. 13, the horizontal axis represents the particle size of the nanoparticle fluorescent material, and the vertical axis represents the energy level of the nanoparticle fluorescent material. The solid line indicates the relationship between the particle size and the energy level for GaN. The broken line indicates the relationship between the particle size and the energy level for InN. The regions indicated by “blue”, “green”, and “red” correspond to the approximate energy levels of blue, green, and red light, respectively. The particle sizes at points of intersection between the blue, green, and red regions and the curved lines correspond to the particle sizes at which the respective color lights are emitted. For example, InN emits red fluorescence at a particle size of slightly less than 5 nm.

As illustrated in FIG. 13, InN having a particle size of 2 nm or more and 5 nm or less efficiently emits visible light. Although GaN cannot emit visible light, a mixed crystal of GaN and InN forms nanoparticle fluorescent materials having various average particle sizes, and the particle size of the nanoparticle fluorescent materials can be controlled to produce nanoparticle fluorescent materials that can emit light at a desired wavelength.

Different nanoparticle fluorescent materials have different particle size ranges for visible light emission. On average, the visible light emission efficiency is high at an average particle size of 50 nm or less. The visible light emission efficiency increases as the average particle size decreases to 10 nm or less and to 5 nm or less.

Thus, nanoparticle fluorescent materials preferably have an average particle size of 50 nm or less, more preferably 10 nm or less, still more preferably 5 nm or less. The lower limit is greater than 0.

When a fluorescent material having a particle size on the order of nanometers, such as a nanoparticle fluorescent material, is mixed with a glass powder having a particle size 100 to 10000 times greater than the particle size of the fluorescent materials, they can be uniformly dispersed although the glass density range is wider than that in mixing with an oxynitride-based fluorescent material or a nitride-based fluorescent material. Thus, when a nanoparticle fluorescent material is used as a fluorescent material in the light-emitting section 5, in other words, when the fluorescent material has an average particle size of 50 nm or less, the glass material has a density of 2.0 g/cm³ or more and 12.0 g/cm³ or less, preferably 6.0 g/cm³ or more and 11 g/cm³ or less.

This density range is a preferred density range of the sealant while the density range of the nanoparticle fluorescent material is fixed. When a nanoparticle fluorescent material is used as a fluorescent material in the light-emitting section 5, the sealant having a density in the range described above can be uniformly mixed with the fluorescent material.

A nanoparticle fluorescent material GaN has a density of 6.1 g/cm³, which is in the density range of the fluorescent material.

### (Method for Producing Si Nanoparticles)

A method for producing a nanoparticle fluorescent material will be described below with respect to Si nanoparticles by way of example. A method for producing a nanoparticle fluorescent material is not limited to the following method.

For example, Si nanoparticles may be produced by chemical etching as described below in (1) to (4).

(1) A silicon wafer or the like is pulverized to form a Si powder having a particle size of approximately 50 nm.

(2) The powdered Si is put into a solvent (for example, pure water+methanol), to which a liquid mixture of hydrofluoric acid (HF) and nitric acid (HNO₃) is then added.

(3) The solution prepared in (2) is subjected to ultrasonic vibration to etch the powdered Si. The etching time depends on the particle size.

(4) The solution after etching in (3) is passed through a filter (such as a PVDF membrane filter) to produce Si nanoparticles having a desired size.

Another nanoparticle fluorescent material can be produced in the same manner.

### (Transparent Fine Particles)

The transparent fine particles 59 in the light-emitting section 5 illustrated in FIGS. 11(a) and 11(b) will be described below. The transparent fine particles 59 have a higher refractive index than the sealant for sealing a fluorescent material and a particle size of 1 μm or more and 50 μm or less.

The transparent fine particles 59 dispersed in the light-emitting section 5 can prevent a laser beam used as excitation light for exciting the light-emitting section 5 from passing directly through the light-emitting section 5 to be emitted outward and increase the luminous area (luminous point size) of the light-emitting section 5. This can improve the safety of illumination light emitted from the light-emitting section 5.

(Reason that Blue-Light-Emitting Fluorescent Material is Preferred as Nanoparticle Fluorescent Material)

The following is the reason that a blue-light-emitting fluorescent material is preferred as a nanoparticle fluorescent material among a plurality of fluorescent materials in the light-emitting section 5. No high-efficiency blue-light-emitting fluorescent material is available at present. Thus, an illuminating device that includes a semiconductor light-emitting element, such as LED or LD, that emits excitation light having a wavelength in the range of approximately 350 to 420 nanometers (nm) (from a near-ultraviolet region to a blue-violet region) as excitation light source has a secondary problem of low luminous efficiency.

A method for solving such a problem may be a method for increasing the blue-light-emitting fluorescent material content relative to the other fluorescent material contents.

However, blue-light-emitting fluorescent materials (for example, rare-earth-activated fluorescent materials) are opaque and have low luminous efficiency. Thus, in this method, an opaque blue-light-emitting fluorescent material interferes with excitation light irradiation of a yellow-light-emitting fluorescent material, resulting in a decrease in excitation efficiency of the high-efficiency yellow-light-emitting fluorescent material.

An opaque blue-light-emitting fluorescent material also interferes with outward emission of fluorescence emitted from a yellow-light-emitting fluorescent material, resulting in low light extraction efficiency from the yellow-light-emitting fluorescent material.

An opaque blue-light-emitting fluorescent material also adversely affects excitation of or fluorescence extraction from a relatively high efficiency green-light-emitting fluorescent material or red-light-emitting fluorescent material in the light-emitting member, resulting in low luminous efficiency of the device.

No technical literature, including Patent Literatures 7 to 10, has described these problems.

There is another problem that LED or LD for emitting blue light used as an excitation light source has a blue light spectrum that is narrower (has a narrower half-width) than the emission spectrum of a fluorescent material. This is particularly noticeable with LD. Use of such blue light in illumination also causes a secondary problem of poor color rendering properties in the vicinity of blue light.

The blue-light-emitting fluorescent material content required for a white luminescent color will be specifically described below.

For example, when two types of fluorescent material, a Caα-SiAlON:Ce fluorescent material and a CASN:Eu fluorescent material, are used, the weight ratio of the CASN:Eu fluorescent material to the Caα-SiAlON:Ce fluorescent material is typically in the range of approximately 1:3 to 1:4. When a blue-light-emitting fluorescent material is added to the two types of fluorescent material to make luminescent color white (for example, 5000 K), the blue-light-emitting fluorescent material is approximately in the range of 16 to 20 in terms of weight ratio. Such situations are unchanged even using a presently available fluorescent material having the best characteristics although they depend on the peak wavelength and luminous efficiency of the fluorescent material.

More specifically, the weight ratio of the fluorescent material contents is red:green:blue=1:(3 to 4):(16 to 20). This requires an overwhelmingly larger amount of blue-light-emitting fluorescent material than the red-light-emitting fluorescent material or the green-light-emitting fluorescent material.

Even when a blue-light-emitting fluorescent material is used as a fluorescent material in the light-emitting section 5, the mixing ratio of the total amount of fluorescent material to the sealant is also approximately 1:10 in terms of weight ratio. Thus, the amounts of red-light-emitting fluorescent material and green-light-emitting fluorescent material are markedly smaller than those in a light-emitting member containing no blue-light-emitting fluorescent material. This results in insufficient red light and green light, and the resulting illuminating device has very low luminous efficiency.

Nanoparticle fluorescent materials can transmit light in the visible region or its vicinity. Thus, when at least an overwhelmingly large amount of blue-light-emitting fluorescent material is used as a nanoparticle fluorescent material, the blue-light-emitting fluorescent material can be prevented from interfering excitation of another fluorescent material or interfering fluorescence emission from another fluorescent material to the outside of the light-emitting section 5. This can also improve the color rendering properties of illumination light from the light-emitting section 5 as compared with a light-emitting device that utilizes blue light of LED or LD as part of illumination light. This is the reason for using a blue-light-emitting fluorescent material as a nanoparticle fluorescent material.

### (Preferred Combination of Plurality of Fluorescent Materials)

A preferred combination of fluorescent materials in the light-emitting section 5 will be described below.

(1) A combination of a blue-light-emitting nanoparticle fluorescent material and a YAG:Ce fluorescent material (a yellow-light-emitting fluorescent material): although the color rendering properties are slightly poor, the light-emitting section 5 has the highest luminous efficiency (quantum internal efficiency). Furthermore, it has a cost advantage because of the low cost of the YAG:Ce fluorescent material. The combination can also achieve a high color temperature.

The blend ratio of the fluorescent materials is (YAG:Ce fluorescent material):(blue-light-emitting nanoparticle fluorescent material)=approximately 1:0.2 to 1:1 in terms of weight ratio. The blend ratio of the two types of fluorescent materials to the transparent fine particles 59 is in the range of approximately 1:1 to 5:1 in terms of weight ratio. The blend ratio of the two types of fluorescent materials and the transparent fine particles 59 to the sealant is approximately 10:1 in terms of weight ratio.

(2) A combination of a blue-light-emitting nanoparticle fluorescent material, a β-SiAlON:Eu fluorescent material (a green-light-emitting fluorescent material), and a CASN:Eu fluorescent material (a red-light-emitting fluorescent material, an orange-light-emitting fluorescent material): although the light-emitting section 5 has slightly low luminous efficiency (quantum internal efficiency), the combination has the best color rendering properties. The combination can also achieve a low color temperature.

The blend ratio of the fluorescent materials is (CASN:Eu fluorescent material):(β-SiAlON:Eu fluorescent material):(blue-light-emitting nanoparticle fluorescent material)=approximately 1:1 to 4:1 to 10 in terms of weight ratio. The blend ratio of the three types of fluorescent materials to the transparent fine particles 59 is in the range of approximately 1:1 to 5:1 in terms of weight ratio. The blend ratio of the three types of fluorescent materials and the transparent fine particles 59 to the sealant is approximately 10:1 in terms of weight ratio.

The combination of a plurality of fluorescent materials in the light-emitting section 5 is not limited to (1) and (2) described above.

### (Relationship Between Fluorescent Materials and Chromaticity)

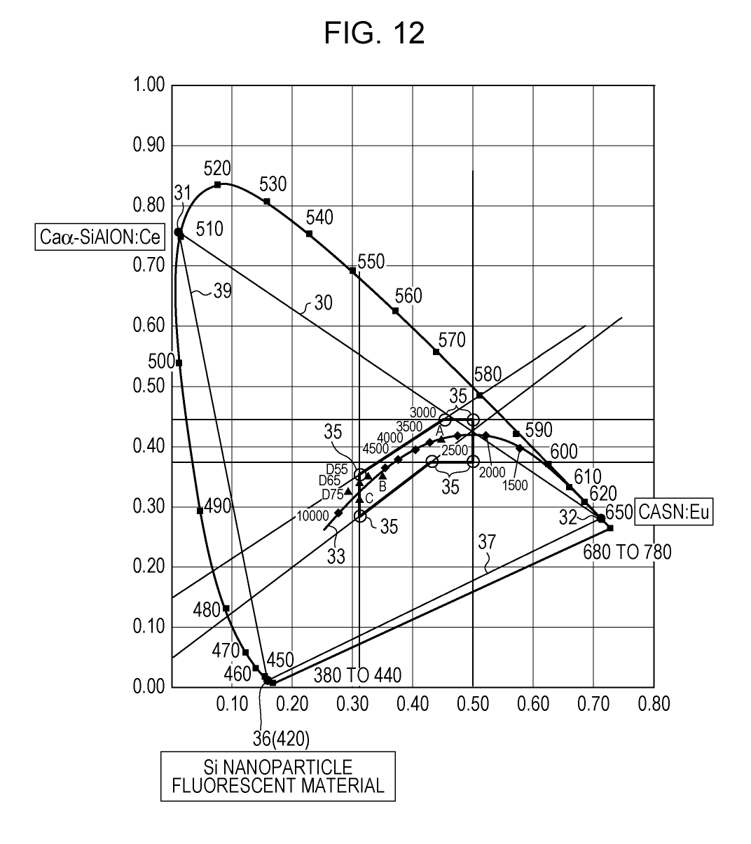

The relationship between a plurality of fluorescent materials in the light-emitting section 5 and chromaticity will be described below with reference to FIG. 12. FIG. 12 is a graph of the chromaticity range of illumination light.

A Si nanoparticle fluorescent material (peak wavelength: approximately 420 nm, see point 36), a Caα-SiAlON:Ce fluorescent material (peak wavelength: approximately 510 nm, see point 31), and a CASN:Eu fluorescent material (peak wavelength: approximately 650 nm, see point 32) will be described below as examples of a plurality of fluorescent materials in the light-emitting section 5.

The Si nanoparticle fluorescent material, the Caα-SiAlON:Ce fluorescent material, and the CASN:Eu fluorescent material are typical examples of the blue-light-emitting fluorescent material 56, the green-light-emitting fluorescent material 51, and the red-light-emitting fluorescent material 52 described above.

A curved line 33 in the figure indicates color temperatures (K: Kelvin). A polygon having vertexes of six points 35 represents the chromaticity range of white light required for vehicle headlights stipulated in a law.

The blend ratio of the three types of fluorescent materials can be controlled to manufacture the light-emitting section 5 that can emit illumination light having any chromaticity in a chromaticity range indicated by a triangle having vertexes of points 31, 32, and 36. The combination of the three types of fluorescent material has substantially the largest area of a triangle covering the chromaticity range in the graph illustrated in FIG. 12. Thus, the light-emitting section 5 thus manufactured can emit illumination light having a very wide range of chromaticity.

The chromaticity range indicated by the triangle overlaps widely with the chromaticity range of white light required for vehicle headlights. Thus, the blend ratio of the three types of fluorescent material can be controlled to manufacture the light-emitting section 5 suitable for vehicle headlights.

For example, the blend ratio of the fluorescent materials is (CASN:Eu fluorescent material):(Caα-SiAlON:Ce fluorescent material):(Si nanoparticle fluorescent material)=approximately 1:1 to 5:1 to 10 in terms of weight ratio. The blend ratio of the three types of fluorescent materials to the transparent fine particles 59 is in the range of approximately 1:1 to 5:1 in terms of weight ratio. The blend ratio of the three types of fluorescent materials and the transparent fine particles 59 to the sealant is approximately 10:1 in terms of weight ratio.

Even when a plurality of fluorescent materials in the light-emitting section 5 are not a combination of three types of fluorescent material, irrespective of the material and the number of types of fluorescent materials, the blend ratio of the fluorescent materials in the light-emitting section 5 may be controlled so as to emit illumination light having chromaticity in the chromaticity range of white light required for vehicle headlights. Thus, the light-emitting section 5 suitable for vehicle headlights can be manufactured, irrespective of the material and the number of types of fluorescent materials in the light-emitting section 5.

### (Arrangement and Shape of Light-Emitting Section 5)

The light-emitting section 5 is fixed at the focal position of the reflector 6 or its vicinity on the inner surface (the side of the light-emitting surface 4b) of the transparent sheet 7. The position of the light-emitting section 5 is fixed not only by this method but also with a (preferably transparent) rod-like or tubular member extending from the reflector 6.

The shape of the light-emitting section 5 is not particularly limited and may be rectangular cuboid or cylindrical. The headlamp 60 according to the present embodiment is cylindrical. The cylindrical light-emitting section 5 is a cylinder having a diameter of 2 mm and a thickness (height) of 0.8 mm.

The laser beam irradiation surface 5a of the light-emitting section 5 is not necessarily flat and may be curved. In order to control the reflection of a laser beam, the laser beam irradiation surface 5a is preferably a plane perpendicular to the optical axis of the laser beam.

The thickness of the cylindrical light-emitting section 5 is not limited to 0.8 mm. The required thickness of the light-emitting section 5 depends on the ratio of the sealant to the fluorescent material in the light-emitting section 5. A high fluorescent material content of the light-emitting section 5 results in high conversion efficiency from a laser beam into white light and a decrease in the thickness of the cylindrical light-emitting section 5.

### (Light Emission Principle of Light-Emitting Section 5, Reflector 6)

The principle of light emission from a fluorescent material in response to a laser beam emitted from the laser diode 2 and the reflector 6 have been described above.

### (Transparent Sheet 7)

The transparent sheet 7 is a transparent resin sheet that covers the opening of the reflector 6 and holds the light-emitting section 5. The transparent sheet 7 is preferably made of a material that intercepts a laser beam emitted from the laser diode 2 and that transmits white light (incoherent light), which is converted from the laser beam in the light-emitting section 5. The transparent sheet 7 may be an inorganic glass sheet as well as a resin sheet. For example, the transparent sheet 7 is ITY418 manufactured by Isuzu Seiko Glass Co., Ltd.

A laser beam containing many coherent components is mostly converted into incoherent white light by the light-emitting section 5 and is scattered and diffused by fluorescent materials other than a nanoparticle fluorescent material or transparent fine particles. However, part of the laser beam may not be converted into white light and may not be scattered or diffused from any cause. Even in such a case, the transparent sheet 7 can intercept a laser beam directly emitted from the laser diode 2 and thereby prevent the laser beam emitted from the laser diode 2 having a very small luminous point from leaking out.

The transparent sheet 7 does not necessarily completely intercept the laser beam or completely transmit fluorescence emitted from the light-emitting section 5. The transparent sheet 7 need not to completely intercept the components, provided that direct light (the luminous point itself of the laser diode 2) emitted from the laser diode 2 for emitting a laser beam that is harmful to the human body is attenuated such that the direct light be directly seen and such that the amount of transmitted light is at a safe level. The transparent sheet 7 need not to completely transmit fluorescence, provided that a sufficient amount of fluorescence (or fluorescence having a sufficiently high color temperature) is emitted as white light of the headlamp 60.

Thus, in the headlamp 60, the light-emitting section 5 emits light upon receiving a laser beam emitted from the laser diode 2, and the fluorescence is emitted through the transparent sheet 7. The laser beam is intercepted with the transparent sheet 7 and does not leak out. This can prevent a laser beam that has not been converted into fluorescence (or has not been scattered or diffused) from being emitted outward to cause damage to the human eye.

When the excitation light source is LED, light from LED has a much larger luminous point size than the laser diode 2. This reduces the necessity of intercepting the light. Thus, direct emission of LED light to the outside of the illuminating device generally causes no problems. When the excitation light source is the laser diode 2, since direct intrusion of light from the laser diode 2 having a very small luminous point into the human eye is harmful, direct light from the luminous point of the laser diode 2 must be intercepted, as described above. Thus, the present embodiment includes the transparent sheet 7.

In other words, when LED is used as an excitation light source, it is easy to emit light from LED to the outside to increase the color temperature. On the other hand, as in the present embodiment, when the laser diode 2 is used, designing must consider a decrease in color temperature due to the transparent sheet 7 and the safety described above.

Since the headlamp 60 includes a blue nanoparticle fluorescent material, which contains many blue components, as a fluorescent material, the color temperature of white light can be increased even when the laser beam is intercepted. In other words, even when the headlamp 60 includes the laser diode 2 and the transparent sheet 7, desired white light having a high color temperature can be emitted while the laser beam is prevented from leaking out. Thus, white light having a high color temperature can be emitted with safety taken into account.

### Fifth Embodiment

A headlamp (light-emitting device, illuminating device, headlight) 70 according to another embodiment of the present invention will be described below with reference to FIG. 14. Like members in the headlamp 60 and the headlamp 70 are designated by like reference numerals and will not be further described. The headlamp 70 of a projector type will be described below.

### (Structure of Headlamp 70)

The structure of the headlamp 70 according to the present embodiment will be described below with reference to FIG. 14. FIG. 14 is a cross-sectional view of the structure of the headlamp 70, which is a projector-type headlamp. The headlamp 70 is different from the headlamp 60 in that the headlamp 70 is a projector-type headlamp and includes an optical fiber (light guide member) 40 instead of the light guide member 4. The optical fiber 40 has been described above.

As illustrated in the figure, the headlamp 70 includes a laser diode array 2a, aspheric lenses 3, the optical fiber 40, a ferrule 9, a light-emitting section 5, a reflector 6, a transparent sheet 7, a housing 10, an extension 11, a lens 12, a convex lens 38, and a lens holder 8. Laser diodes 2, the optical fiber 40, the ferrule 9, and the light-emitting section 5 constitute the basic structure of the light-emitting device.

The headlamp 70 is a projector-type headlamp and therefore includes the convex lens 38. The present invention may be applied to another type of headlamp (for example, a semi-sealed beam headlamp), in which the convex lens 38 may be omitted.

### (Aspheric Lenses 3, Optical Fiber 40)

The aspheric lenses 3 and the optical fiber 40 have been described above.

### (Ferrule 9)

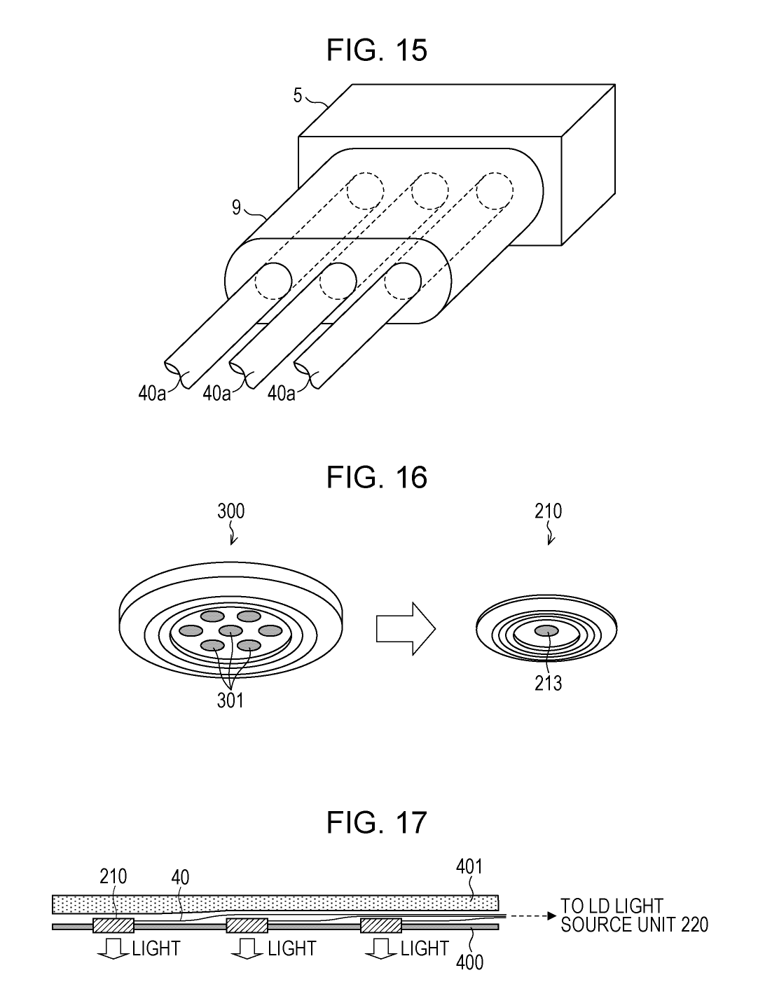

FIG. 15 is a view illustrating the positional relationship between outlet ends 40a of the optical fiber 40 and the light-emitting section 5. As illustrated in the figure, the ferrule 9 holds the outlet ends 40a of the optical fiber 40 arranged in a predetermined pattern relative to the laser beam irradiation surface 5a of the light-emitting section 5. The ferrule 9 has been described above.

Although the number of optical fibers constituting the optical fiber 40 is three in FIG. 15, the number of optical fibers constituting the optical fiber 40 is not limited to three. The ferrule 9 may be fixed with a rod-like member extending from the reflector 6.

The outlet ends 40a of the ferrule 9 may be in contact with or slightly separated from the laser beam irradiation surface 5a.

It is not necessary to disperse the outlet ends 40a of each optical fiber. The optical fibers may be combined together using the ferrule 9.

### (Light-Emitting Section 5)

As described above, the light-emitting section 5 emits white fluorescence upon receiving a laser beam emitted from the outlet ends 40a of the optical fiber 40 and includes a blue nanoparticle fluorescent material, which contains many blue components. Thus, white light having a high color temperature can be emitted. The light-emitting section 5 of the headlamp 70 is rectangular cuboid and is approximately 3 mm in width×1 mm in length×1 mm in height. The light-emitting section 5 is disposed in the vicinity of a first focal point of the reflector 6 described below. The light-emitting section 5 may be fixed to the tip of a tubular portion passing through the center of the reflector 6. In this case, the optical fiber 40 may pass through the inside of the tubular portion.

### (Reflector 6)

The reflector 6 is a member having a thin metal film on its surface and reflects light emitted from the light-emitting section 5 to focus the light. Since the headlamp 70 is a projector-type headlamp, the basic shape of the reflector 6 has an elliptical cross section parallel to the optical axis direction of reflected light. The reflector 6 has a first focal point and a second focal point. The second focal point is closer to the opening of the reflector 6 than the first focal point. The convex lens 38 described below is disposed such that its focal point is disposed in the vicinity of the second focal point. The convex lens 38 projects light that is converged on the second focal point by the reflector 6 toward the front.

### (Transparent Sheet 7)

As described above, the transparent sheet 7 intercepts excitation light and transmits fluorescence emitted from the light-emitting section 5. The transparent sheet 7 holds the light-emitting section 5. The transparent sheet 7 can prevent a laser beam emitted from the laser diode 2 from leaking out directly.

### (Convex Lens 38)

The convex lens 38 converges light emitted from the light-emitting section 5 and projects the converged light toward the front of the headlamp 70. The focal point of the convex lens 38 is disposed in the vicinity of the second focal point of the reflector 6. The optical axis of the convex lens 38 passes through substantially the center of the light-emitting surface of the light-emitting section 5. The convex lens 38 is held by the lens holder 8, thereby defining the position of the convex lens 38 relative to the reflector 6. The lens holder 8 may be part of the reflector 6.

### (Other Members)

The housing 10, the extension 11, and the lens 12 have been described above.

As described above, the headlamp may have any structure. It is important in the present invention that in the composition of the light-emitting section 5 at least one fluorescent material for emitting fluorescence having a lower peak wavelength than the other fluorescent materials is a nanoparticle fluorescent material.

### Sixth Embodiment

Another embodiment of the present invention will be described below with reference to FIG. 10.

(Structure of Headlamp 60a)

### (Technical Idea of Present Invention)

In general, blue-light-emitting fluorescent materials have low luminous efficiency and transparency. A known wavelength conversion member (for example, a light-emitting section) that contains a blue-light-emitting fluorescent material must contain a large amount of blue-light-emitting fluorescent material in order to improve luminous efficiency, which reduces the transparency of the wavelength conversion member. This reduces excitation of a red-light-emitting fluorescent material or a green-light-emitting fluorescent material, which can achieve relatively high efficiency output, and light extraction efficiency from these fluorescent materials. In addition, a known wavelength conversion member contains a large amount of blue-light-emitting fluorescent material, which increases the manufacturing costs of the wavelength conversion member.

In view of such situations, the present inventor has worked on the development of the following light-emitting device. The light-emitting device includes a wavelength conversion member that contains a sealant made of a fluorescent glass for emitting blue fluorescence in response to excitation light emitted from an excitation light source. Fluorescent materials, such as a red-light-emitting fluorescent material and a green-light-emitting fluorescent material, are dispersed in the wavelength conversion member. It is believed that such a structure can provide a wavelength conversion member and a light-emitting device that can efficiently emit illumination light having good color rendering properties. Furthermore, the good color rendering properties include both improved color rendering properties due to the addition of fluorescence having a longer wavelength than blue and improved color rendering properties in the blue region itself.

A wavelength conversion member and a light-emitting device according to the present invention are based on such a technical idea. A headlamp (light-emitting device, illuminating device, vehicle headlight) 60a that satisfies the light distribution characteristic standard of an automotive main-beam headlight (high beam) will be described below as a light-emitting device according to an embodiment of the present invention. A light-emitting device according to the present invention may be a headlamp for vehicles and moving objects other than automobiles (for example, humans, ships, aircrafts, submarines, and rockets) or another light-emitting device, such as a searchlight.

(Structure of Headlamp 60a)

The structure of the headlamp (light-emitting device) 60a according to the present embodiment will be described below with reference to FIG. 10. FIG. 10 is a schematic view of the structure of the headlamp 60a. As illustrated in the figure, the headlamp 60a includes a laser diode 2 (an excitation light source), an aspheric lens 3, a light guide member 4, a light-emitting section (wavelength conversion member) 5, a reflector 6, and a transparent sheet 7 (a light-emitting-section-supporting member). The light-emitting section 5 is disposed on a surface of the transparent sheet 7 on the light guide member 4 side. The light-emitting section 5 may be disposed on a surface of the transparent sheet 7 opposite the light guide member 4.

The headlamp 60a according to the present embodiment is mainly different from the headlamp 60 in that a fluorescent glass described below is used as a sealant for sealing fluorescent materials contained in the light-emitting section 5. The other components are substantially the same as in the headlamp 60. Thus, only the difference from the headlamp 60 will be described below, and the others will not be further described.

### (Laser Diode 2)

The laser diode 2 according to the present embodiment may have one luminous point (one stripe) per chip and emit a laser beam in the range of 350 to 380 nm. For convenience, FIG. 10 illustrates only one laser diode 2.

The wavelength of the laser beam is not limited to the range described above and is preferably in the range of 350 to 420 nm. A laser beam having a wavelength in the range of 350 to 420 nm allows a blue fluorescent glass described below to efficiently emit light, thereby realizing the headlamp 60a having still higher luminous efficiency.

The excitation light source may be a light-emitting diode.

### (Light-Emitting Section 5)

The light-emitting section 5 according to the present embodiment emits white light or pseudo-white light upon receiving a laser beam emitted from the light-emitting surface 4b of the light guide member 4 and contains a sealant made of a fluorescent glass for emitting blue fluorescence in response to a laser beam emitted from the laser diode 2 (hereinafter also referred to as a blue fluorescent glass). A red-light-emitting fluorescent material for emitting red fluorescence, a green-light-emitting fluorescent material for emitting green fluorescence, and a yellow-light-emitting fluorescent material for emitting yellow fluorescence upon receiving a laser beam are dispersed in the light-emitting section 5.

The fluorescent material(s) dispersed in the light-emitting section 5 may be at least one of the red-light-emitting fluorescent material, the green-light-emitting fluorescent material, and the yellow-light-emitting fluorescent material or may be a fluorescent material that emits fluorescence of a color other than red, green, and yellow upon receiving a laser beam. Thus, the light-emitting section 5 does not necessarily emit white fluorescence and may emit fluorescence of a different color.

### (Blue Fluorescent Glass)

A method for manufacturing a blue fluorescent glass will be described below.

In the manufacture of a sol-gel glass using tetraethoxysilane (Si(OC₂H₅)₄) and europium nitrate (Eu(NO₃)₃₋₆H₂O) as raw materials, aluminum butoxide (Al(OC₄H₉)₃) or aluminum nitrate (Al(NO₃)₃.9H₂O) is added such that Eu constitutes 5% by mole or less in terms of Eu₂O₃ and Al constitutes 10% by mole or less in terms of Al₂O₃ when the complete components of the sol-gel glass are expressed in % by mole of SiO₂:Al₂O₃:Eu₂O₃. The raw materials are dissolved in ethanol, water, or a nitric acid solution to prepare a starting sol. Under this condition, the sol-gel glass is manufactured by a gelation reaction in a common sol-gel process and heating to approximately 800° C. Because of the reducing ability of aluminum, europium ions, which are trivalent under normal conditions, become divalent and thereby produce a sol-gel glass for emitting blue light.

A blue fluorescent glass may also be manufactured by adding an appropriate concentration of a rare-earth element (for example, Ce³⁺ (trivalent cerium)) that acts as a luminescent center in the manufacture of a known low-melting glass (for example, having a composition of SiO₂-α₂O₃—CaO—BaO—LiO₂—Na₂O and a melting point of 530° C.) to manufacture a low-melting-point fluorescent glass.

The blue fluorescent glass is only an example and does not limit the scope of the present invention. Thus, as described above, a manufacture method using Ce³⁺ instead of Eu²⁺ or a method for manufacturing a blue fluorescent glass using neodymium (Nd) may also be employed. The fluorescent glass may also be manufactured by a method other than doping of a glass base material with a rare-earth element.

The blue fluorescent glass characteristically transmits light and does not absorb excitation light and fluorescence of a red-light-emitting fluorescent material, a green-light-emitting fluorescent material, and a yellow-light-emitting fluorescent material described below. Thus, the characteristics of an oxynitride-based fluorescent material (oxynitride fluorescent material) or a nitride fluorescent material that can produce highly efficient output can be fully exploited.

### (Red-Light-Emitting Fluorescent Material)

The red-light-emitting fluorescent material in the light-emitting section 5 according to the present embodiment is the same as the red-light-emitting fluorescent material 52 and will not be further described.

(Green-Light-Emitting Fluorescent Material)

Examples of a green-light-emitting fluorescent material for emitting green light upon receiving a laser beam include various nitride-based and oxynitride-based fluorescent materials.

Examples of the oxynitride-based fluorescent material that emits green light include a β—SiAlON:Eu fluorescent material and a Caα-SiAlON:Ce fluorescent material (see the green-light-emitting fluorescent material 51).

Examples of the nitride-based fluorescent material that emits green light include Eu-activated oxynitride fluorescent materials, such as (Mg, Sr, Ba, Ca) Si₂O₂N₂:Eu and Eu-activated β-sialons.

The green-light-emitting fluorescent material for emitting green light upon receiving a laser beam may also be a Eu-activated fluorescent material, for example, an oxynitride-based fluorescent material having a SiAlON structure, such as Caₓ(Si, Al)₁₂(O, N)₁₆:Eu.

### (Others)

A fluorescent material dispersed in a fluorescent glass may be YAG:Ce³⁺ or CaAlSiN₃:Ce³⁺. Since YAG:Ce³⁺ has an excitation wavelength range in the range of 430 to 490 nm, YAG:Ce³⁺ is not excited by light emitted from the laser diode 2. YAG:Ce³⁺ absorbs part of blue light emitted from a fluorescent glass to emit yellow fluorescence. Since CaAlSiN₃:Ce³⁺ is excited by light having a wavelength of 500 nm or less, CaAlSiN₃:Ce³⁺ absorbs and is excited by a laser beam emitted from the laser diode 2 and part of blue light emitted from a fluorescent glass to emit yellow, orange, or red light. In any case, since a large amount of known opaque blue-light-emitting fluorescent material is not required, the high-efficiency headlamp 60a can be provided.

### (Method for Manufacturing Light-Emitting Section 5)

First, a blue fluorescent glass is produced by the method described above. The blue fluorescent glass is then pulverized and classified to form a glass frit having a particle size in the range of 150 to 250 μm.

The glass frit, a green-light-emitting fluorescent material (Caα-SiAlON:Ce³⁺), and a red-light-emitting fluorescent material (CASN:Eu²⁺) are mixed at a weight ratio of 100:6:2 (a mixing step). A mold having a desired shape (a mold having φ₂ mm and a height of 0.5 mm is used in the present embodiment) is filled with the mixture (a molding step). The molded product is heated in the atmosphere at 550° C. (a heating step) for one hour. In this manner, the light-emitting section 5 is manufactured. In the present embodiment, the mold is a boron nitride (BN) formed product.

The light-emitting section 5 is manufactured by this method using the blue fluorescent glass, the green-light-emitting fluorescent material, and the red-light-emitting fluorescent material. The present method for manufacturing the light-emitting section 5 is only an example and does not limit the scope of the present invention.

### (Transparent Fine Particles)

In particular, when the excitation light source is a laser beam, the light-emitting section 5 according to the present embodiment may contain the transparent fine particles.

Because of the reason described below, the transparent fine particles 59 preferably have a particle size in the range of 1 to 50 μm and a higher refractive index than blue fluorescent glass and transmit light.

The transparent fine particles 59 having a particle size of 1 μm or more can sufficiently cause Mie scattering or diffraction scattering of ultraviolet to visible light and sufficiently scatter or diffuse a laser beam. However, a particle size of more than 50 μm may result in an imbalance with the particle size of a fluorescent material, resulting in insufficient irradiation of the fluorescent material with a laser beam.

Since the particles can transmit light, the particles do not intercept excitation light irradiation of a fluorescent material or outward emission of fluorescence. Since the transparent fine particles 59 have a higher refractive index than a blue fluorescent glass sealant, the dispersed transparent fine particles 59 have the effects of a diffusing member or a scattering member because of reflection at the interface between the fluorescent glass and the transparent fine particles 59.

For these reasons, particularly when the excitation light source is a laser beam, the transparent fine particles 59 in the light-emitting section 5 can scatter or diffuse the laser beam and improve the efficiency of the headlamp 60a. Dispersion of a laser beam by the transparent fine particles 59 ensures eye safety.

### (Reflector 6)

The reflector 6 reflects incoherent light emitted from the light-emitting section 5 to form a bundle of rays that travels within a predetermined solid angle. In other words, the reflector 6 reflects light emitted from the light-emitting section 5 to form a bundle of rays that travels toward the headlamp 1. For example, the reflector 6 is a curved (cup-shaped) member on which a thin metal film is formed and has an opening toward the traveling direction of reflected light.

### (Transparent Sheet 7)

A coherent component in a laser beam may cause damage to the human eye. Thus, direct emission of a laser beam to the outside of the headlamp 60a may cause a problem. In such a case, the transparent sheet 7 (a cutoff filter) that intercepts a laser beam in the oscillation wavelength range allows only incoherent light to be emitted to the outside of the headlamp 60a. The headlamp 60a may include such a cutoff filter.

### (Light Emission Principle of Light-Emitting Section 5)

As described above, white light can be made up by the color mixing of three colors that satisfy the isochromatic principle, and pseudo-white light can be made up by the color mixing of two colors that satisfy the relationship of complementary colors. On the basis of these principle and relationship, the color of a laser beam emitted from a laser diode and the colors of light emitted from fluorescent materials are mixed to produce white light or pseudo-white light.

In the present embodiment, laser beam irradiation of a blue fluorescent glass produces blue light, laser beam irradiation of a red-light-emitting fluorescent material produces red light, and laser beam irradiation of a green-light-emitting fluorescent material produces green light. The color mixing of the three colors produces white light. Some fluorescent materials are not excited by light emitted from the laser diode 2, absorb part of blue light emitted from a fluorescent glass, and emit fluorescence. The fluorescence is mixed with another color light, and the mixed color light is emitted outward from the headlamp 60a.

### [Another Example of Headlamp]

The composition of the light-emitting section 5 of the headlamp 70 illustrated in FIG. 14 may be the composition of the light-emitting section 5 of the headlamp 60a.

As described above, the headlamp may have any structure. It is important in the present invention that the headlamp includes the light-emitting section 5 that contains a sealant made of a fluorescent glass for emitting blue fluorescence in response to a laser beam emitted from the laser diode 2, and the light-emitting section 5 contains fluorescent materials, such as a red-light-emitting fluorescent material and a green-light-emitting fluorescent material, dispersed therein. Thus, the headlamp can efficiently emit illumination light having good color rendering properties.

### Seventh Embodiment

Another embodiment of the present invention will be described below with reference to FIGS. 16 to 20 and FIG. 23. Like members in the first to sixth embodiments and the present embodiment are designated by like reference numerals and will not be further described.

A laser downlight 200 will be described below as an example of an illuminating device according to the present invention. The laser downlight 200 is an illuminating device to be installed on the ceiling of a structure, such as a house or a vehicle. A light-emitting section 5 is irradiated with a laser beam emitted from a laser diode 2 to emit fluorescence as illumination light.

An illuminating device having substantially the same structure as the laser downlight 200 may be installed on a sidewall or floor of a structure. The installation location of the illuminating device is not particularly limited.

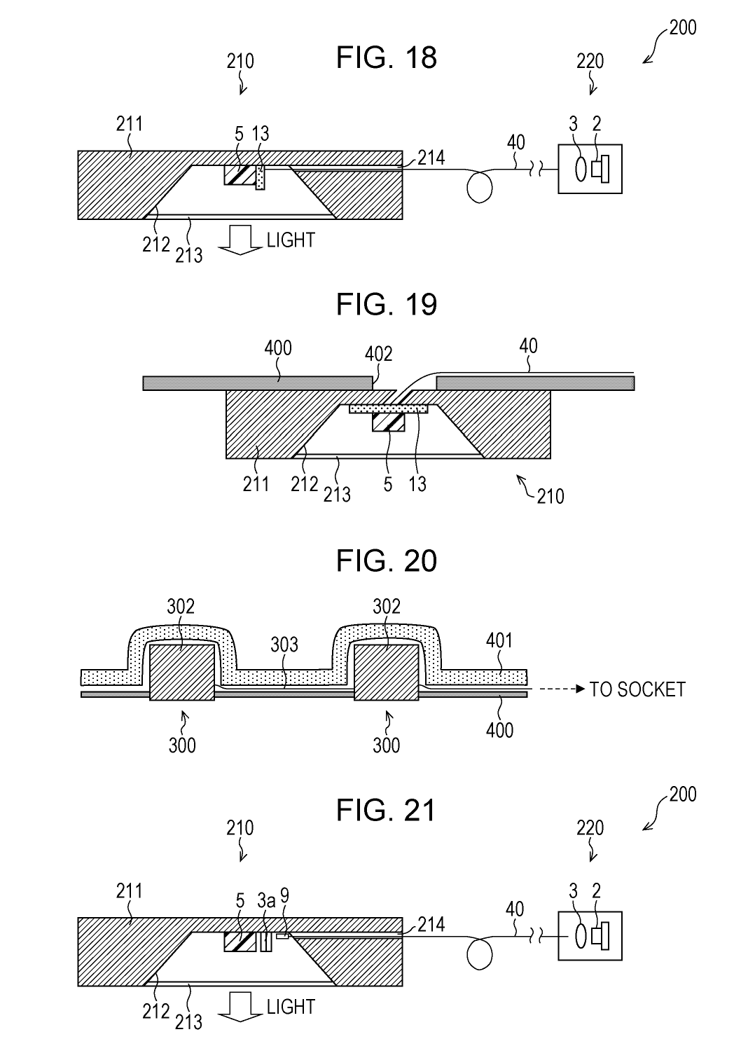

FIG. 16 is a schematic view of the appearance of a light-emitting unit 210 of the laser downlight 200 and a known LED downlight 300. FIG. 17 is a cross-sectional view of the ceiling on which the laser downlight 200 is installed. FIG. 18 is a cross-sectional view of the laser downlight 200. As illustrated in FIGS. 16 to 18, the laser downlight 200 is installed in a top plate 400 and includes the light-emitting unit 210 for emitting illumination light and a LD light source unit 220 for supplying a laser beam to the light-emitting unit 210 through an optical fiber 40. The LD light source unit 220 is not installed on the ceiling but is installed at a location accessible to a user (for example, on a sidewall in a house). The LD light source unit 220 can be placed in any location because the LD light source unit 220 is connected to the light-emitting unit 210 via the optical fiber 40. The optical fiber 40 is disposed between the top plate 400 and a heat insulator 401.

### (Structure of Light-Emitting Unit 210)

As illustrated in FIG. 18, the light-emitting unit 210 includes a case 211, the optical fiber 40, the light-emitting section 5, a heat-conductive member 13, and a light-transmitting sheet 213. Although not shown in FIG. 18, the light-emitting section 5 according to the present embodiment contains the dispersed diffusing particles 15 described above. In the same manner as in the embodiment described above, the diffusing particles 15 in the light-emitting section 5 can diffuse and convert a laser beam having high coherence and a very small luminous point size into light having a large luminous point size that is little harmful to the human body. This can improve the eye safety of the laser downlight 200.

The case 211 includes a depressed portion 212. The light-emitting section 5 is disposed on the bottom of the depressed portion 212. The depressed portion 212 includes a thin metal film on its surface and functions as a reflector.

The case 211 includes a path 214 for the optical fiber 40. The optical fiber 40 reaches the heat-conductive member 13 through the path 214. A laser beam from an outlet end 40a of the optical fiber 40 reaches the light-emitting section 5 via the heat-conductive member 13.

The light-transmitting sheet 213 is a transparent or translucent sheet for covering the opening of the depressed portion 212. The light-transmitting sheet 213 has substantially the same function as the transparent sheet 7. Fluorescence from the light-emitting section 5 is emitted as illumination light through the light-transmitting sheet 213. The light-transmitting sheet 213 may be detachable from the case 211 or may be omitted.

Although the light-emitting unit 210 has a circular outer edge in FIG. 16, the shape of the light-emitting unit 210 (in the more strict sense, the shape of the case 211) is not particularly limited.

Unlike headlamps, downlights require no ideal point light source and only require one luminous point. Thus, restrictions on the shape, size, and position of the light-emitting section 5 are fewer than those in headlamps.

### (Structure of LD Light Source Unit 220)

The LD light source unit 220 includes a laser diode 2, an aspheric lens 3, and the optical fiber 40.

An inlet end 40b of the optical fiber 40 is connected to the LD light source unit 220. A laser beam from the laser diode 2 enters the inlet end 40b of the optical fiber 40 through the aspheric lens 3.

Although the LD light source unit 220 illustrated in FIG. 18 includes a pair of the laser diode 2 and the aspheric lens 3, for a plurality of light-emitting units 210, a bundle of optical fibers 40 extending from the light-emitting units 210 may be connected to a single LD light source unit 220. In this case, the single LD light source unit 220 includes a plurality of pairs of the laser diode 2 and the aspheric lens 3 and functions as an integrated power supply box.

### (Modified Example of Method for Installing Laser Downlight 200)

FIG. 19 is a cross-sectional view of a modified example of a method for installing the laser downlight 200. As illustrated in the figure, in accordance with a modified example of a method for installing the laser downlight 200, the top plate 400 includes a small opening 402 for the optical fiber 40 and, taking a low-profile light-weight advantage, a laser downlight main body (the light-emitting unit 210) may be attached to the top plate 400. This advantageously eases restrictions on the installation of the laser downlight 200 and significantly reduces installation costs.

In this structure, the heat-conductive member 13 is disposed on the bottom of the case 211 such that the laser beam incident surface of heat-conductive member 13 is entirely in contact with the bottom. Thus, the case 211 made of a heat-conductive substance can function as a cooling section for the heat-conductive member 13.

### (Comparison of Laser Downlight 200 and Known LED Downlight 300)

As illustrated in FIG. 16, the known LED downlight 300 includes a plurality of light-transmitting sheets 301. Illumination light is emitted through each of the light-transmitting sheets 301. Thus, the LED downlight 300 has a plurality of luminous points. The reason for the presence of the plurality of luminous points in the LED downlight 300 is that because of relatively small light flux from each luminous point sufficient light flux for illumination light cannot be produced without the plurality of luminous points.

In contrast, the laser downlight 200 is a high-light-flux illuminating device and may require only one luminous point. Thus, illumination light can advantageously create clear shadows. When a fluorescent material in the light-emitting section 5 is a high-color-rendering fluorescent material (for example, a combination of a few types of oxynitride fluorescent material), illumination light can have improved color rendering properties.

This can achieve high color rendering that is close to the color rendering properties of incandescent downlights. For example, a combination of the high-color-rendering fluorescent material and the laser diode 2 can produce even high-color-rendering light having a general color rendering index Ra of 90 or more as well as a special color rendering index R9 of 95 or more, which is difficult to produce with LED downlights or fluorescent downlights.

FIG. 20 is a cross-sectional view of a ceiling on which the LED downlight 300 is installed. As illustrated in the figure, the LED downlight 300 includes a case 302 disposed in a top plate 400. The case 302 houses a LED chip, a power supply, and a cooling unit. The case 302 is relatively large. A heat insulator 401 in which the case 302 is disposed has a depressed portion corresponding to the shape of the case 302. A power supply line 303 extends from the case 302 and is connected to a socket (not shown).

Such a structure has the following problems. First, because of a light source (LED chip) and a power supply, which are heat sources, between the top plate 400 and the heat insulator 401, use of the LED downlight 300 increases the temperature of the ceiling and reduces cooling efficiency in the room.

Furthermore, the LED downlight 300 requires a power supply and a cooling unit for each light source. This increases the total cost.

Since the case 302 is relatively large, it is often difficult to install the LED downlight 300 between the top plate 400 and the heat insulator 401.

In contrast, the light-emitting unit 210 of the laser downlight 200 includes no large heat source and does not reduce cooling efficiency in the room. This can prevent an increase in cooling cost of the room.

It is not necessary to provide a power supply and a cooling unit for each light-emitting unit 210. Thus, the size and thickness of the laser downlight 200 can be reduced. This eases restrictions on the installation space for the laser downlight 200, thereby facilitating installation in existing houses.

Since the laser downlight 200 is small and thin, the light-emitting unit 210 can be installed on the surface of the top plate 400 as described above. This can ease restrictions on installation as compared with the LED downlight 300 and significantly reduce installation costs.

FIG. 23 is a table for comparing the specifications of the laser downlight 200 and the LED downlight 300. As illustrated in the figure, the laser downlight 200 in this example can reduce the volume by 94% and the mass by 86% as compared with the LED downlight 300.

Since the LD light source unit 220 is accessible to a user, the laser diode 2 can be easily replaced in case of a failure of the laser diode 2. Optical fibers 40 from a plurality of light-emitting units 210 can be connected to one LD light source unit 220 to control the plurality of laser diodes 2 by one operation. This facilitates the replacement of a plurality of laser diodes 2.

When the LED downlight 300 contains a high-color-rendering fluorescent material, a power consumption of 10 W results in the emission of light flux of approximately 500 lm. Light of the same brightness in the laser downlight 200 requires a light output of 3.3 W. If the LD efficiency is 35%, this light output corresponds to a power consumption of 10 W. Since the power consumption of the LED downlight 300 is also 10 W, no significant difference in power consumption is found between these downlights. Thus, the laser downlight 200 has the various advantages described above while consuming the same power as the LED downlight 300.

As described above, the laser downlight 200 includes the LD light source unit 220, which includes at least one laser diode 2 for emitting a laser beam, at least one light-emitting unit 210, which includes the light-emitting section 5 and the depressed portion 212 serving as a reflector, and the optical fiber 40 for guiding the laser beam to the light-emitting unit 210. The light-emitting section 5 contains the diffusing particles 15. The diffusing particles 15 diffuse a laser beam and improve eye safety.

### Eighth Embodiment

Another embodiment of the present invention will be described below with reference to FIGS. 18 and 19. Like members in the first to seventh embodiments and the present embodiment are designated by like reference numerals and will not be further described.

A main point of difference between the laser downlight 200 according to the present embodiment and the laser downlight 200 according to the seventh embodiment is a difference in the composition of the light-emitting section 5. The other points are the same as the laser downlight 200 according to the seventh embodiment. Thus, only the difference from the laser downlight 200 according to the seventh embodiment will be described below, and the other points are omitted.

### (Composition of Light-Emitting Section 5)

Although not shown in FIGS. 18 and 19, the light-emitting section 5 according to the present embodiment contains the dispersed heat-conductive filler 15a described above. As in the embodiment described above, since the light-emitting section 5 contains the heat-conductive filler 15a, the light-emitting section 5 has lower thermal resistance than before. Thus, heat of the light-emitting section 5 is efficiently transferred to the heat-conductive member 13 and is effectively dissipated. This can prevent the degradation of the light-emitting section 5 and a decrease in luminous efficiency due to heat generation.

This can improve the life and reliability of the laser downlight 200 as an ultrahigh-intensity light source that utilizes a laser beam as an excitation light source.

The laser downlight 200 according to the present embodiment may include a high-power LED as an excitation light source. In this case, LED for emitting light having a wavelength of 450 nm (blue) and a yellow fluorescent material or green and red fluorescent materials are combined to realize a light-emitting device for emitting white light.

A solid-state laser other than laser diodes may be used as an excitation light source. However, a laser diode is preferably used to reduce the size of an excitation light source.

### Ninth Embodiment

Another embodiment of the present invention will be described below with reference to FIGS. 18 and 19. Like members in the first to eighth embodiments and the present embodiment are designated by like reference numerals and will not be further described.

A main point of difference between the laser downlight 200 according to the present embodiment and the laser downlight 200 according to the seventh or eighth embodiment is that the fluorescent glass described above is used as a sealant for sealing fluorescent materials in the light-emitting section 5. The other points are the same as the laser downlight 200 according to the seventh or eighth embodiment. Thus, only the difference from the laser downlight 200 according to the seventh or eighth embodiment will be described below, and the other points are omitted.

### Composition of Light-Emitting Section 5)

Although not shown in FIGS. 18 and 19, the laser downlight 200 according to the present embodiment contains the fluorescent glass described above as a sealant for sealing fluorescent materials in the light-emitting section 5.

As in the embodiment described above, the laser downlight 200 according to the present embodiment includes the light-emitting section 5 that contains a sealant made of a fluorescent glass for emitting blue fluorescence in response to a laser beam emitted from the laser diode 2, and the light-emitting section 5 contains fluorescent materials, such as a red-light-emitting fluorescent material and a green-light-emitting fluorescent material, dispersed therein. Thus, the laser downlight can efficiently emit illumination light having good color rendering properties.

### Tenth Embodiment

### Laser Downlight 200

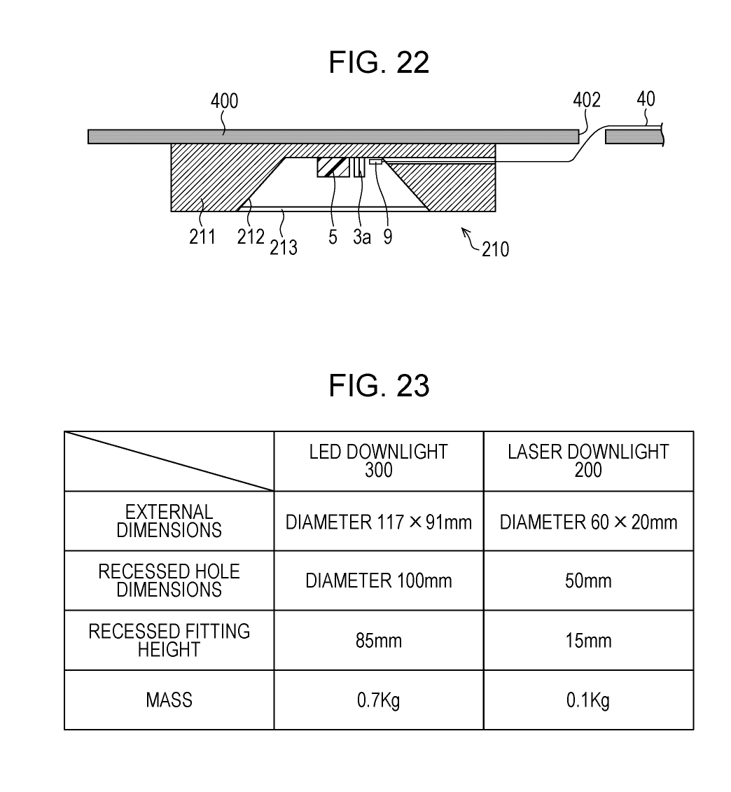

Another embodiment of the present invention will be described below with reference to FIGS. 21 and 22. Like members in the first to ninth embodiments and the present embodiment are designated by like reference numerals and will not be further described.

A main point of difference between the laser downlight 200 according to the present embodiment and the laser downlights 200 according to the seventh to ninth embodiments is a difference in the composition of the light-emitting section 5. The other points are the same as the laser downlights 200 according to the seventh to ninth embodiments. Thus, only the difference from the laser downlights 200 according to the seventh to ninth embodiment will be described below, and the other points are omitted.

### (Structure of Light-Emitting Unit 210)

As illustrated in FIG. 21, the light-emitting unit 210 includes a case 211, an optical fiber 40, a light-emitting section 5, an emission lens 3a, a ferrule 9, and a light-transmitting sheet 213.

The emission lens 3a may be a convex lens having a convex surface facing the light-emitting section 5 or a concave lens having a concave surface facing the light-emitting section 5. Although the present embodiment includes the emission lens 3a, no lens may be disposed between the light-emitting section 5 and the ferrule 9, and a laser beam may be directly emitted from an outlet end 40a of the optical fiber 40 to the light-emitting section 5.

Examples of the emission lens 3a include a biconvex lens, a plano-convex lens, and a convex meniscus lens each having a convex surface facing the light-emitting section 5, and a biconcave lens, a plano-concave lens, and a concave meniscus lens each having a concave surface facing the light-emitting section 5.

In addition to these examples, depending on the shape of the light-emitting section 5, the emission lens 3a may be a combination of independent lenses each having a concave surface and a convex surface each having an arbitrary axis, a combination of independent lenses each having a convex surface and a convex surface each having an arbitrary axis, or a combination of independent lenses each having a concave surface and concave surface each having an arbitrary axis.

A combination of lenses suitable for the shape of the light-emitting section 5 can increase the luminous efficiency of the light-emitting section 5.

Depending on the shape of the light-emitting section 5, the emission lens 3a may be an integrated compound lens of lenses each having a concave surface and a convex surface each having an arbitrary axis, an integrated lens of compound lenses each having a convex surface and a convex surface each having an arbitrary axis, or an integrated compound lens of lenses each having a concave surface and a concave surface each having an arbitrary axis.

This can reduce the number of components of the entire optical system and the size of the entire optical system, and a compound lens suitable for the shape of the light-emitting section 5 can increase the luminous efficiency of the light-emitting section 5.

Another lens may be a gradient index (GRIN) lens (gradient-refractive-index lens).

A GRIN lens has a lens function due to the refractive index gradient of the lens without having a convex or concave shape.

Thus, a GRIN lens can have a lens function while having a flat end surface, for example. An end surface of the GRIN lens can therefore be closely joined to an end surface of a light-emitting section 5, for example, of a rectangular cuboid shape.

### (Modified Example of Method for Installing Laser Downlight 200)

FIG. 22 is a cross-sectional view of a modified example of a method for installing the laser downlight 200. As illustrated in the figure, in accordance with a modified example of a method for installing the laser downlight 200, the top plate 400 includes a small opening 402 for the optical fiber 40 and, taking a low-profile light-weight advantage, a laser downlight main body (the light-emitting unit 210) may be attached to the top plate 400. This advantageously eases restrictions on the installation of the laser downlight 200 and significantly reduces installation costs.

### (Composition of Light-Emitting Section 5)

Although not shown in FIGS. 21 and 22, in the laser downlight 200 according to the present embodiment, at least one fluorescent material for emitting fluorescence having a lower peak wavelength than the other fluorescent materials in the composition of the light-emitting section 5 is a nanoparticle fluorescent material. Thus, in the laser downlight 200 according to the present embodiment, the light-emitting section 5 has improved luminous efficiency and is easy to manufacture.

As described above, the laser downlight 200 according to the present embodiment includes the emission lens 3a for dispersedly irradiating a light irradiation region of the light-emitting section 5 with irradiation light emitted from an outlet end 40a of the optical fiber 40.

This can reduce the possibility of marked degradation of the light-emitting section 5 due to concentrated laser beam irradiation of the light-emitting section 5 in the laser downlight 200. Thus, a long-life laser downlight 200 can be provided.

### [Another Representation of Present Invention]

The present invention may also be represented as described below.

In a light-emitting device according to the present invention, the fluorescent substance and the diffusing particles may be contained in a heat-resistant sealant.

When a laser beam is used as excitation light, a component of excitation light absorbed by a very small wavelength conversion member and converted into heat rather than converted into fluorescence by a fluorescent substance easily increases the temperature of the wavelength conversion member. This may impair the characteristics of the wavelength conversion member or cause thermal damage to the wavelength conversion member.

In accordance with this constitution, a fluorescent substance and diffusing particles are sealed with a heat-resistant sealant to form a wavelength conversion member. Thus, the possibility of degradation of the sealant can be reduced even when the wavelength conversion member is heated by laser beam irradiation. The heat dissipation efficiency of the fluorescent substance may be increased by using a certain material (for example, an inorganic glass) of the heat-resistant sealant.

In a light-emitting device according to the present invention, the difference in refractive index between the diffusing particles and the heat-resistant sealant may be 0.2 or more.

A large difference in refractive index between adjacent substances results in wider diffusion of light passing between the substances.

In accordance with this constitution, the difference in refractive index between the diffusing particles and the heat-resistant sealant is 0.2 or more. Thus, a laser beam incident on the wavelength conversion member can be effectively diffused.

In a light-emitting device according to the present invention, the heat-resistant sealant may be an inorganic glass.

Inorganic glasses have a thermal conductivity of approximately 1 W/mK. Use of an inorganic glass as a sealant can increase the thermal conductivity (or reduce the thermal resistance) of the wavelength conversion member. This can increase the heat dissipation efficiency of the fluorescent substance and prevent degradation of the wavelength conversion member due to heat.

In a light-emitting device according to the present invention, the heat-resistant sealant may be a low-melting glass.

In accordance with the constitution described above, the fluorescent substance may be dispersed in a glass material at a low temperature. This can prevent degradation of the fluorescent substance due to heat and facilitate the manufacture of the wavelength conversion member.

In a light-emitting device according to the present invention, the diffusing particles may be made of zirconium oxide or diamond.

Zirconium oxide has a refractive index of 2.4, and diamond has a refractive index of 2.42. Use of such a substance having a high refractive index as the diffusing particles can enhance the effect of the diffusing particles in diffusing a laser beam. Since zirconium oxide has a melting point of 2715° C., and diamond has a melting point of 3550° C., they do not melt or deteriorate at melting temperatures of common sealants and are suitable as the materials of diffusing particles dispersed in the sealant.

In a light-emitting device according to the present invention, the wavelength conversion member is made of the fluorescent material sealed with a sealant. The heat-conductive particles may have a higher thermal conductivity than the sealant.

In accordance with this constitution, the heat-conductive particles have a higher thermal conductivity than the sealant. Thus, the thermal resistance of the wavelength conversion member can be effectively reduced.

In a light-emitting device according to the present invention, the heat-conductive particles may transmit light.

In accordance with this constitution, the heat-conductive particles transmit light and reduce the possibility of intercepting excitation light emitted from an excitation light source and fluorescence emitted from a fluorescent material. This can increase the use efficiency (luminous efficiency) of excitation light.

In a light-emitting device according to the present invention, the heat-conductive particles and the fluorescent material may be dispersed in the wavelength conversion member while the heat-conductive particles are in contact with the fluorescent material.

In accordance with this constitution, the heat-conductive particles in contact with the fluorescent material can increase the heat transfer efficiency from the fluorescent material to the heat-conductive particles. Thus, the thermal resistance of the wavelength conversion member can be effectively reduced.

A plurality of fluorescent material particles may be adhered to the surface of one heat-conductive particle, or a plurality of heat-conductive particles may be adhered to the surface of one fluorescent material particle.

A light-emitting device according to the present invention may further include a heat-conductive member in contact with the wavelength conversion member to receive heat from the wavelength conversion member.

In accordance with this constitution, heat of the wavelength conversion member is transferred to the heat-conductive member in contact with the wavelength conversion member, thereby increasing the heat dissipation efficiency of the wavelength conversion member.

A manufacturing method according to the present invention may further include a combining step of combining the heat-conductive particles with the fluorescent material. The complex between the heat-conductive particles and the fluorescent material formed in the combining step may be mixed with the sealant in the mixing step.

In accordance with this constitution, the heat-conductive particles in contact with the fluorescent material are sealed to form the wavelength conversion member. Thus, heat of the fluorescent material generated by excitation light irradiation is efficiently transferred to the heat-conductive particles. Thus, the heat-conductive particles can more effectively reduce the thermal resistance of the wavelength conversion member.

In a wavelength conversion member according to the present invention, the first fluorescent material may be a blue-light-emitting nanoparticle fluorescent material for emitting blue light.

For the sake of simplicity, a fluorescent material for emitting fluorescence having a peak wavelength in a blue wavelength range is referred to as a blue-light-emitting fluorescent material. A fluorescent material for emitting fluorescence having a peak wavelength in a yellow wavelength range is referred to as a yellow-light-emitting fluorescent material. A fluorescent material for emitting fluorescence having a peak wavelength in a green wavelength range is referred to as a green-light-emitting fluorescent material. A fluorescent material for emitting fluorescence having a peak wavelength in a red wavelength range is referred to as a red-light-emitting fluorescent material.

In general, white (or pseudo-white) light used as illumination light can be made up by the color mixing of three colors that satisfy the isochromatic principle or the color mixing of two colors that satisfy the relationship of complementary colors. On the basis of the isochromatic principle or the relationship of complementary colors, for example, white (or pseudo-white) light can be made up by the color mixing of fluorescent colors of a plurality of fluorescent materials contained in the wavelength conversion member.

For example, a blue-light-emitting fluorescent material and a yellow-light-emitting fluorescent material may be combined to produce (pseudo-)white light. In this case, the blue wavelength range is a first color wavelength range, and the yellow wavelength range is a second color wavelength range.

A blue-light-emitting fluorescent material, a green-light-emitting fluorescent material, and a red-light-emitting fluorescent material may also be combined to produce white light. In this case, the blue wavelength range is a first color wavelength range, the green wavelength range is a second color wavelength range, and the red wavelength range is a third color wavelength range.

In general, a blue-light-emitting fluorescent material (for example, a rare-earth-activated fluorescent material) has much lower luminous efficiency than another fluorescent material having a longer peak wavelength. For example, a blue-light-emitting fluorescent material has much lower fluorescence efficiency (external quantum efficiency) than a yellow-(or green- and red-)light-emitting fluorescent material having a longer peak wavelength. Furthermore, also because of low visibility of light emission in the blue wavelength range, in order to produce white light having high luminous efficiency as illumination light emitted from the wavelength conversion member, the blue-light-emitting fluorescent material content must be particularly increased. However, general (not nanoparticle) fluorescent materials containing a rare-earth-activated fluorescent material are opaque to light in a visible light wavelength range and the vicinity thereof. Thus, for the reason described above, a particularly high blue-light-emitting fluorescent material content causes a secondary problem of markedly low excitation light irradiation efficiency of a yellow-(or green- and red-)light-emitting fluorescent material or markedly low fluorescence efficiency of the fluorescent material.

When the first fluorescent material is a blue-light-emitting nanoparticle fluorescent material as in the constitution described above, however, even at a high first fluorescent material content, since the first fluorescent material transmits light having a wavelength in the visible light wavelength range or the vicinity thereof, the secondary problem can be solved.

Because of a narrow full width at half maximum (half-width) of the emission spectrum of blue light of LED or LD for emitting blue light, a light-emitting device that utilizes blue light of LED or LD as part of illumination light has a secondary problem of poor color rendering properties of illumination light. This is particularly noticeable with LD.

However, the emission spectrum of a blue-light-emitting nanoparticle fluorescent material generally has a wider half-width than the emission spectrum of LED or LD blue light. Thus, when the first fluorescent material is a blue-light-emitting nanoparticle fluorescent material as in the constitution described above, this can improve the color rendering properties of illumination light emitted from the light-emitting member.

“Blue light” is fluorescence having a peak wavelength in a wavelength range of 440 nm or more and 490 nm or less, for example.

In a wavelength conversion member according to the present invention, the second fluorescent material may be a yellow-light-emitting fluorescent material for emitting yellow light.

The wavelength conversion member irradiated with near-ultraviolet or blue-violet excitation light (having an oscillation wavelength of 350 nm or more and less than 420 nm) (near-ultraviolet light or blue-violet light) can emit (pseudo-)white light with high luminous efficiency as illumination light.

“Yellow light” is fluorescence having a peak wavelength in a wavelength range of 560 nm or more and 590 nm or less, for example.

In a wavelength conversion member according to the present invention, the second fluorescent material is a green-light-emitting fluorescent material for emitting green light and may further contain a red-light-emitting fluorescent material for emitting red light as a third fluorescent material.

The wavelength conversion member irradiated with near-ultraviolet or blue-violet excitation light can emit white light having good color rendering properties with high luminous efficiency as illumination light. Furthermore, a combination of these fluorescent materials and the blue-light-emitting nanoparticle fluorescent material has better color rendering properties than a combination of excitation light in the blue region and a yellow-light-emitting fluorescent material and prevents a decrease in the luminous efficiency of the wavelength conversion member.

“Green light” is fluorescence having a peak wavelength in a wavelength range of 510 nm or more and 560 nm or less, for example. “Red light” is fluorescence having a peak wavelength in a wavelength range of 600 nm or more and 680 nm or less, for example.

In a wavelength conversion member according to the present invention, the green-light-emitting fluorescent material may be an oxynitride fluorescent material.

In accordance with this constitution, oxynitride fluorescent materials, which have excellent heat resistance and high luminous efficiency and are stable, can provide the wavelength conversion member that has excellent heat resistance and high luminous efficiency and is stable. Examples of the oxynitride fluorescent materials include sialon fluorescent materials.

In a wavelength conversion member according to the present invention, the red-light-emitting fluorescent material is preferably a nitride fluorescent material.

A nitride fluorescent material, in particular a CaAlSiN₃ fluorescent material (CASN) or a SrCaAlSiN₃ fluorescent material (SCASN) in combination with the oxynitride fluorescent material can further improve color rendering properties.

In a wavelength conversion member according to the present invention, the blue-light-emitting nanoparticle fluorescent material may contain at least one type of semiconductor nanoparticles made of any of Si, CdSe, InP, InN, InGaN, and InN—GaN mixed crystals.

For example, Si semiconductor nanoparticles (hereinafter referred to as Si nanoparticles) having a particle size of approximately 1.9 nm emit blue-violet to blue (a peak wavelength in the vicinity of 420 nm) fluorescence. Si nanoparticles having a particle size of approximately 2.5 nm emit green (a peak wavelength in the vicinity of 500 nm) fluorescence. Si nanoparticles having a particle size of approximately 3.3 nm emit red (a peak wavelength in the vicinity of 720 nm) fluorescence.

CdSe nanoparticles have the highest luminous efficiency and an internal quantum efficiency of 50% or more.

InP nanoparticles have an internal quantum efficiency of approximately 20%. Blue light due to InP nanoparticles is produced at a very small particle size of 2 nm or less.

InN nanoparticles contains N instead of reactive P and are therefore expected to have high reliability. InN nanoparticles having a particle size of 2.5 nm or more and 3.0 nm or less emit blue light.

The mixed crystal ratio of Ga to N of InGaN nanoparticles can be changed to emit blue light at a particle size of approximately 3.0 nm. Thus, it is easiest to manufacture a nanoparticle fluorescent material from InGaN nanoparticles.

A mixed crystal of InN and GaN may also be used. Also in this case, blue light emission is possible at a particle size of several nanometers.

A wavelength conversion member according to the present invention may contain transparent fine particles, which can transmit light in a visible light wavelength range and the vicinity thereof, have a higher refractive index than a sealant for sealing at least the first fluorescent material and the second fluorescent material, and have a particle size of 1 μm or more and 50 μm or less.

The transparent fine particles can prevent a laser beam used as excitation light for exciting a wavelength conversion member from passing directly through the wavelength conversion member to be emitted outward and increase the luminous area (luminous point size) of the wavelength conversion member. This can improve the safety of illumination light emitted from the wavelength conversion member.

A light-emitting device according to the present invention includes any of the wavelength conversion members described above and may include an excitation light source for irradiating the wavelength conversion member with near-ultraviolet light or blue-violet light.

Thus, the light-emitting device can emit illumination light having high efficiency and/or good color rendering properties.

“Near-ultraviolet light or blue-violet light” is excitation light having an oscillation wavelength of 350 nm or more and less than 420 nm, for example.

A light-emitting member according to the present invention may contain a nanoparticle fluorescent material that is excited in an excitation light wavelength range (a near-ultraviolet to blue region having an oscillation wavelength of approximately 350 to 420 nm) and emits blue light and a yellow-light-emitting fluorescent material for emitting yellow light.

Nanoparticle fluorescent materials generally transmit light in the visible light region or the vicinity thereof. Thus, even a large amount of nanoparticle fluorescent material does not prevent excitation light from reaching the yellow-light-emitting fluorescent material. Nanoparticle fluorescent materials also do not prevent light emission of the yellow-light-emitting fluorescent material. Thus, the light-emitting member can have high luminous efficiency.

The emission spectrum of a nanoparticle fluorescent material for emitting blue light has a wider half-width than the emission spectrum of a semiconductor light-emitting element. Thus, the color rendering properties in the vicinity of blue light are also improved.

A light-emitting member according to the present invention may contain a green-light-emitting fluorescent material for emitting green light and a red-light-emitting fluorescent material for emitting red light instead of the yellow-light-emitting fluorescent material for emitting yellow light.

Also in this case, excitation light is not prevented from reaching the green-light-emitting fluorescent material and the red-light-emitting fluorescent material, and light emission from the green-light-emitting fluorescent material and the red-light-emitting fluorescent material is not prevented. Thus, the light-emitting member can have high luminous efficiency. Furthermore, in this case, illumination light can have good color rendering properties.

When a laser diode is used as an excitation light source, a light-emitting member according to the present invention may contain transparent fine particles that have a higher refractive index than a sealant for sealing the plurality of fluorescent materials and have an average particle size (a particle size) in the range of approximately 1 to 50 μm.

This constitution (transparent fine particles are further added) can prevent a laser beam used as excitation light from passing directly through the light-emitting member to be emitted outward and increase the luminous point size, thereby realizing a light-emitting member that can emit illumination light that is safe for the eye.

In a wavelength conversion member according to the present invention, the fluorescent glass may transmit light.

Hitherto, use of a large amount of blue-light-emitting fluorescent material has made it difficult for excitation light to reach a fluorescent material that emits fluorescence having a longer wavelength than blue light emitted from a fluorescent glass, resulting in insufficient excitation of the fluorescent material. Furthermore, the blue-light-emitting fluorescent material has intercepted most of the fluorescence emitted from the fluorescent material, thereby making it impossible to efficiently extract light from the fluorescent material.

In contrast, in a wavelength conversion member according to the present invention, since the fluorescent glass can transmit light, excitation light can easily reach a fluorescent material, and fluorescence from the fluorescent material can be easily emitted outward. Thus, the wavelength conversion member can have high luminous efficiency.

In a wavelength conversion member according to the present invention, the fluorescent material may be a red-light-emitting fluorescent material for emitting red fluorescence in response to the excitation light.

In a wavelength conversion member according to the present invention, the fluorescent material may be a green-light-emitting fluorescent material for emitting green fluorescence in response to the excitation light.

Hitherto, use of a large amount of translucent or opaque blue-light-emitting fluorescent material has made it difficult for excitation light to reach a red-light-emitting fluorescent material and a green-light-emitting fluorescent material, resulting in insufficient excitation of the red-light-emitting fluorescent material and the green-light-emitting fluorescent material. Furthermore, the blue-light-emitting fluorescent material has intercepted most of the fluorescence emitted from the red-light-emitting fluorescent material and the green-light-emitting fluorescent material. This makes it impossible to efficiently extract light having good color rendering properties from the fluorescent materials.

In contrast, in a wavelength conversion member according to the present invention, since the fluorescent glass can transmit light, excitation light can easily reach the red-light-emitting fluorescent material and the green-light-emitting fluorescent material, and fluorescence from the red-light-emitting fluorescent material and the green-light-emitting fluorescent material can be easily emitted outward. Thus, a wavelength conversion member according to the present invention can have both high luminous efficiency and good color rendering properties. In addition, since a wavelength conversion member according to the present invention requires no blue-light-emitting fluorescent material, the material cost of the blue-light-emitting fluorescent material can be saved.

A wavelength conversion member according to the present invention may contain an oxynitride fluorescent material or a nitride fluorescent material as the fluorescent material.

Oxynitride fluorescent materials or nitride fluorescent materials have high heat resistance and stability. Thus, an oxynitride fluorescent material or a nitride fluorescent material dispersed in a fluorescent glass does not impair the characteristics (such as luminous efficiency, temperature characteristics, and life) of the fluorescent glass.

In a wavelength conversion member according to the present invention, the fluorescent material may be a yellow-light-emitting fluorescent material for emitting yellow fluorescence in response to the excitation light.

Hitherto, use of a large amount of translucent or opaque blue-light-emitting fluorescent material has made it difficult for excitation light to reach a yellow-light-emitting fluorescent material, resulting in insufficient excitation of the yellow-light-emitting fluorescent material. Furthermore, the blue-light-emitting fluorescent material has intercepted most of the fluorescence emitted from the yellow-light-emitting fluorescent material. This makes it impossible to efficiently extract light having good color rendering properties from the fluorescent material.

In contrast, in a wavelength conversion member according to the present invention, since the fluorescent glass can transmit light, excitation light can easily reach the yellow-light-emitting fluorescent material, and fluorescence from the yellow-light-emitting fluorescent material can be easily emitted outward. Thus, a wavelength conversion member according to the present invention can have both good color rendering properties and high luminous efficiency. In addition, since a wavelength conversion member according to the present invention requires no blue-light-emitting fluorescent material, the material cost of the blue-light-emitting fluorescent material can be saved.

In a wavelength conversion member according to the present invention, the excitation light may have a wavelength in the range of 350 to 420 nm.

An excitation light having a wavelength in the range of 350 to 420 nm allows a fluorescent glass to efficiently emit light, thereby realizing a wavelength conversion member having still higher luminous efficiency.

In a wavelength conversion member according to the present invention, the fluorescent glass may be a glass base material doped with a rare-earth element.

A sealant constituting a wavelength conversion member may be a transparent fluorescent glass doped with a rare-earth element, such as Eu²⁺ (divalent europium) or Ce³⁺ (trivalent cerium), instead of a commonly used silicone resin or inorganic glass.

In a wavelength conversion member according to the present invention, in the case that the excitation light is a laser beam, light-transmitting particles that have a particle size in the range of 1 to 50 μm, have a higher refractive index than the fluorescent glass, and can transmit light may be dispersed in the fluorescent glass.

Dispersion of particles in a fluorescent glass will be discussed below. The particles having a particle size of 1 μm or more can sufficiently cause Mie scattering or diffraction scattering of ultraviolet to visible light and sufficiently scatter or diffuse excitation light. However, a particle size of more than 50 μm results in an imbalance with the particle size of a fluorescent material, resulting in insufficient irradiation of the fluorescent material with excitation light.

Since the particles can transmit light, the particles do not intercept excitation light irradiation of a fluorescent material or outward emission of fluorescence. Since the light-transmitting particles have a higher refractive index than a fluorescent glass sealant, the dispersed transparent fine particles have the effects of a diffusing member or a scattering member because of reflection at the interface between the fluorescent glass and the light-transmitting particles.

From these reasons, a wavelength conversion member according to the present invention having the constitution as described above can scatter or diffuse excitation light and improve the efficiency of the wavelength conversion member, and dispersion of a laser beam used as the excitation light ensures eye safety.

A light-emitting device according to the present invention includes any of the wavelength conversion members described above and may include an excitation light source for emitting excitation light and, in the case that the excitation light is a laser beam, a cutoff filter for intercepting the laser beam in its oscillation wavelength range.

In accordance with this constitution, the laser beam is intercepted with the cutoff filter and does not leak out. This can prevent a laser beam that has not been converted into fluorescence (or has not been scattered) from being emitted outward to cause damage to the human eye, thus ensuring the eye safety of the light-emitting device.

A method for manufacturing a wavelength conversion member according to the present invention may include a mixing step of mixing pulverized blue fluorescent glass with the fluorescent material, a molding step of molding the mixture prepared in the mixing step, and a heating step of heating the molded product of the molding step.

In accordance with this constitution, the pulverized blue fluorescent glass is mixed with the fluorescent material in the mixing step. The mixing ratio depends on the types of blue fluorescent glass and fluorescent material used and the specifications of an intended wavelength conversion member. The mixture in the mixing step is molded, and the molded product is heated to manufacture a wavelength conversion member according to the present invention.

Thus, the method for manufacturing a wavelength conversion member according to the present invention includes the mixing step, the molding step, and the heating step. Through these steps, a wavelength conversion member that can efficiently emit illumination light having good color rendering properties can be easily manufactured at low costs.

An illuminating device and a headlight (for example, a vehicle headlight) each including the light-emitting device are within the technical scope of the present invention.

### [Supplementary Notes; Other Modified Examples]

The present invention is not limited to these embodiments, and various modifications may be made in these embodiments without departing from the scope of the appended claims. Embodiments obtained from a combination of technical means disclosed in different embodiments are also within the technical scope of the present invention.

For example, although a laser diode is used as a solid-state light-emitting element for excitation in the embodiments described above, use of a light-emitting diode as an excitation light source as described above also must take the luminous point size into consideration in the same manner. In accordance with the constitution of the present invention, a light-emitting diode can also be used as an excitation light source to provide a safe solid-state illumination source.

A solid-state laser other than laser diodes may be used as an excitation light source. However, a laser diode is preferably used to reduce the size of an excitation light source.

The excitation light source may also be a high-power LED, for example. In this case, LED for emitting light having a wavelength of 450 nm (blue) and a yellow fluorescent material or green and red fluorescent materials are combined to realize a light-emitting device for emitting white light.

A solid-state laser other than laser diodes may be used as an excitation light source. However, a laser diode is preferably used to reduce the size of an excitation light source.

The present invention can be applied to a wavelength conversion member (for example, a light-emitting member or a light-emitting section) and a method for manufacturing the wavelength conversion member, as well as a light-emitting device, an illuminating device, and a headlight (for example, a vehicle headlight). More specifically, the present invention can be applied to automobile headlamps, headlamps for vehicles and moving objects other than automobiles (for example, humans, ships, aircrafts, submarines, and rockets), and other illuminating devices. The present invention can also be applied to other illuminating devices, for example, searchlights, projectors, household lighting fixtures, interior lighting fixtures, and exterior lighting fixtures.

### REFERENCE SIGNS LIST

1 headlamp (light-emitting device, illuminating device, headlight)
1a headlamp (light-emitting device, headlight)
2 laser diode (excitation light source)
5 light-emitting section (wavelength conversion member)
5a surface to be irradiated with laser beam (excitation light irradiation surface)
15 diffusing particles (diffusing member)
15a heat-conductive filler (heat-conductive particles)
16 fluorescent material particles
17 inorganic glass (sealant)
19 transparent sheet (holding portion)
50 headlamp (light-emitting device, headlight)
51 green-light-emitting fluorescent material (first fluorescent material, second fluorescent material)
52 red-light-emitting fluorescent material (second fluorescent material, third fluorescent material)
56 blue-light-emitting fluorescent material (first fluorescent material, nanoparticle fluorescent material)
58 yellow-light-emitting fluorescent material (second fluorescent material)
59 transparent fine particles
60 headlamp (light-emitting device, illuminating device, headlight)
60a headlamp (light-emitting device, illuminating device, headlight)
70 headlamp (light-emitting device, illuminating device, headlight)
200 laser downlight (light-emitting device, illuminating device)
240 LED chip (excitation light source)

1. A light-emitting device, comprising:
a laser diode for emitting a laser beam; and
a wavelength conversion member that contains a fluorescent substance for emitting fluorescence upon receiving the laser beam emitted from the laser diode and diffusing particles for diffusing the laser beam.

2. The light-emitting device according to claim 1, wherein the fluorescent substance and the diffusing particles are contained in a heat-resistant sealant.

3. The light-emitting device according to claim 2, wherein the difference in refractive index between the diffusing particles and the heat-resistant sealant is 0.2 or more.

4. The light-emitting device according to claim 2, wherein the heat-resistant sealant is an inorganic glass.

5. The light-emitting device according to claim 4, wherein the heat-resistant sealant is a low-melting glass.

6. The light-emitting device according to claim 2, wherein the diffusing particles are made of zirconium oxide or diamond.

7. An illuminating device, comprising the light-emitting device according to claim 2.

8. A headlight, comprising the light-emitting device according to claim 2.

9. A light-emitting device, comprising:
an excitation light source for emitting excitation light; and
a wavelength conversion member containing a fluorescent material that emits light in response to excitation light emitted from the excitation light source,
wherein the wavelength conversion member contains heat-conductive particles.

10. The light-emitting device according to claim 9, wherein
the wavelength conversion member contains the fluorescent material sealed with a sealant, and
the heat-conductive particles have a higher thermal conductivity than the sealant.

11. The light-emitting device according to claim 10, wherein the heat-conductive particles can transmit light.

12. The light-emitting device according to claim 10, wherein the heat-conductive particles in contact with the fluorescent material are dispersed in the wavelength conversion member.

13. The light-emitting device according to claim 10, further comprising a heat-conductive member that is in contact with the wavelength conversion member and receives heat from the wavelength conversion member.

14. An illuminating device, comprising the light-emitting device according to claim 10.

15. A headlight, comprising the light-emitting device according to claim 10.

16. A method for manufacturing a wavelength conversion member that emits light upon receiving excitation light, comprising:
a mixing step of mixing heat-conductive particles, a fluorescent material, and a sealant; and
a baking step of baking the mixture prepared in the mixing step.

17. The method for manufacturing a wavelength conversion member according to claim 16, further comprising:
a combining step of combining the heat-conductive particles with the fluorescent material,
wherein a complex between the heat-conductive particles and the fluorescent material formed in the combining step is mixed with the sealant in the mixing step.

18-35. (canceled)
